(19) United States
(12) Patent Application Publication
(10) Pub. No.: US 2022/0297612 A1
(43) Pub. Date: Sep. 22, 2022

(54) HITCH-MOUNTED APPARATUS

(71) Applicant: Quick Turn Precision Machining, Inc., Ogden, UT (US)

(72) Inventors: Whitt Woods, North Ogden, UT (US); Nathan Woods, North Ogden, UT (US); Adam Woods, Willard, UT (US); Mckay Woods, North Ogden, UT (US); Preston Roylance, North Ogden, UT (US)

(21) Appl. No.: 17/655,337

(22) Filed: Mar. 17, 2022

Related U.S. Application Data
(60) Provisional application No. 63/162,935, filed on Mar. 18, 2021.

(51) Int. Cl. B60R 9/10

(52) U.S. Cl. CPC B60R 9/10

(57) ABSTRACT

The present disclosure relates to a hitch-mounted apparatus for use in conjunction with a vehicular hitch receiver to efficiently transport one or more payloads. In particular, the hitch-mounted apparatus may include first and second support arms that are adjustably connected to a connecting member. In some embodiments, each of the first and second support arms and the connecting member include at least one mounting surface defining one or more slots. Utilizing the one or more slots, at least one of the first and second support arms can slide relative to the connecting member. Similarly, upper and lower retention mechanisms for securing a payload can slide relative to the respective first and second support arms. Further, via the one or more slots of the connecting member, lever locks can secure or loosen fasteners at a pivot joint coupling the connecting member and a hitch tube inserted into a vehicular hitch receiver.

### CROSS-REFERENCE TO RELATED APPLICATIONS

The present application claims the benefit of U.S. Provisional Application No. 63/162,935, filed on Mar. 18, 2021. The aforementioned application is hereby incorporated by reference in its entirety.

### BACKGROUND

Vehicle racks are typically implemented with a vehicle structure (e.g., the roof, bed, trunk, bumper, and/or hitch) of a vehicle. These vehicle racks can accommodate additional space for hauling payloads comprising items such as cargo carriers, tents, skis, bikes, four-wheelers, canoes, etc. Particularly with respect to hitch racks, a need exists for adaptively altering positional configurations to accommodate a variety of different payloads (e.g., different sizes and types of payloads) and/or accessory integration. In addition, a need exists for enhanced rigidity to reduce undesired motion (or play) of the hitch rack while the vehicle is in transit.

The subject matter claimed herein is not limited to embodiments that solve any disadvantages or that operate only in environments such as those described above. Rather, this background is only provided to illustrate one example technology area where some embodiments described herein may be practiced.

### BRIEF SUMMARY

Aspects of the present disclosure relate to a hitch-mounted apparatus for use in conjunction with a vehicular hitch receiver. The hitch-mounted apparatus can comprise an upper support arm attached to a top portion of a connecting member. The upper support arm can include an upper retention mechanism adjustably connected to the upper support arm. With the upper retention mechanism, the hitch-mounted apparatus can secure, among other things, a bike wheel. For example, the upper retention mechanism can slidably adjust across the upper support arm for desired placement of the secured bike wheel. Additionally, in some embodiments, the upper retention mechanism can include a pivot connection to the upper support arm, thereby allowing the upper retention mechanism to adaptively configure an angle of connection to the upper support arm. Further, the hitch-mounted apparatus can include a lower support arm adjustably connected to the connecting member at a position between the top portion and a bottom portion of the connecting member. The lower support arm can include a lower retention mechanism adjustably connected to the lower support arm. With the lower retention mechanism, the hitch-mounted apparatus can secure, among other things, a second bike wheel. For example, the lower support arm can adjust up and down the connecting member to secure a rear bike wheel at a desired location via the lower retention mechanism. Additionally, in some embodiments, the hitch-mounted apparatus comprises a hitch tube rotatably attached to the bottom portion of the connecting member via a pivot joint. The hitch tube is configured for insertion into a vehicular hitch receiver.

Additional features and advantages of one or more embodiments of the present disclosure are outlined in the following description.

### BRIEF DESCRIPTION OF THE DRAWINGS

The detailed description provides one or more embodiments with additional specificity and detail through the use of the accompanying drawings, as briefly described below.

FIGS. 1A-1D illustrate various views of a hitch-mounted apparatus in accordance with one or more embodiments.

FIGS. 2A-2D illustrate an upper retention mechanism of a hitch-mounted apparatus in accordance with one or more embodiments.

FIGS. 3A-3C illustrate a lower retention mechanism of a hitch-mounted apparatus in accordance with one or more embodiments.

FIGS. 4A-4B illustrate a hitch-mounted apparatus comprising a motor-assist system in accordance with one or more embodiments.

FIGS. 5A-5B illustrate a hitch tube of a hitch-mounted apparatus in accordance with one or more embodiments.

FIGS. 6A-6C illustrate a hitch-mounted apparatus comprising a swing rack that swings between a stowed and unstowed configuration in accordance with one or more embodiments.

FIGS. 7A-7C illustrate various views of a hitch-mounted apparatus in accordance with one or more embodiments.

FIGS. 8-20 illustrate various views of a hitch-mounted apparatus in accordance with one or more embodiments.

FIGS. 21-24 illustrate various views of a hitch-mounted apparatus in accordance with one or more embodiments.

FIGS. 25-30 illustrate various views of an upper retention mechanism of a hitch-mounted apparatus in accordance with one or more embodiments.

FIGS. 31-33 illustrate various views of a lower retention mechanism of a hitch-mounted apparatus in accordance with one or more embodiments.

FIG. 34 illustrates a hitch tube of a hitch-mounted apparatus in accordance with one or more embodiments.

FIGS. 35-36 illustrate various views of one or more hitch-mounted apparatuses in accordance with one or more embodiments.

FIGS. 37-40 illustrate various views of an upper retention mechanism of a hitch-mounted apparatus in accordance with one or more embodiments.

FIGS. 41-43 illustrate various views of a lower retention mechanism of a hitch-mounted apparatus in accordance with one or more embodiments.

FIGS. 44-46 illustrate various views of an upper retention mechanism of a hitch-mounted apparatus in accordance with one or more embodiments.

FIGS. 47-50 illustrate various views of a hitch-mounted apparatus comprising a motor-assist system in accordance with one or more embodiments.

FIGS. 51-56 illustrate various views of a hitch tube of a hitch-mounted apparatus in accordance with one or more embodiments.

FIGS. 57-71 illustrate various views of a hitch-mounted apparatus in accordance with one or more embodiments.

FIGS. 72-81 illustrate various views of a pivot joint of a hitch-mounted apparatus in accordance with one or more embodiments.

FIGS. 82-83 illustrate various views of a hitch-mounted apparatus in accordance with one or more embodiments.

FIGS. 84-85 illustrate various views of a lower retention mechanism in accordance with one or more embodiments.

FIGS. 86-100 illustrate various views of an upper retention mechanism in accordance with one or more embodiments.

FIGS. 101-102 illustrate various views of a lower retention mechanism in accordance with one or more embodiments.

FIGS. 103-117 illustrate various views of an upper retention mechanism of a hitch-mounted apparatus in accordance with one or more embodiments.

FIG. 118 illustrates a view of a connection between a connecting member and a lower support arm in accordance with one or more embodiments.

FIGS. 119-121 illustrates various views of a hitch-mounted apparatus for transporting a snowboard in accordance with one or more embodiments.

FIGS. 122-128 illustrate various views of a hitch-mounted apparatus comprising a swing rack that swings between a stowed and unstowed configuration in accordance with one or more embodiments.

FIG. 129 illustrates a method of manufacturing a hitch-mounted apparatus in accordance with one or more embodiments.

### DETAILED DESCRIPTION

This disclosure describes one or more embodiments of a hitch-mounted apparatus. In particular, the hitch-mounted apparatus may include first and second support arms (e.g., crossbars) that are adjustably connected to a connecting member (e.g., a reclinable upright bar). In some embodiments, each of the first and second support arms and the connecting member include at least one mounting surface defining one or more slots (e.g., formed according to an extrusion process). Utilizing the one or more slots, at least one of the first and second support arms can slide (e.g., translate) relative to the connecting member. Similarly, via the one or more slots of the first and second support arms, upper and lower retention mechanisms for securing a payload can slide relative to the respective first and second support arms. Further, via the one or more slots of the connecting member, lever locks can help to secure or loosen fasteners at a pivot joint coupling the connecting member and the hitch tube inserted into a vehicular hitch receiver. In this manner, the hitch-mounted apparatus can flexibly accommodate one or more bikes (and/or other payloads) of various sizes and in various positional configurations. Moreover, using a manufacturing-friendly material, a lightweight material, and/or a combination of materials such as aluminum, steel, titanium, carbon fiber, etc., the hitch-mounted apparatus can advantageously form the one or more slots and reduce its weight for improved adaptability and vehicle integration.

As just mentioned, the hitch-mounted apparatus can include the first and second support arms (or additional support arms as needed). In some embodiments, the first and second support arms are positioned parallel to each other and perpendicular to the connecting member. In particular embodiments, the first support arm can attach to the connecting member at a top portion of the connecting member. For example, in some embodiments, the first support arm rests above or on top of a top-most portion of the connecting member (e.g., in a T-shape configuration forming a perpendicular joint with each other). In other embodiments, the first support arm is attached adjacent to (e.g., off to one side of or proximate) a top portion of the connecting member.

The first support arm can also include an upper retention mechanism. In some embodiments, the upper retention mechanism is sized and shaped to receive a variety of bike wheel sizes (e.g., wheel diameters and tire widths). For example, in certain implementations, the upper retention mechanism includes two retention plates configured to adjust (e.g., slide along one or more slots in the first support arm) relative to each other. In some cases, the two retention plates are independent of each other. In other embodiments, the two retention plates are structurally connected (e.g., via a common base connection to the first support arm). Additionally, in some embodiments, the upper retention mechanism includes one or more stop pins disposed between the two retention plates. The one or more stop pins provide a mechanical stop for the bike wheel such that the bike wheel is not allowed to exit (e.g., pass through or fall out of) the two retention plates. Further, in some embodiments, the upper retention mechanism includes an adjustable tie configured to wrap around a bike wheel (e.g., between wheel spokes) to secure a bike wheel between the two retention plates and/or against the one or more stop pins.

Further, in some embodiments, the upper retention mechanism is angularly adjustable. For example, the two retention plates can change an angle of connection to the first support arm. To illustrate, in some embodiments, the two retention plates are perpendicular to the first support arm. In other embodiments, the two retention plates pivot at a base connection (e.g., respective base connections) to the first support arm to form a desired angle less than ninety degrees or greater than ninety degrees relative to the first support arm. By adjusting an angle of connection to the first support arm, the upper retention mechanism allows the hitch-mounted apparatus to flexibly accommodate multiple bikes. For instance, utilizing one or more angles of connection between respective retention mechanisms and the first support arm, the hitch-mounted apparatus can accommodate multiple bikes with sufficient clearance in between them.

In addition, the second support arm can be adjustably connected to the connecting member at a position between the top portion and a bottom portion of the connecting member. For example, the second support arm can be adjustably connected adjacent to (e.g., off to one side of or proximate) the connecting member. To illustrate, the second support arm may be connected to the connecting member (e.g., in a same or similar manner as the first support arm) via one or more fasteners that engage a mounting surface of the connecting member. Utilizing the one or more slots, the second support arm can slide up and down the connecting member to achieve a desired placement between the first support arm and a pivot joint. With this adjustability, the hitch-mounted apparatus can, for example, accommodate different bike lengths that span a variety of distances between front and rear bike wheels (e.g., for kid bikes, adult bikes, etc.).

The second support arm can also include a lower retention mechanism. Like the upper retention mechanism, the lower retention mechanism can be sized and shaped to receive a variety of different wheel sizes and types. In particular embodiments, the lower retention mechanism includes a wheel rest. For example, the wheel rest may include a “V”-shape or “U”-shape or other shapes or retaining features and configurations such that the bike wheel does not slip or slide out of the wheel rest (e.g., during vehicle turns). In these or other embodiments, the wheel rest may include different orientations for securing the bike wheel (e.g., to secure the bike wheel from one or both sides of the bike wheel). Additionally or alternatively, the lower retention mechanism can include an adjustable tie configured to wrap around the bike wheel (e.g., between wheel spokes) to secure the bike wheel against the wheel rest (or against the second support arm without a wheel rest). In these or other embodiments, the lower retention mechanism is adjustably connected via one or more fasteners that engage a mounting surface of the second support arm. Specifically, utilizing one or more slots in the second support arm, the lower retention mechanism can slide across the second support arm to achieve a desired placement (e.g., to vertically align with or else positionally offset from the upper retention mechanism). With this adjustability, the hitch-mounted apparatus can, for example, accommodate different spacing between bikes and/or balance a weight load of the bike(s) relative to the connecting member.

In addition, the hitch-mounted apparatus includes a hitch tube rotatably attached to the connecting member at the bottom portion via a pivot joint. The hitch tube can be inserted into a vehicular hitch receiver and secured inside the vehicular hitch receiver (e.g., via a hitch pin, clevis pin, etc.). The hitch tube may also include additional or alternative mechanisms to further secure or provide a customized fit within the vehicular hitch receiver. For instance, the hitch tube may include one or more horizontal and/or vertical points of constraint within the vehicular hitch receiver. To illustrate, the hitch tube may include a bottom bolt or pin that secures the hitch tube in the vertical direction once inserted into the vehicular hitch receiver. Further, the hitch tube may include two side bolts or pins that secure the hitch tube in the horizontal direction once inserted into the vehicular hitch receiver.

With respect to the pivot joint, the pivot joint can allow the connecting member to adjust a degree of verticalness by reclining forward and backward (e.g., toward or away from a vehicle). Similarly, there may be connecting members to adjust a degree of horizontalness. This adjustability allows the connecting member to provide various amounts of clearance between the hitch-mounted apparatus and the vehicle when inserted into the vehicle hitch receiver. To illustrate, reclining the connecting member away from the vehicle allows additional clearance for opening a tail gate of the vehicle, accessing a spare vehicle tire, etc.

To facilitate the connecting member pivoting or adjusting its angle of attachment to the hitch tube, the pivot joint can include lever locks. The lever locks, when released, allow the connecting member to recline forward or backward. When the lever locks are engaged, however, the connecting member is held rigidly in place. In particular, the lever locks can reduce or in some cases remove any and all wobble of the connecting member relative to the hitch tube by compressing side plates against corresponding surfaces of the connecting member. Specifically, using a fastener disposed within a slot of the connecting member, the lever locks can draw in the fastener to create a clamping force exerted between the lever lock and the fastener inside the slot of the connecting member. In turn, the side plates can disperse the clamping force across the surface of the connecting member for an effective, rigid hold. Thus, unlike conventional hitch racks that undergo substantial movement during vehicle transit, the hitch-mounted apparatus can rigidly maintain its position during vehicle transit.

In some embodiments, the hitch-mounted apparatus includes accessibility features. For instance, the hitch-mounted apparatus may include motor-assisted raising and lowering between a stowed (e.g., upright, ready-for-transit position) and unstowed (e.g., lowered, loading position) configuration. In this manner, the hitch-mounted apparatus can reduce and/or eliminate the amount of lifting or manual effort to move the hitch-mounted apparatus when loaded with one or more bikes (particularly heavier bikes, such as electric/hybrid bikes). This motor-assist may be controlled via tethered or untethered push button(s), remotely (e.g., via a key fob), Bluetooth® connection, WI-FI connection, etc. and/or software applications on one or more communicatively coupled computing devices (e.g., mobile phone).

In additional or alternative embodiments, the hitch-mounted apparatus includes an accessibility feature comprising a swing top that can laterally rotate away from a vehicle. In this example embodiment, the hitch-mounted apparatus can provide improved access to the vehicle (e.g., a vehicle tailgate or back hatch) while leaving the hitch-mounted apparatus attached to the vehicle and even loaded with bikes or other payloads. Further, in some embodiments, the hitch-mounted apparatus includes a combination of accessibility features. For example, in certain implementations, the hitch-mounted apparatus comprises a swing top that can laterally rotate away from a vehicle and a liftable rack that raises and lowers vertically from the swing top for convenient loading.

In certain embodiments, the hitch-mounted apparatus further includes one or more components for providing electrical power (e.g., for charging an electric bike, electronic devices, etc.). For example, in one or more embodiments, the hitch-mounted apparatus includes a rechargeable battery and associated electrical configurations to power one or more electrical receptacles (e.g., 12-24 VDC, 120 VAC outlets, USB ports, etc.). The rechargeable battery may be affixed or mounted to the hitch-mounted apparatus. Alternatively, the rechargeable battery may be removable (e.g., withdrawn for charging and inserted back into an electrical mount on the hitch-mounted apparatus). In certain implementations, the rechargeable battery comprises solar charging. It will be appreciated that the rechargeable battery can charge a payload (e.g., an electric bike) during transit.

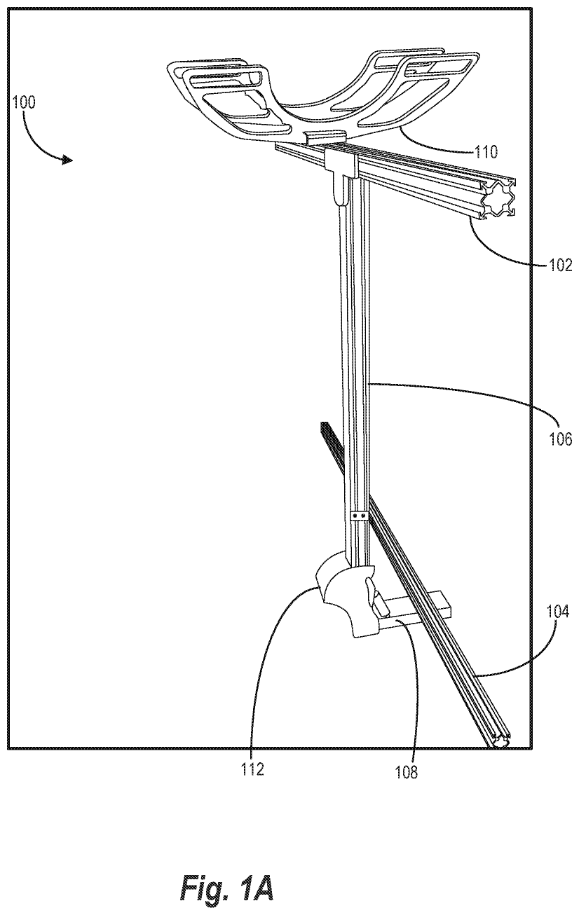

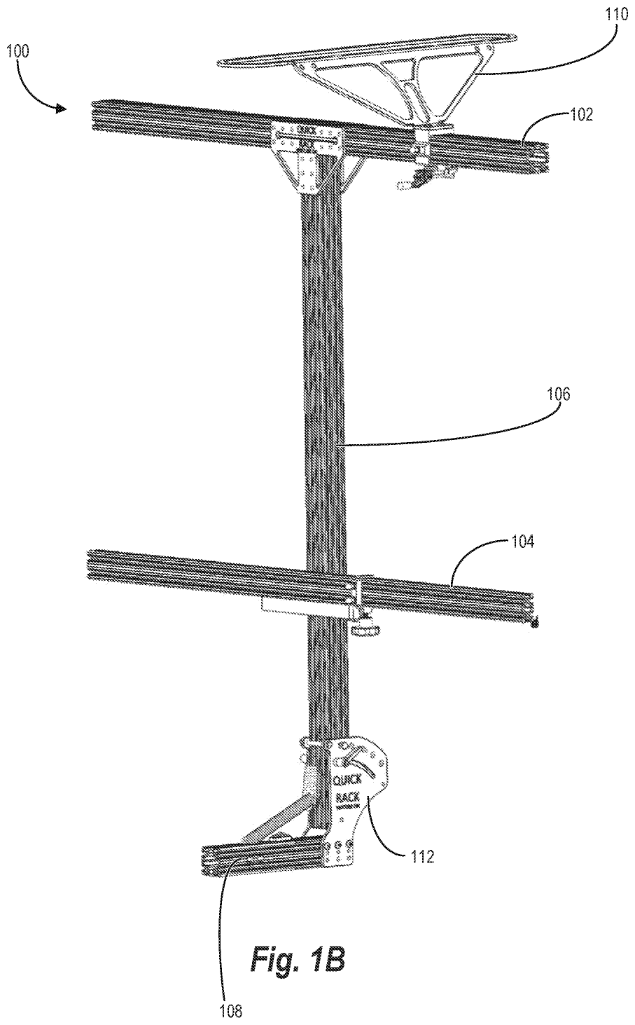

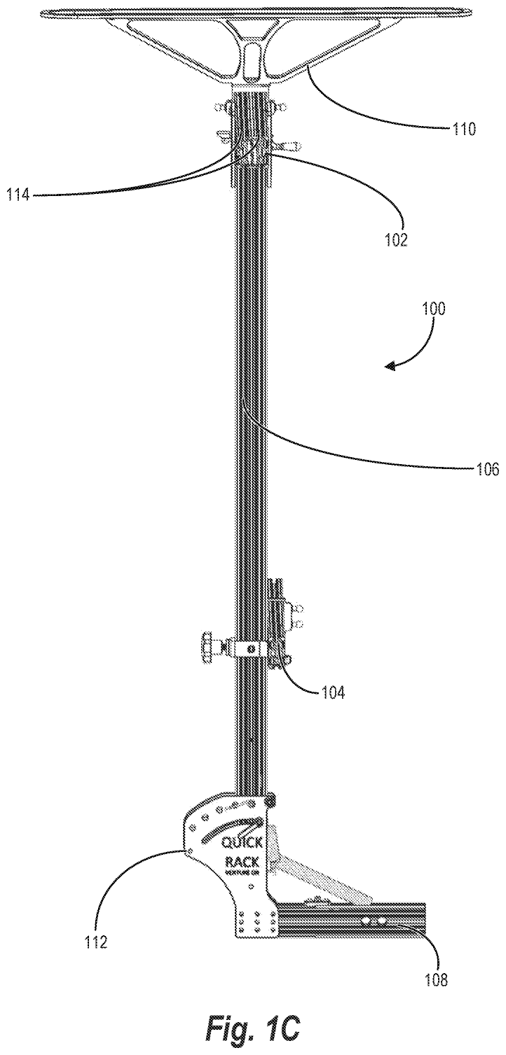

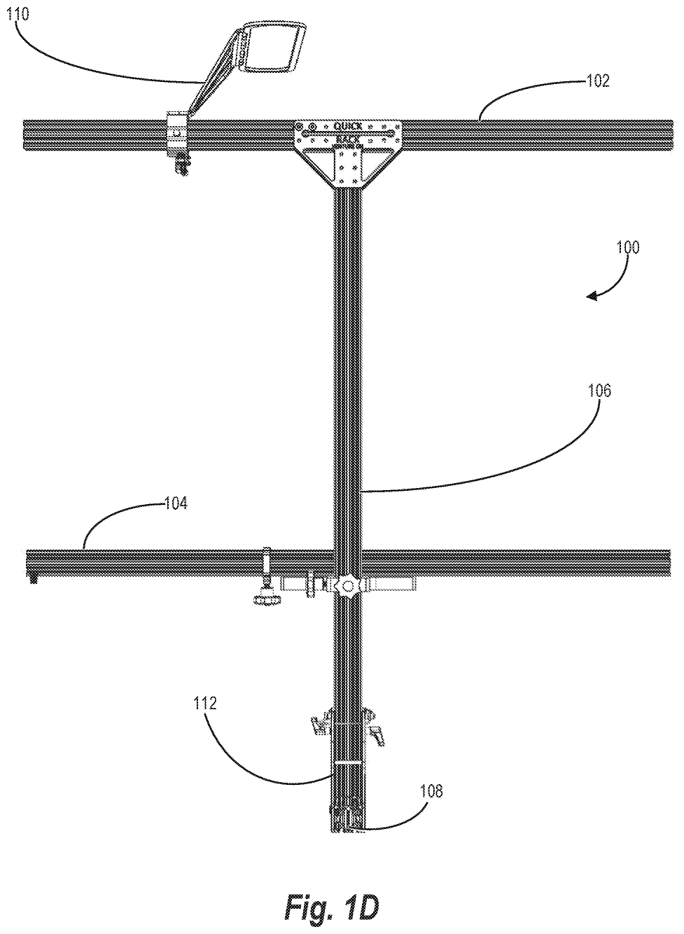

Turning to the figures, FIGS. 1A-1D illustrate a hitch-mounted apparatus 100 in accordance with one or more embodiments. As shown in FIGS. 1A-1D, the hitch-mounted apparatus 100 includes a first support arm 102, a second support arm 104, a connecting member 106, a hitch tube 108, an upper retention mechanism 110, and a pivot joint 112. In particular, the first support arm 102, the second support arm 104, the connecting member 106, and the hitch tube 108 comprise extruded aluminum. The aluminum is a lightweight, durable material that is also manufacturing friendly. For example (and as specifically called out in FIG. 1C), the first support arm 102, the second support arm 104, the connecting member 106, and the hitch tube 108 each comprise slots 114 formed within the aluminum material (and/or other materials such as steel, titanium, carbon fiber, etc. The slots 114 can include one or more slots (e.g., two slots as shown). In addition, the slots 114 can be positioned along one or more surfaces and/or for various portions of the first support arm 102, the second support arm 104, the connecting member 106, and the hitch tube 108. As will be explained more below, the hitch-mounted apparatus 100 can advantageously position and/or spatially reconfigure the various elements relative to each other via the slots 114.

As further shown, the first support arm 102 is secured atop the connecting member 106 via a mounting bracket that leverages fasteners and the slots 114 to affix the first support arm 102 and the connecting member 106 together (e.g., in perpendicular fashion). In particular, half the first support arm 102 is positioned to one side of the connecting member 106, and the other half of the first support arm 102 is positioned to the other side of the connecting member 106 such that the connecting member 106 is approximately centered across the first support arm 102. Of course in other embodiments, different positional arrangements between the first support arm 102 and the connecting member 106 are herein contemplated. For example, the connecting member 106 may not be centered across the first support arm 102 and/or the first support arm 102 may be secured adjacent to the connecting member 106 rather than atop the connecting member 106 (e.g., similar to the second support arm 104 described below). In some embodiments, the first support arm 102 comprises a length of about two feet, about four feet, about six feet, or about eight feet (e.g., depending on the number and type of payload(s)).

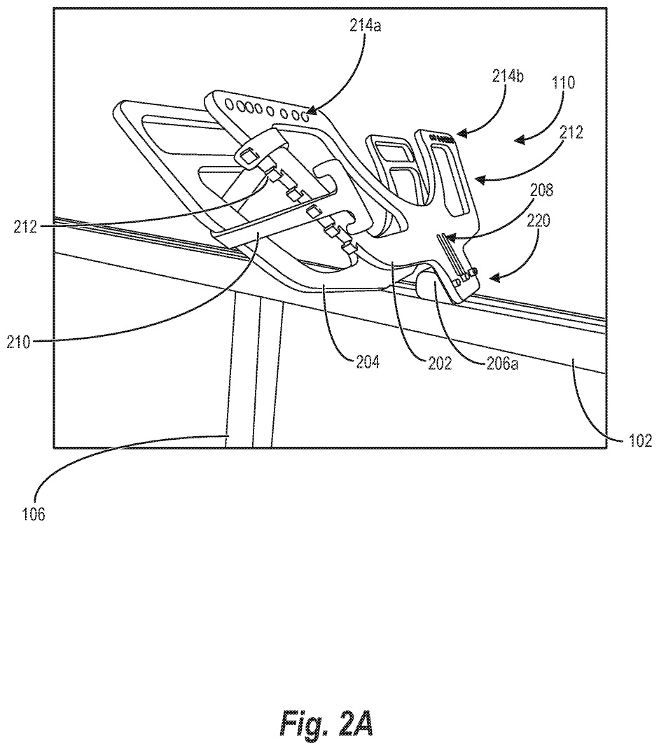

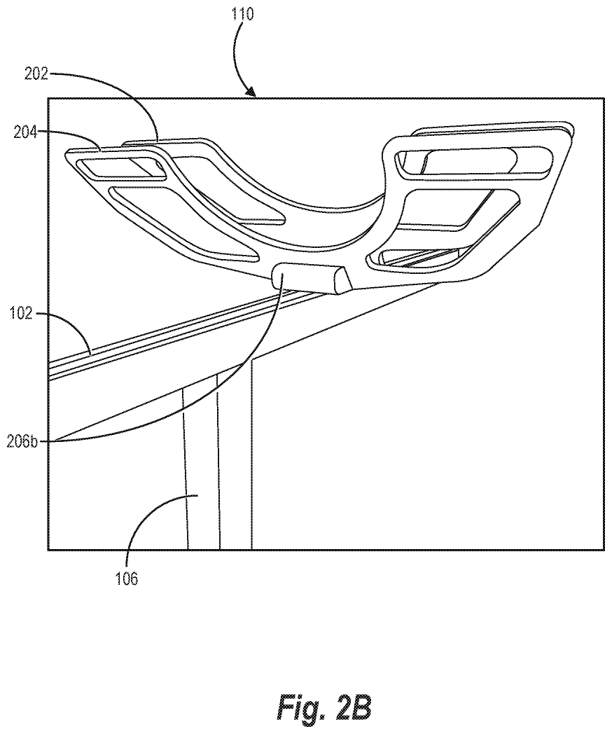

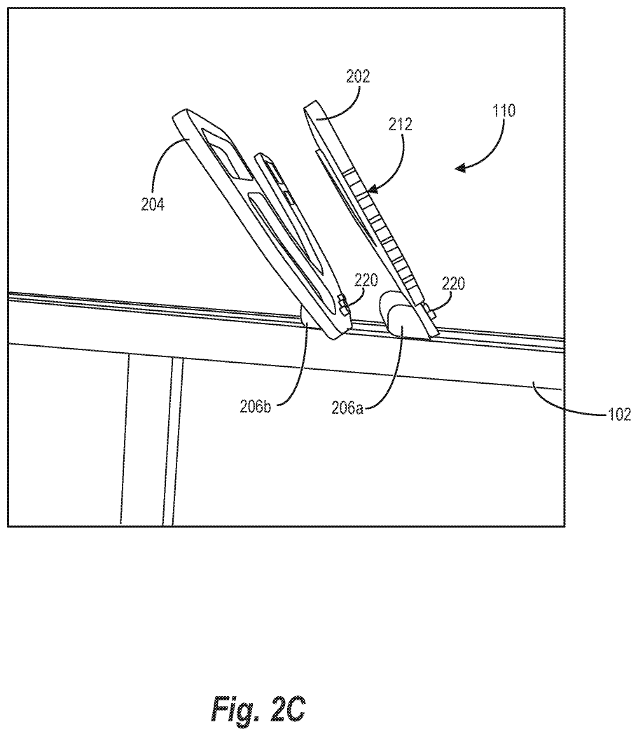

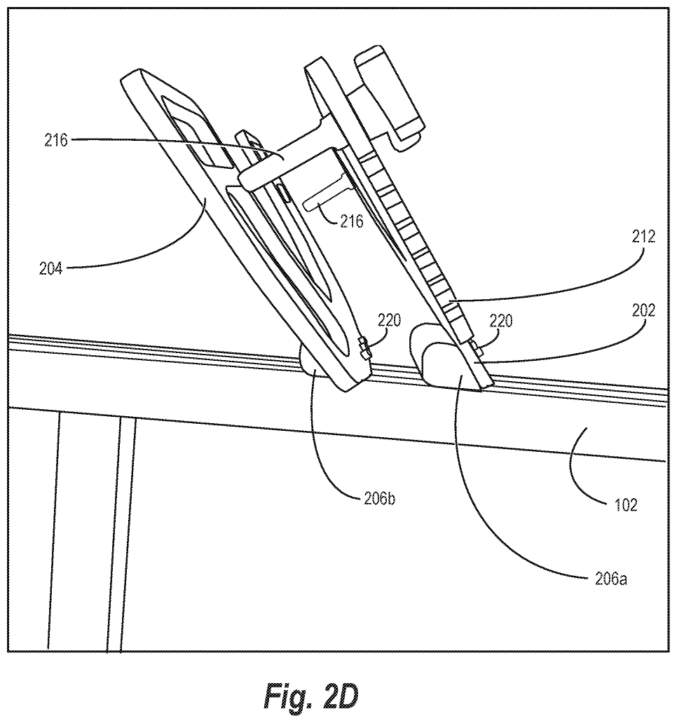

In addition, the first support arm 102 comprises the upper retention mechanism 110 for securing a portion of a payload (e.g., a front bike wheel). The upper retention mechanism 110 is adjustably connected to the first support arm 102. By loosening and tightening fasteners connecting the upper retention mechanism 110 to the first support arm 102 (e.g., via fasteners disposed within the slots 114 of the first support arm 102), the upper retention mechanism 110 can slide to any desired position across the first support arm 102. Furthermore, the upper retention mechanism 110 can adjust an angle of connection to the first support arm 102. By allowing the upper retention mechanism 110 to adjust the angle of connection to the first support arm 102, for example, the handlebars of the bike can be rotated or turned (as shown in FIG. 1D) so as to accommodate multiple bikes on the hitch-mounted apparatus 100. The upper retention mechanism 110 is described in greater detail below in relation to FIGS. 2A-2D.

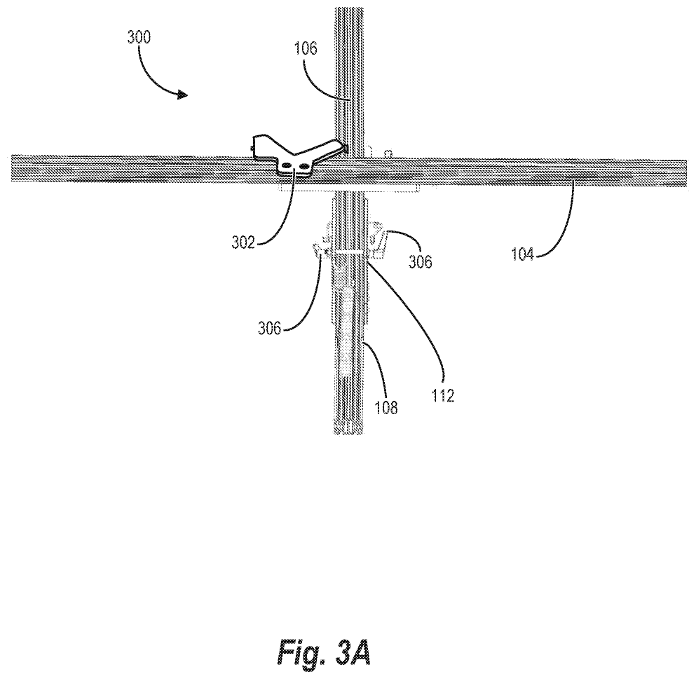

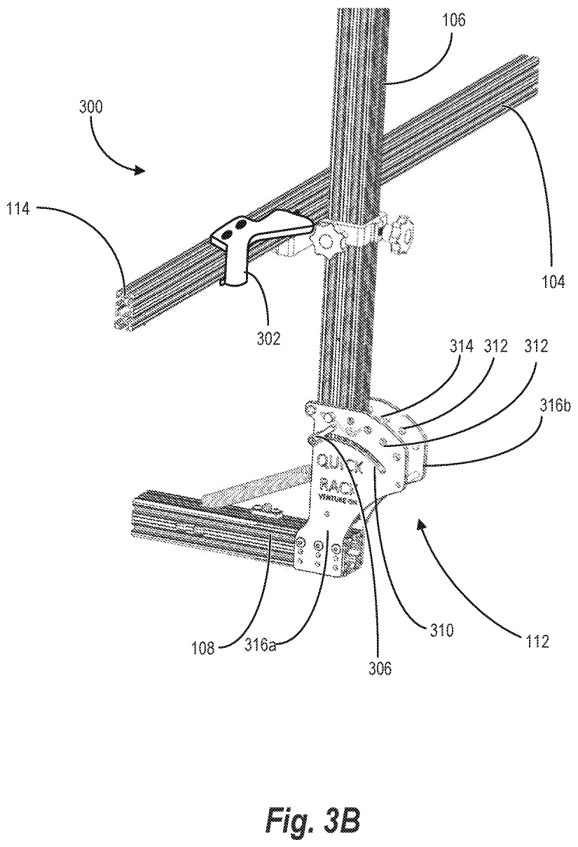

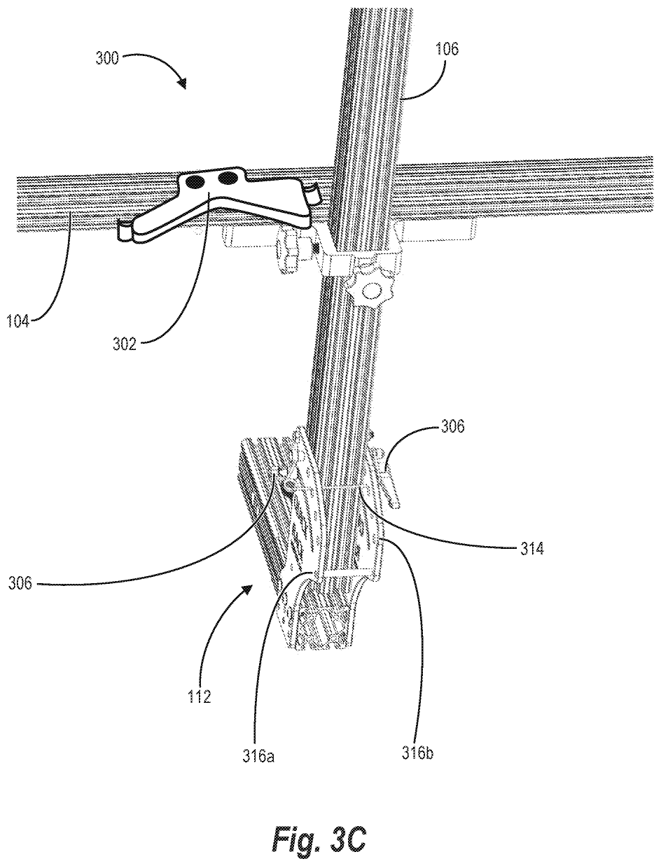

Similarly, the second support arm 104 is adjustably connected to the connecting member 106 via a mounting bracket that leverages fasteners and the slots 114 to affix the second support arm 104 and the connecting member 106 together at a desired location. Upon loosening and tightening the fasteners, the second support arm 104 can be adjusted up and down the connecting member 106 between the first support arm 102 and the pivot joint 112. By positionally arranging the connecting member 106 to a desired location along the connecting member 106, the second support arm 104 can secure another portion of the payload (e.g., a rear bike wheel) via a lower retention mechanism described more below in relation to FIGS. 3A-3C. In these or other embodiments, the second support arm 104 is sized and shaped similar to the first support arm 102.

As just described, the connecting member 106 is attached to both the first support arm 102 and the second support arm 104. In particular, the connecting member 106 is attached perpendicular to the first support arm 102 and the second support arm 104. In this manner, the connecting member 106 can transfer a weight of the payload from the first support arm 102 and the second support arm 104 to the hitch tube 108 (e.g., via the pivot joint 112). In these or other embodiments, the connecting member 106 comprises a length of about three feet, about five feet, or about seven feet.

With respect to the hitch tube 108, the hitch tube 108 is sized and shaped for inserting into a vehicular hitch receiver of a vehicle. By securing the hitch tube 108 within the vehicular hitch receiver, the hitch-mounted apparatus 100 can transfer the weight of the payload(s) to the vehicle. To do so, the hitch tube 108 includes one or more thru-hole pairs for inserting a hitch pin. With alignment of corresponding thru holes of the vehicular hitch receiver, the hitch pin can pass through both the vehicular hitch receiver and the hitch tube 108.

In some embodiments, to reduce or eliminate play between the hitch tube 108 and the vehicular hitch receiver, the hitch tube 108 can also include one or more adjustable configurations. The adjustable configurations can include one or more fasteners that wedge the hitch tube 108 against the inner sidewalls of the vehicular hitch receiver. For example, the hitch tube 108 may include adjustable portions (e.g., compression plates) that, upon adjustment of one or more fasteners, expand the portions of the hitch tube 108 into compression against the inner sidewalls of the vehicular hitch receiver. In addition, the hitch tube 108 increases a surface area that interfaces with the vehicular hitch receiver (e.g., for more efficient, distributed weight transfer).

With respect to the pivot joint 112, the pivot joint 112 provides a rotatable connection between the connecting member 106 and the hitch tube 108. In particular, the pivot joint 112 allows the connecting member 106 to rotate relative to the hitch tube 108 inserted within a vehicular hitch receiver. For example, the pivot joint 112 allows the connecting member 106 to rotate away from a vehicle (e.g., recline backwards) from about a ninety-degree angle to another desired angle relative to the hitch tube 108. The desired angle may be any angle between the following approximate angular ranges: between 90 degrees and 100 degrees, between 90 degrees and 120 degrees, between 90 degrees and 150 degrees, or between 90 degrees and 180 degrees, or any angle in between (e.g., to lie flat with the hitch tube 108). Additionally or alternatively, the pivot joint 112 may allow the connecting member 106 to rotate towards the vehicle (e.g., recline forwards between about 90 degrees and about 60 degrees, or between about 90 degrees and about 45 degrees). With the pivot joint 112 able to rotate the connecting member 106 towards the vehicle, the hitch-mounted apparatus 100 can accommodate longer payloads (e.g. canoes).

To allow the connecting member 106 to pivot relative to the hitch tube 108, the pivot joint 112 includes lever locks. The lever locks, when released, allow the connecting member 106 to be positionally adjusted or rotated as desired. When the lever locks are engaged, however, the connecting member 106 is secured at a particular position relative to the hitch tube 108. In particular, and as described more below in relation to FIGS. 3A-3C, the lever locks can reduce or eliminate play between the connecting member 106 and the hitch tube 108 to impart a more stable and smoother ride during transit with the hitch-mounted apparatus 100.

Modifications, additions, or omissions may be made to the embodiments illustrated and described in relation to FIGS. 1A-1D without departing from the scope of the present disclosure. The additional modifications described below can also apply to myriad different styles, sizes, and design configurations of a hitch-mounted apparatus as disclosed herein. For example, in some embodiments, the hitch-mounted apparatus 100 comprises one or more additional support arms at desired locations. For instance, to secure a child bike and an adult bike, the hitch-mounted apparatus 100 may include an additional support arm adjustably connected to one or both sides of the connecting member 106. The additional support arm can secure a rear wheel of the child bike, while the second support arm 104 secures the rear wheel of the adult bike.

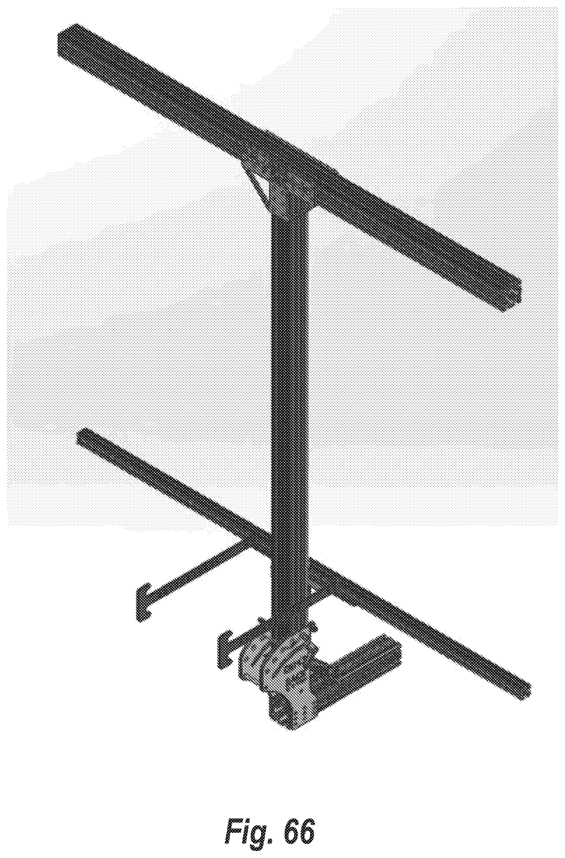

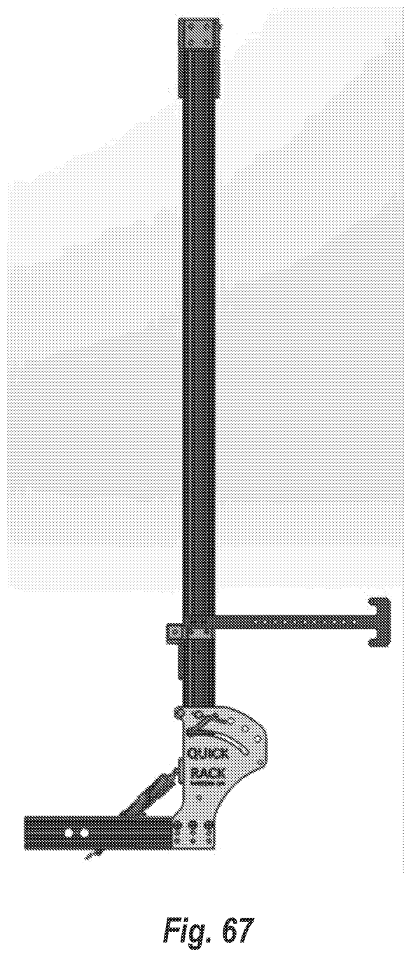

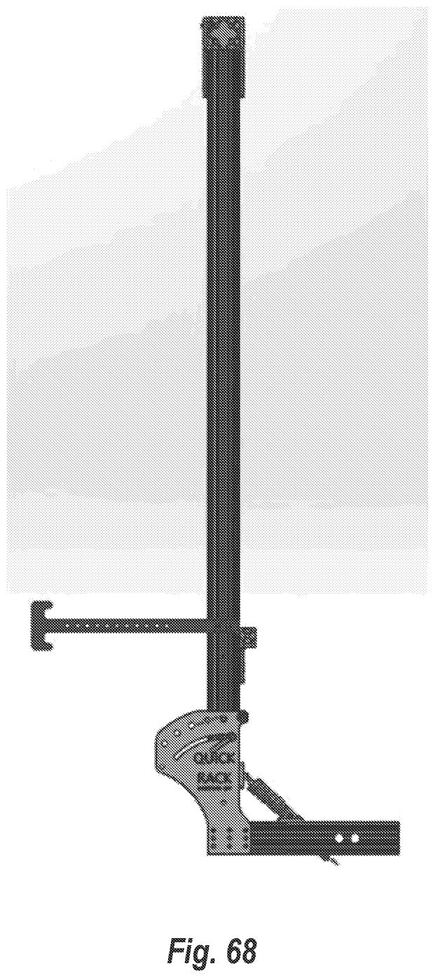

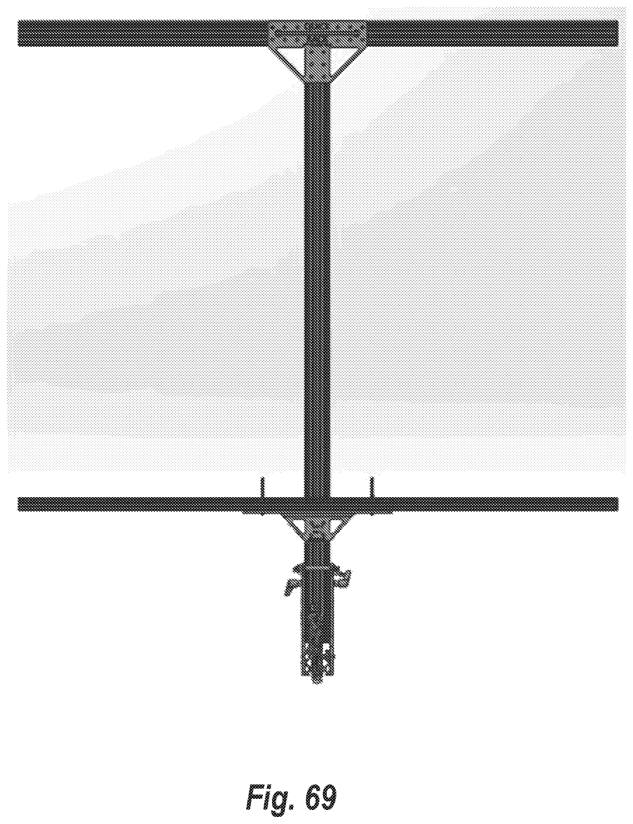

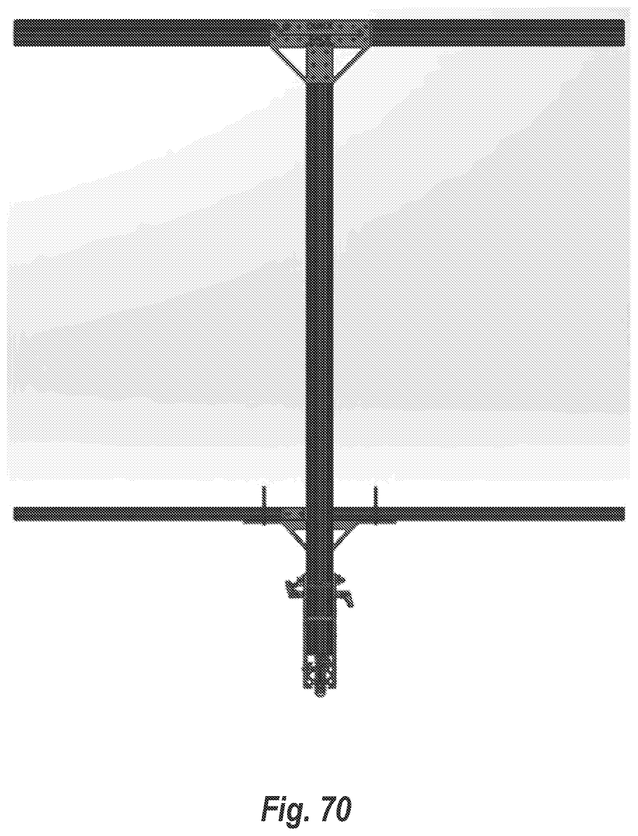

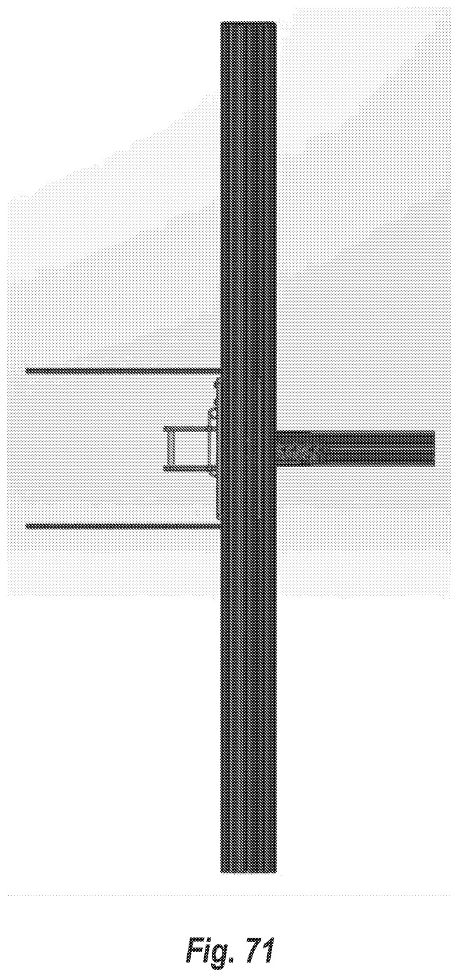

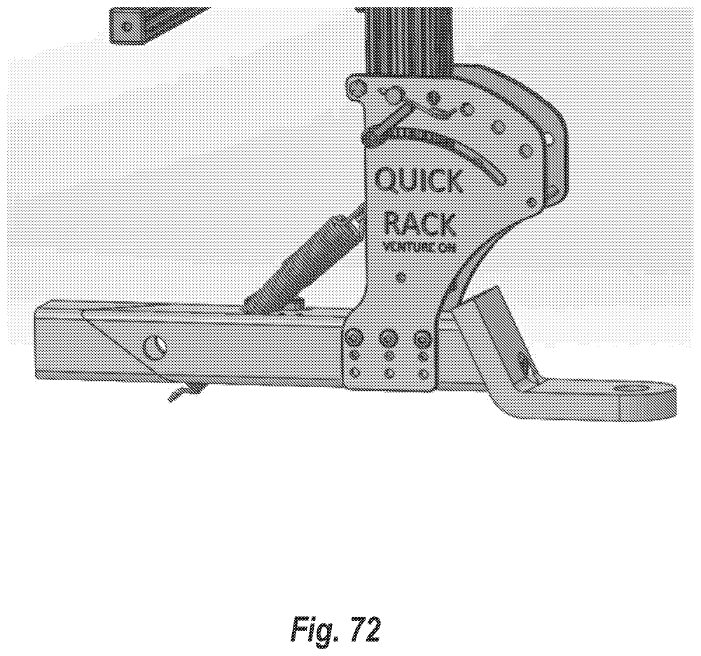

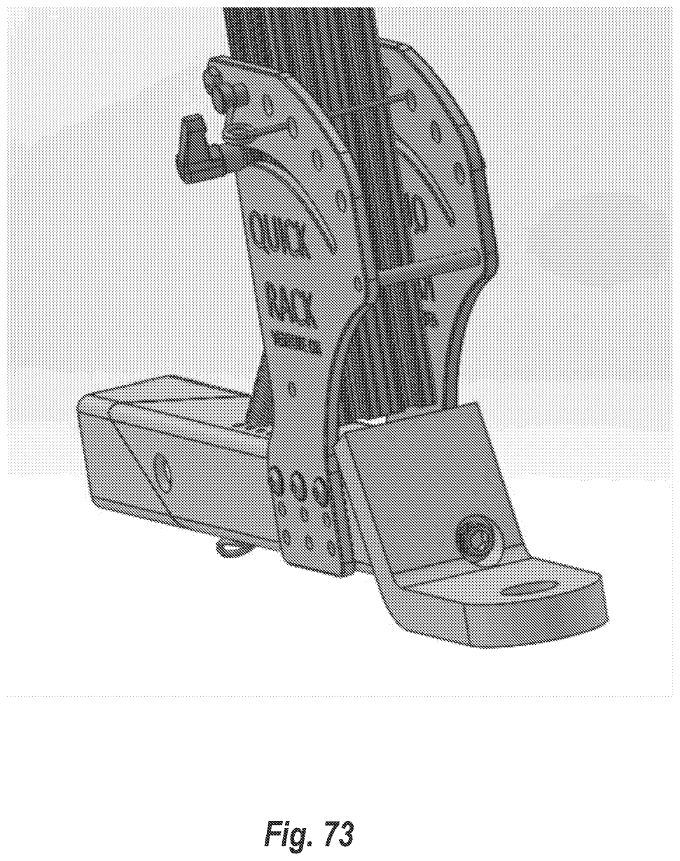

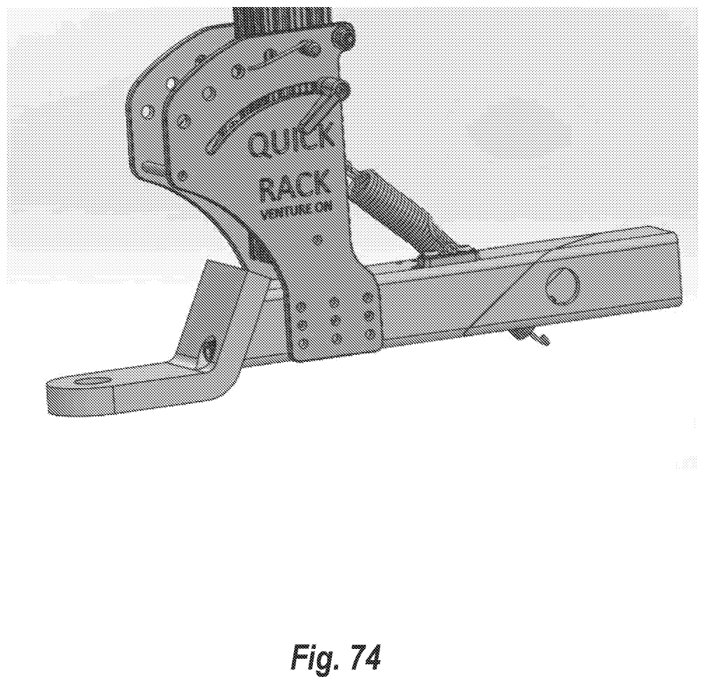

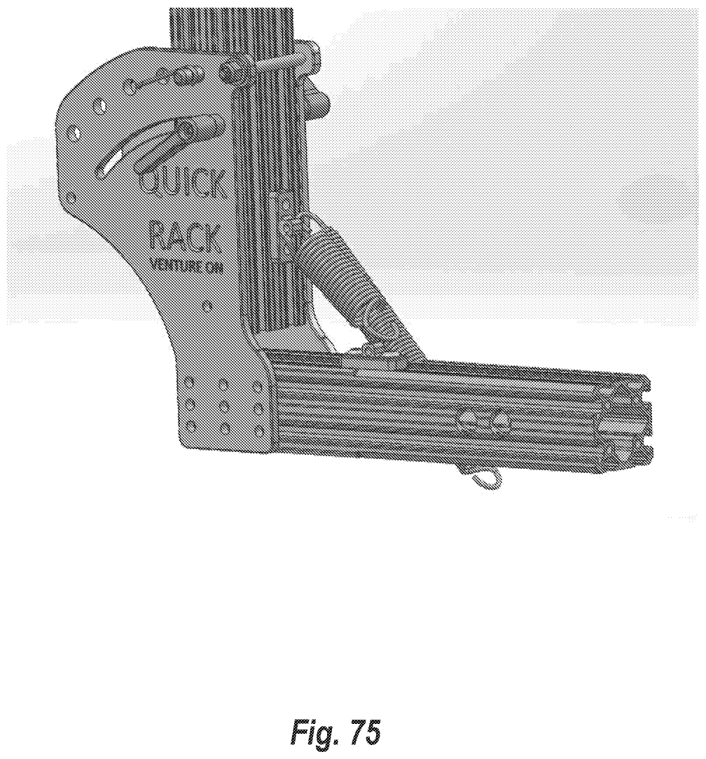

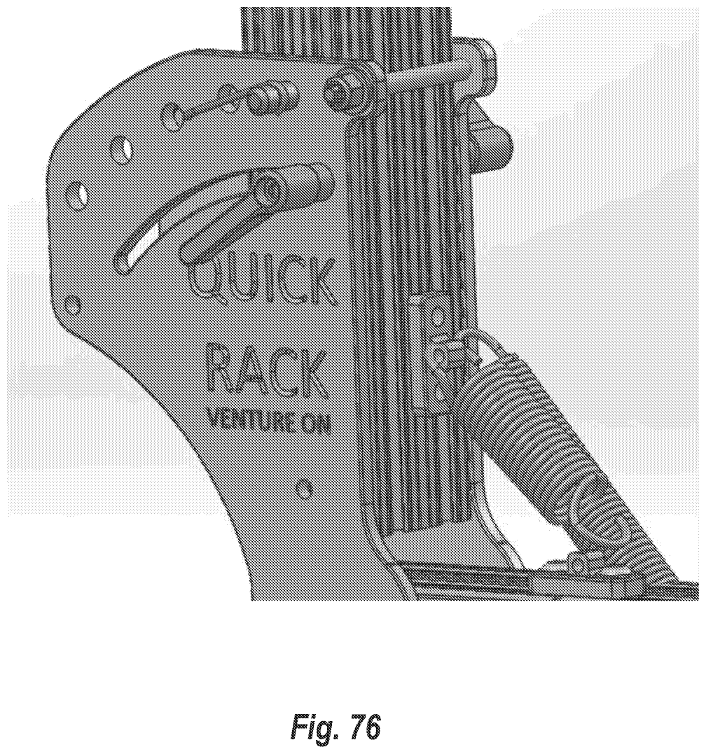

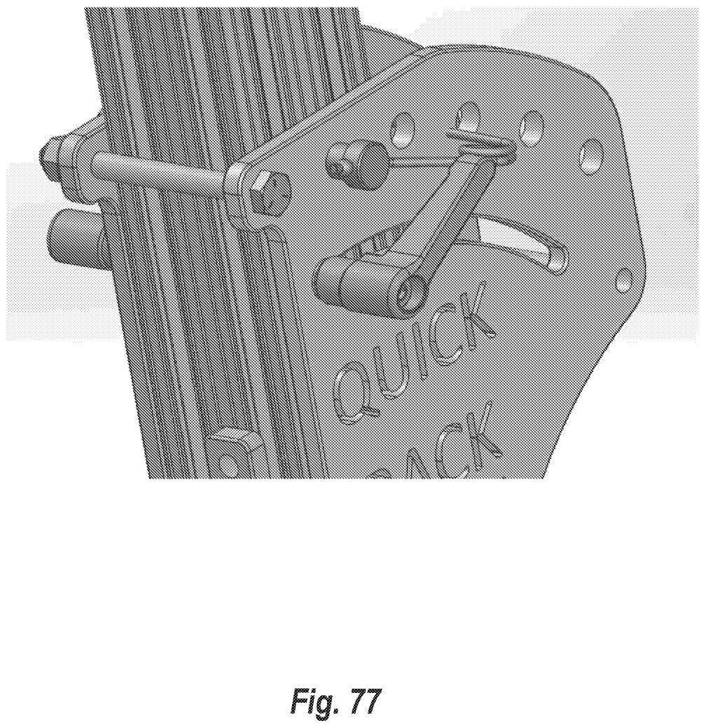

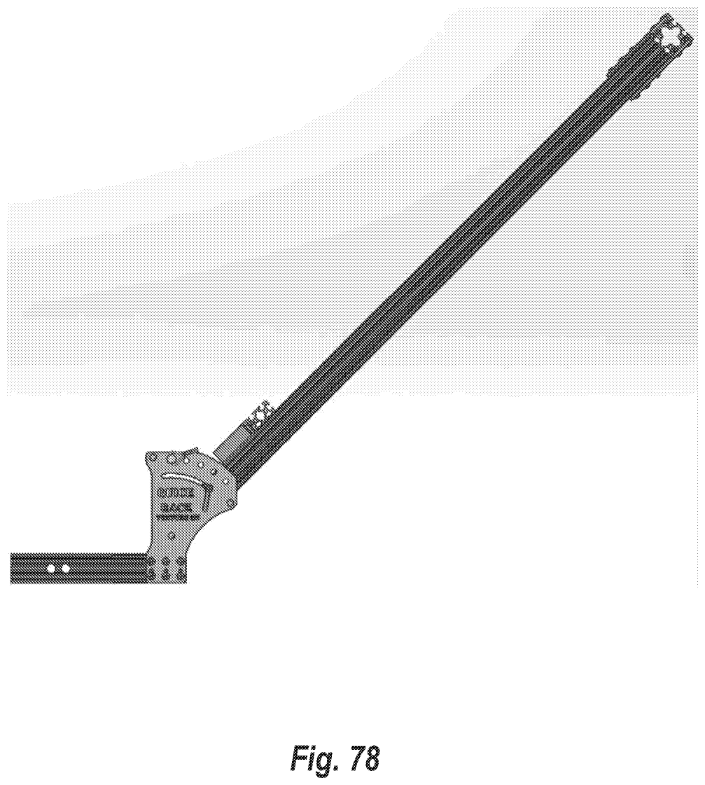

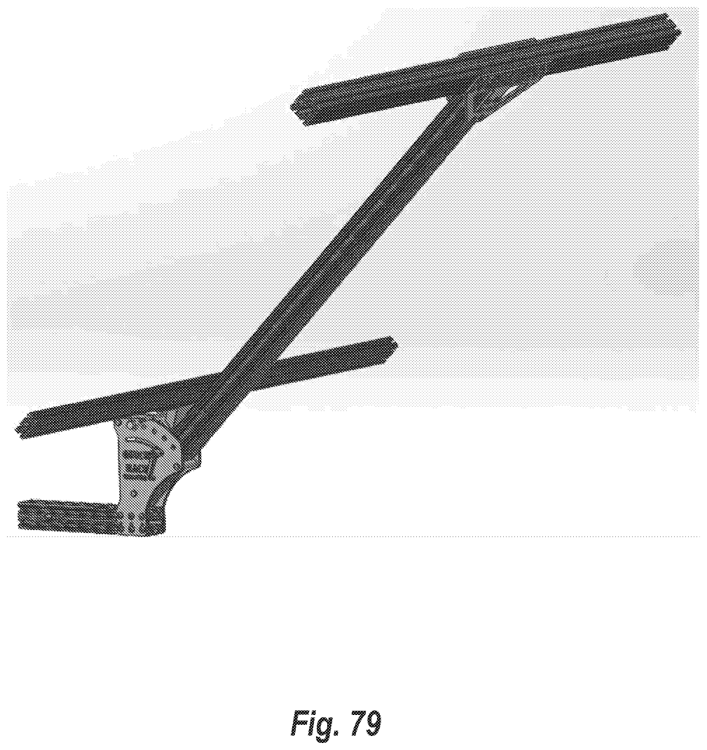

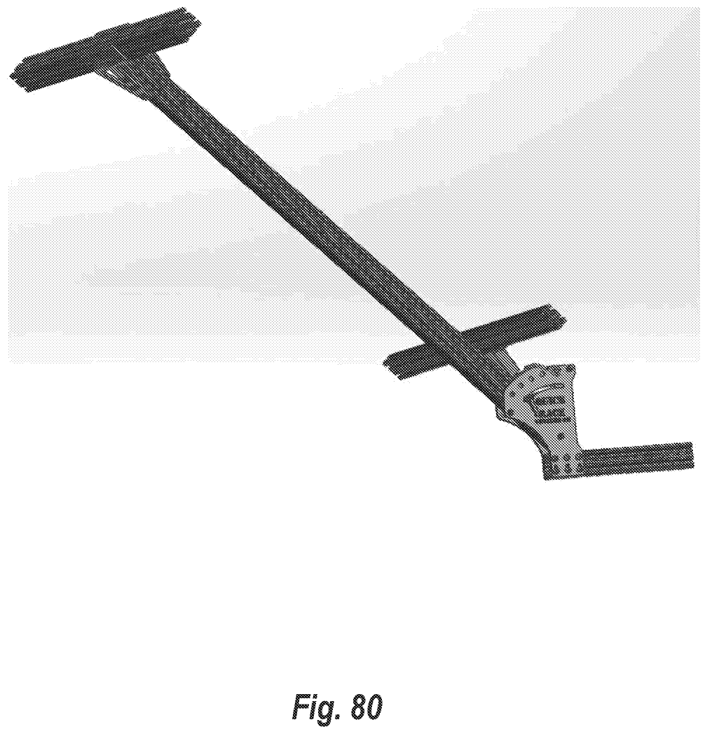

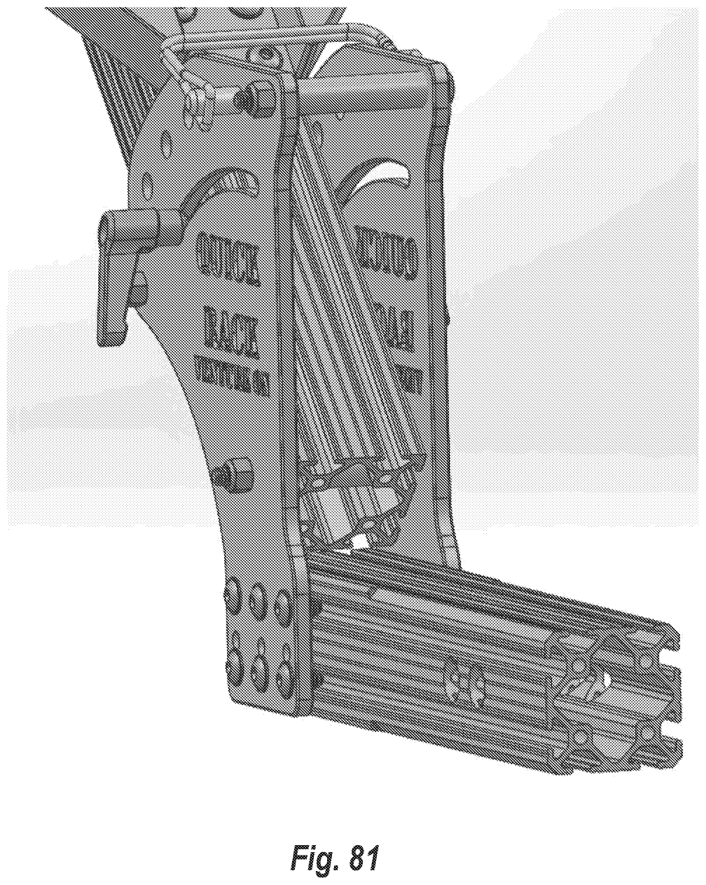

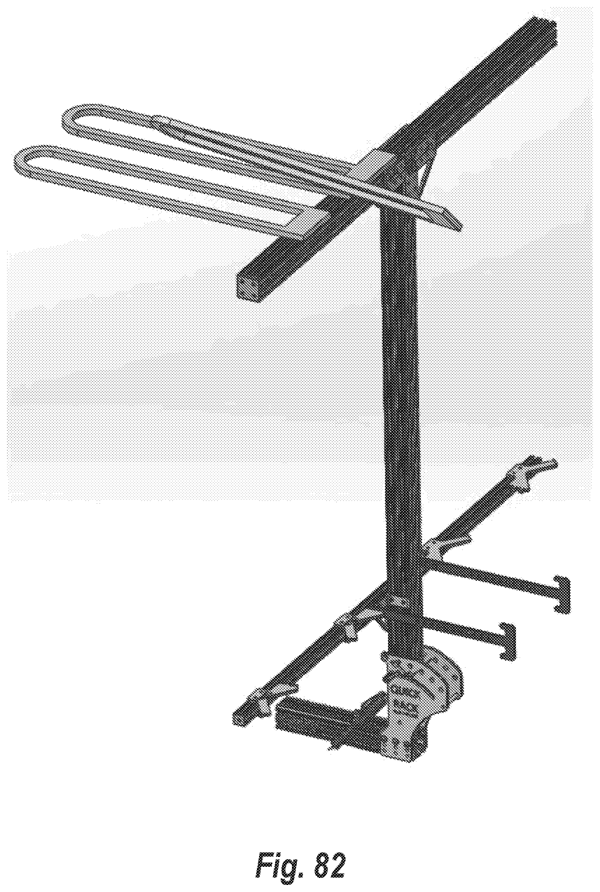

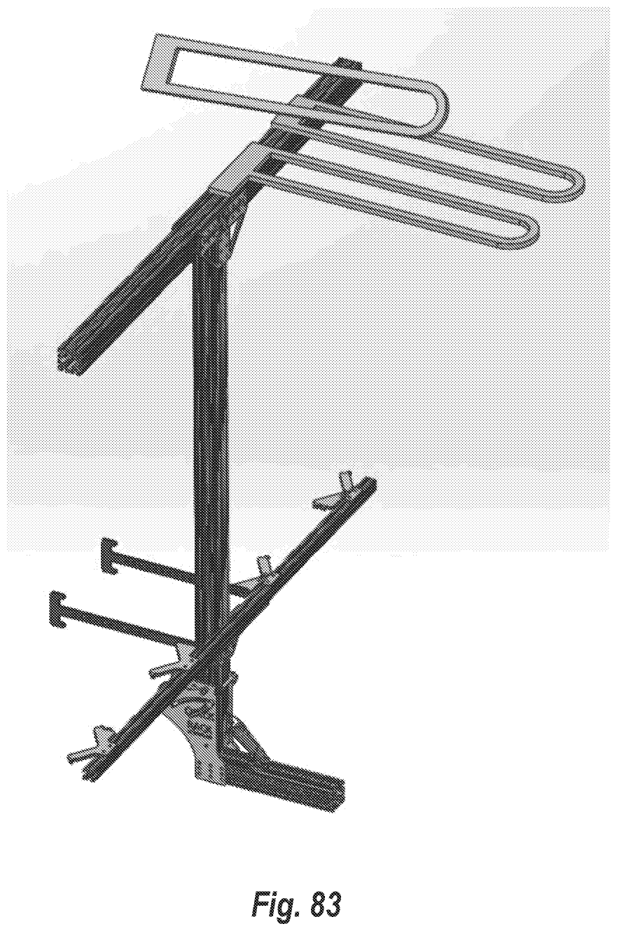

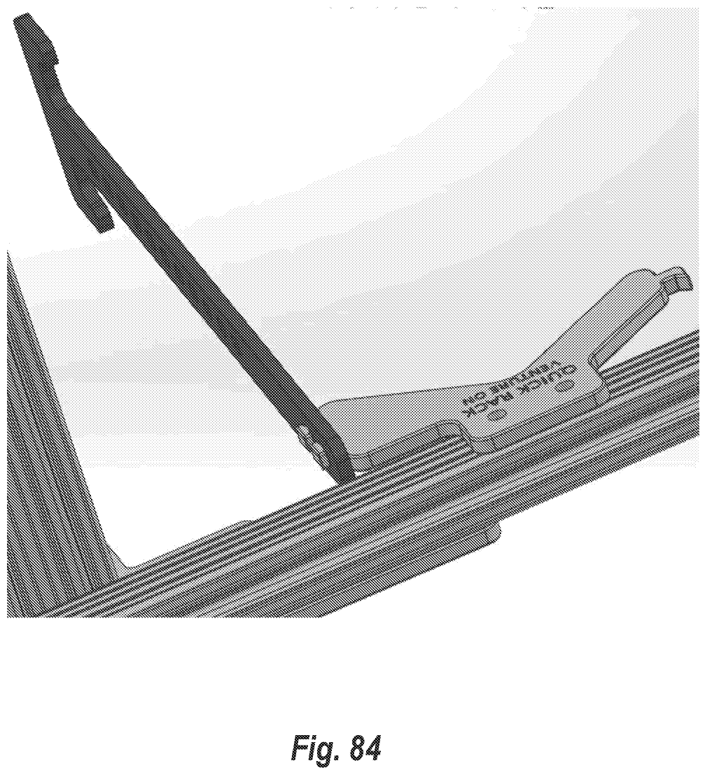

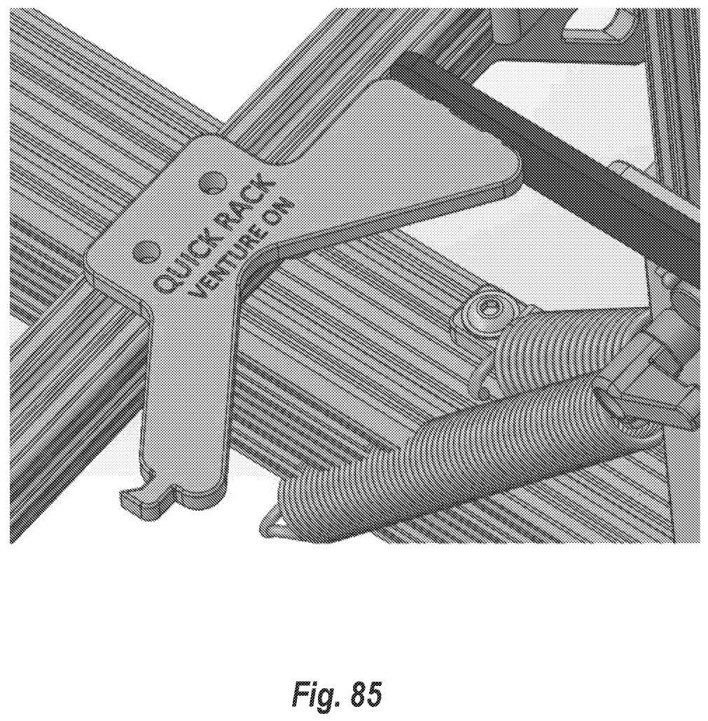

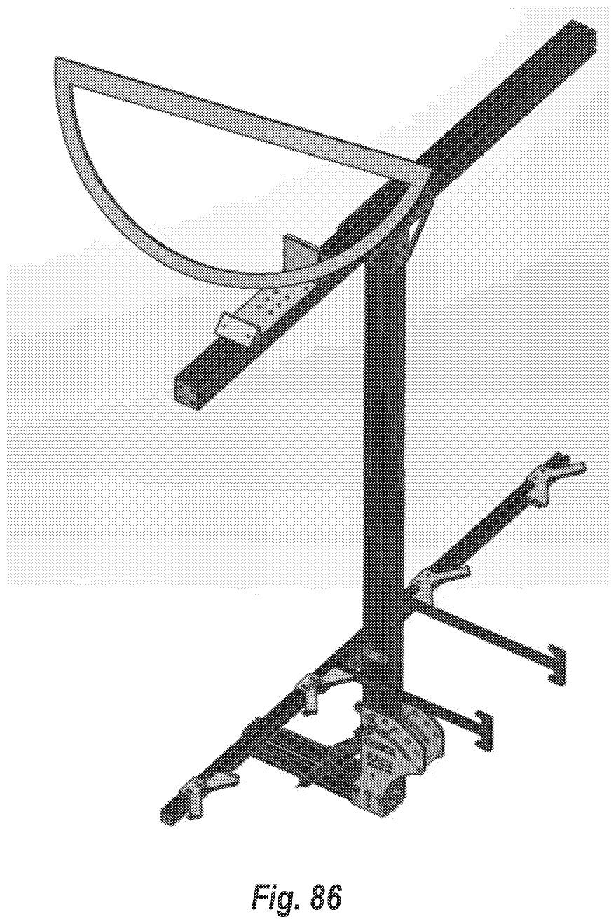

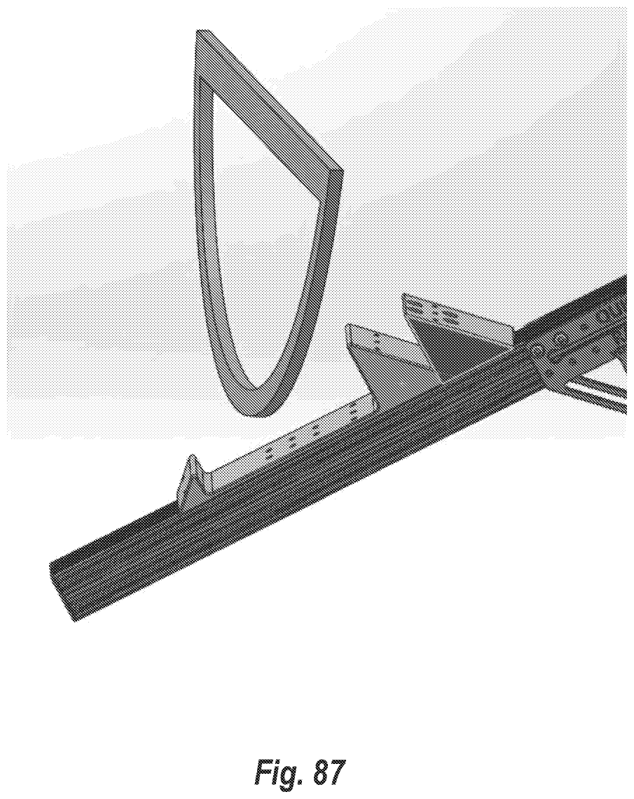

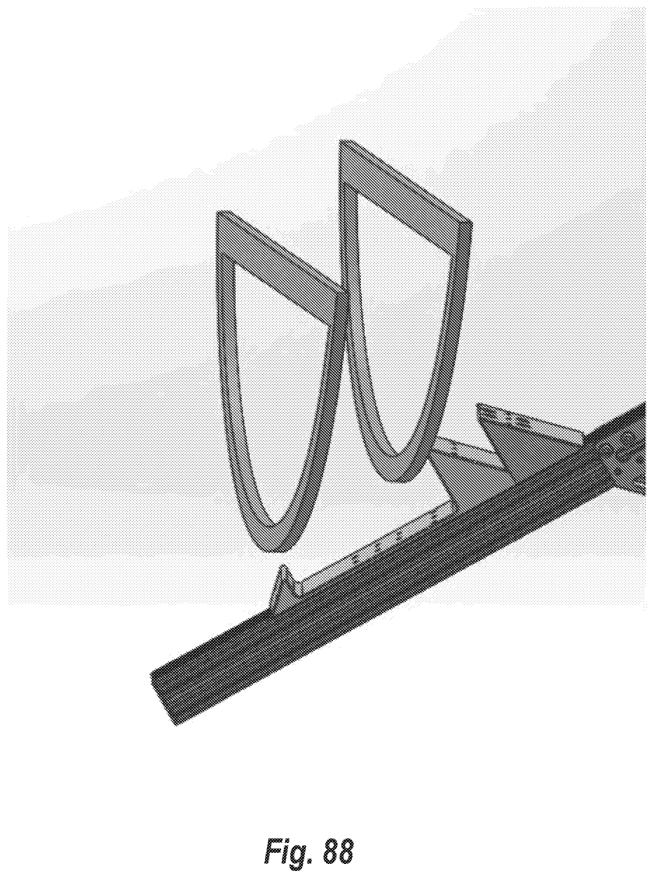

Additionally or alternatively, the hitch-mounted apparatus 100 may accommodate different payloads than the bike shown in FIGS. 1A-1D. For example, the hitch-mounted apparatus 100 may mount snowboards (e.g., as shown in FIGS. 66-68), wakeboards, skis, canoes, kayaks, paddleboards, hammock, etc. Additionally or alternatively, the hitch-mounted apparatus 100 may accommodate accessories, such as paddles, poles, recovery tracks, fluid containers (e.g., fuel, water, etc.), bike trailers, and the like. Further, in some embodiments, the hitch-mounted apparatus 100 may accommodate coolers, lockers, shelving, or other suitable storage space (e.g., for storing food, tents, sleeping bags, emergency/medical gear, or other supplies). Additionally or alternatively, the hitch-mounted apparatus 100 may mount a table (e.g., a foldable table that releases from a stowed configuration to an unstowed configuration for use). As another example, the hitch-mounted apparatus 100 can accommodate electrical power or charging device(s) (e.g., a rechargeable battery for charging an electric bike during transit). The foregoing examples are non-limiting. Indeed, the hitch-mounted apparatus 100 can mount myriad other items, accessories, and/or functional accommodations within the scope of the present disclosure.

In these or other embodiments, the hitch-mounted apparatus 100 can mount various accessories and/or payloads to one or more of the first support arm 102, the second support arm 104, or the connecting member 106 via the slots 114. For example, the hitch-mounted apparatus 100 can utilize hooks, racks, tie downs, ski or snowboard holders, binding clips, paddle holders, etc. that leverage the slots 114 (e.g., in a same or similar manner as described above). Accordingly, the hitch-mounted apparatus 100 can mount numerous accessories and/or payloads, but also in a variety of positional configurations as desired.

Additionally or alternatively, the hitch-mounted apparatus 100 can support payloads extending from the vehicle (e.g., a truck bed or vehicle trunk/cab). For example, to support longer payloads such as canoes, paddleboards, or construction items (e.g., two-by-fours, baseboard trim, etc.), the first support arm 102 of the hitch-mounted apparatus 100 may secure a portion of these payloads. Accordingly, in some embodiments, the hitch-mounted apparatus 100 comprises a height that extends above a tailgate height such that the first support arm 102 secures and supports at least a portion of the payload instead of a vehicle tailgate or bedrail.

Further, in some embodiments, one or more of the first support arm 102, the second support arm 104, the connecting member 106, and/or the hitch tube 108 comprise extendable (e.g., telescoping) portions. For example, the first support arm 102 and the second support arm 104 may extend outward to accommodate additional bikes or other payloads. Similarly, for instance, the connecting member 106 may extend to various heights (e.g., to accommodate shorter and longer payloads as needed). Likewise, the hitch tube 108 may extend inwards or outwards away from the vehicle to provide additional clearance with the vehicle and/or support additional cantilevered weight by adjusting the moment arm (e.g., reducing the distance between the vehicular hitch receiver and the connecting member 106).

In some embodiments, one or more elements of the hitch-mounted apparatus 100 comprise a different configuration than illustrated. For example, the hitch-mounted apparatus 100 may include solid portions (e.g., a solid first support arm, solid second support arm, a solid connecting member, etc.). For instance, with solid first and second support arms, the hitch-mounted apparatus 100 comprises fixed or predetermined positions for arranging the upper and lower retention mechanisms. Similarly, with a solid connecting member, the hitch-mounted apparatus 100 comprises fixed or predetermined positions for configuring the second support arm at certain heights/intervals along the connecting member. In other embodiments, the hitch-mounted apparatus 100 utilizes compression locks, clamps, magnets, etc. to position one or more elements relative to a solid member (e.g., a clamp for connecting an upper retention mechanism to a solid first support arm).

Further, in some embodiments, one or more components of the hitch-mounted apparatus 100 comprise additional or alternative materials to aluminum described above. For instance, one or more components of the hitch-mounted apparatus 100 comprise steel, galvanized steel, titanium, carbon fiber, and/or other suitable materials. Accordingly, one or more embodiments of the hitch-mounted apparatus 100 include additional or alternative means of connecting members (e.g., via welding, permanent fasteners, braces, brackets, adhesives, and/or other suitable means).

As mentioned above, the hitch-mounted apparatus 100 can secure portions of a payload via an upper retention mechanism. FIGS. 2A-2D illustrate the upper retention mechanism 110 of the hitch-mounted apparatus 100 in accordance with one or more embodiments. As shown, the upper retention mechanism 110 comprises side plates 202-204, base mounts 206a-206b, and an adjustable restraint 210. In these or other embodiments, the upper retention mechanism 110 is sized and shaped to receive a variety of types and sizes of bike wheels and tire widths (e.g., by independently adjusting a position of the side plate 202 and the side plate 204 relative to each other along the first support arm 102). However, in other embodiments, the upper retention mechanism 110 can be sized and shaped to receive a variety of other accessories and/or payloads as indicated above.

In more detail, the side plate 202 comprises access slots 208, protrusions 212, stop-pin holes 214a-214b, and fasteners 220. Via the access slots 208, one or more fasteners (not shown) can be accessed that secure the base mount 206a to the first support arm 102 via the slots 114. By loosening such fasteners, a compression force between the base mount 206a and the first support arm 102 is reduced allowing the base mount 206a to slide (e.g., independent of the base mount 206b) along the slots 114 of the first support arm 102. In this manner, the side plate 202 can slidably adjust relative to the side plate 204 for fitting wheels and tires comprising a variety of different thicknesses or widths (e.g., snow-bike tires, fat bike tires, mountain bike tires, road cycling tires, etc.).

With respect to the protrusions 212, the protrusions 212 comprise integrated hooks or anchors for securing the adjustable restraint 210. For example, to secure a bike wheel, the adjustable restraint 210 may wrap at least partially around the bike wheel. To illustrate, the adjustable restraint 210 is anchored at a first protrusion of the protrusions 212, proceeds between spokes of a bike wheel, advances around a tire tread of the bike wheel, and hooks onto a second protrusion of the protrusions 212. Thus, via the protrusions 212, the adjustable restraint 210 can secure the bike wheel in place between the side plate 202 and the side plate 204.

The stop-pin holes 214a and the stop-pin holes 214b are sized and shaped (and in some cases, threaded) to receive and/or engage stop-pins 216. Positioned along the side plate 202, the stop-pin holes 214a and the stop-pin holes 214b are arranged such that the stop-pins 216 can provide a mechanical stop for a variety of bike wheel types and sizes (e.g., as shown in FIG. 2D). For example, larger diameter bike wheels may involve positioning the stop-pins 216 at greater distances apart from each other (e.g., at farthest outer stop-pin holes of the respective stop-pin holes 214a and stop-pin holes 214b). Contrary, smaller diameter bike wheels may involve positioning the stop-pins 216 at smaller distances apart from each other (e.g., at inner most stop-pin holes of the respective stop-pin holes 214a and stop-pin holes 214b). In this manner, the stop-pin holes 214a and the stop-pin holes 214b allow the upper retention mechanism 110 to provide a mechanical stop for securing a bike wheel against the stop-pins 216 and/or preventing the bike wheel from falling through or bouncing out of the upper retention mechanism 110. For example, the adjustable restraint 210 may compress the bike wheel against the stop-pins 216 to provide a safe, secure hold for the bike wheel.

In addition, respective sets of the fasteners 220 (e.g., screws, bolts, etc.) correspondingly secure the side plate 202 and the side plate 204 to the base mount 206a and the base mount 206b. Moreover, in some embodiments, the respective sets of the fasteners 220 allow the side plate 202 and the side plate 204 to adjust a corresponding angle of connection to the base mount 206a and the base mount 206b. For example, by tightening the respective sets of the fasteners 220, the side plate 202 and the side plate 204 are compressed flush against the base mount 206a and the base mount 206b (e.g., at predetermined angles). On the other hand, by loosening the respective sets of the fasteners 220, the side plate 202 and the side plate 204 can be adjusted to alternative angles (and/or different angles relative to each other). By being able to adjust the angle of connection to the base mount 206a and the base mount 206b via the respective sets of the fasteners 220, the side plate 202 and the side plate 204 can determine an angle at which the bike wheel is secured within the upper retention mechanism 110 (e.g., to provide additional clearance between bikes).

Additionally shown, the upper retention mechanism 110 comprises the side plate 204. The side plate 204 may include the same or similar features as described above in relation to the side plate 202. However, as shown in FIGS. 2A-2D, the side plate 204 omits one or more features of the side plate 202 just described. By omitting one or more features, for example, the side plate 204 can increase manufacturing speed and reduce manufacturing resources.

Modifications, additions, or omissions may be made to the embodiments illustrated and described in relation to FIGS. 2A-2D without departing from the scope of the present disclosure. For example, in some embodiments, the base mount 206a and the base mount 206b (shown as separate, independent components of the upper retention mechanism 110) may form a single combined mounting base. Thus, in some embodiments, the side plate 202 and the side plate 204 may be dependently adjustable (e.g., moving one causes the other to move as well). In other embodiments incorporating a single mounting base for the side plate 202 and the side plate 204, the side plate 202 and the side plate 204 may nonetheless be independently adjustable relative to each other. For example, the side plate 202 and the side plate 204 may each slide or otherwise adjust relative to the single mounting base.

Similarly, in other embodiments, different variations of the adjustable restraint 210 and/or the protrusions 212 are herein contemplated. For example, instead of an elastic band with holes for engaging the protrusions 212, the adjustable restraint 210 may utilize Velcro® straps, chains, steel cables, webs, cords, tie downs, zip ties, or other securing mechanisms. Similarly, in other embodiments, the protrusions 212 may comprise hooks, clasps, carabiner connections, spring links, interlocking connections, or other suitable means of attachment.

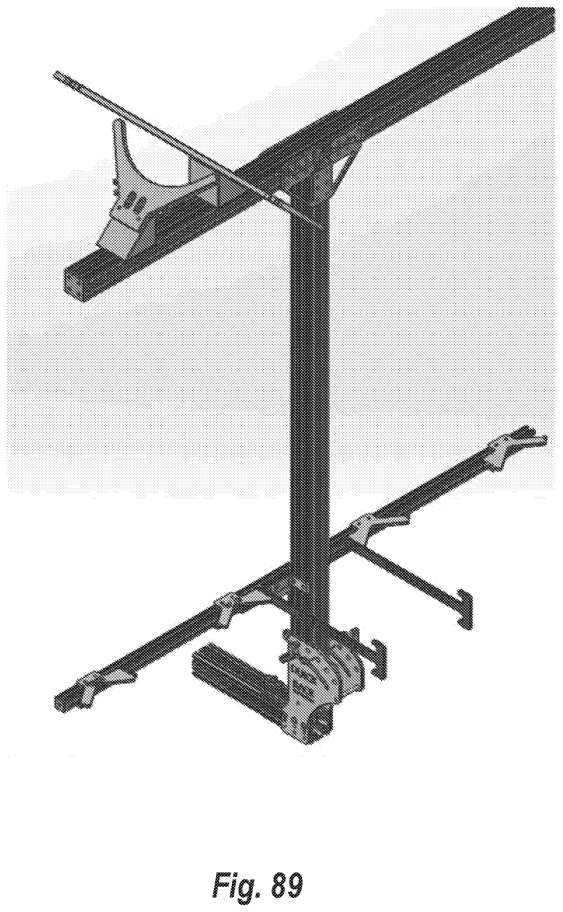

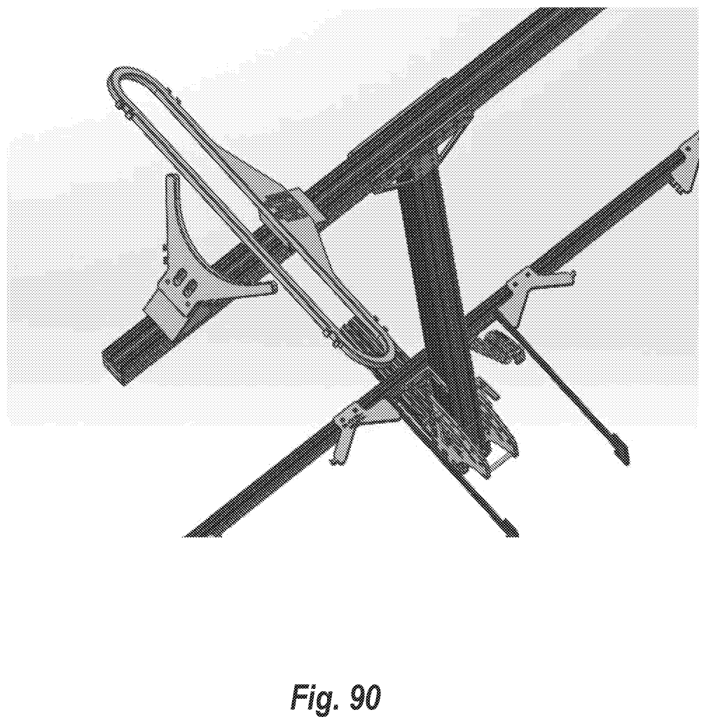

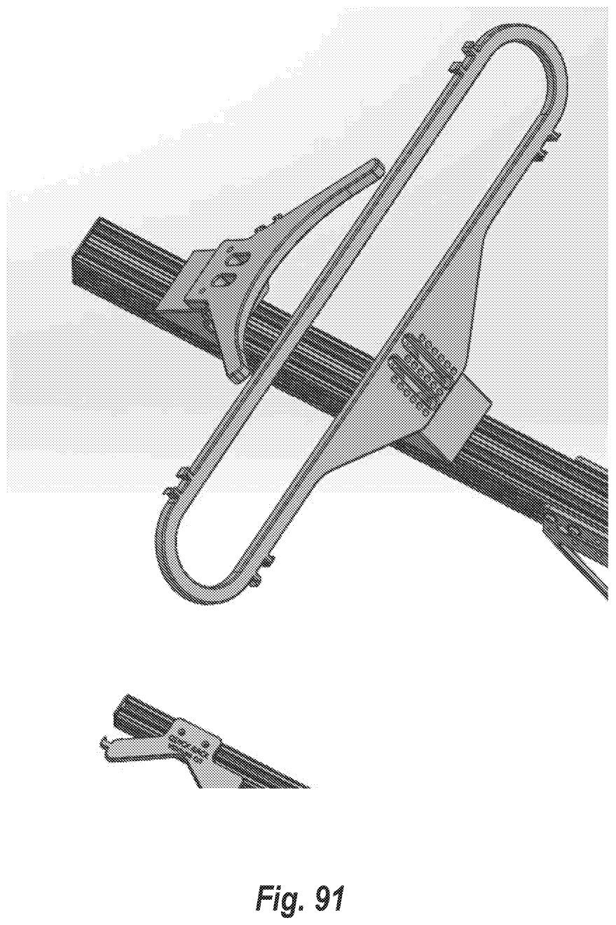

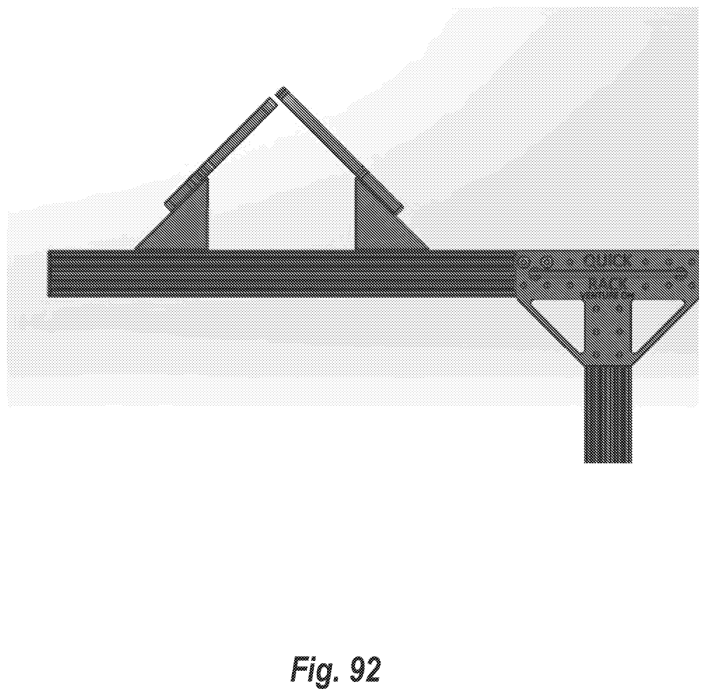

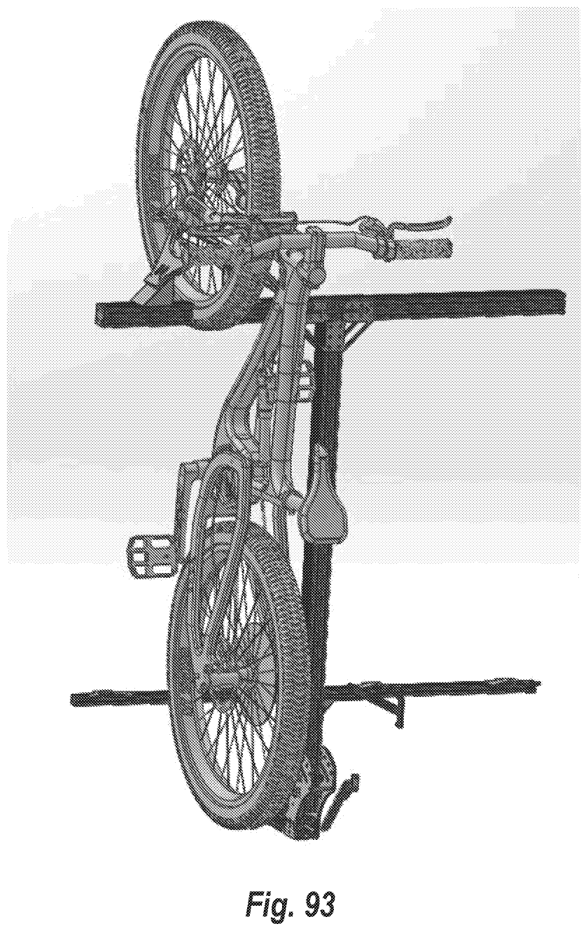

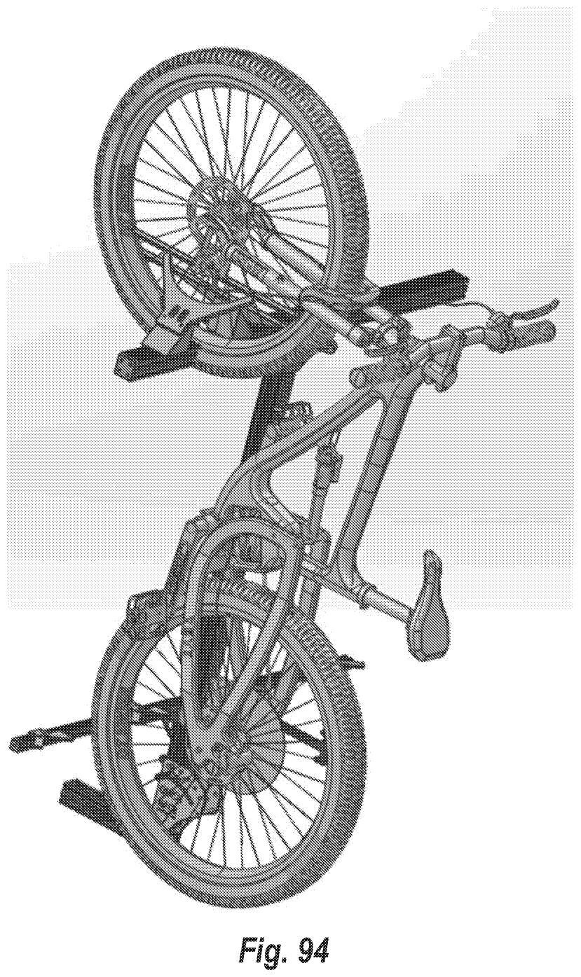

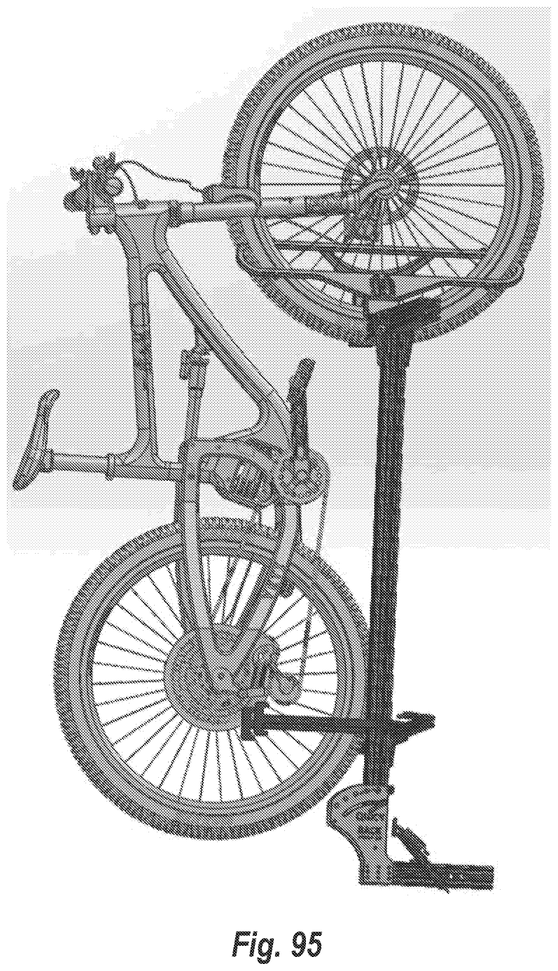

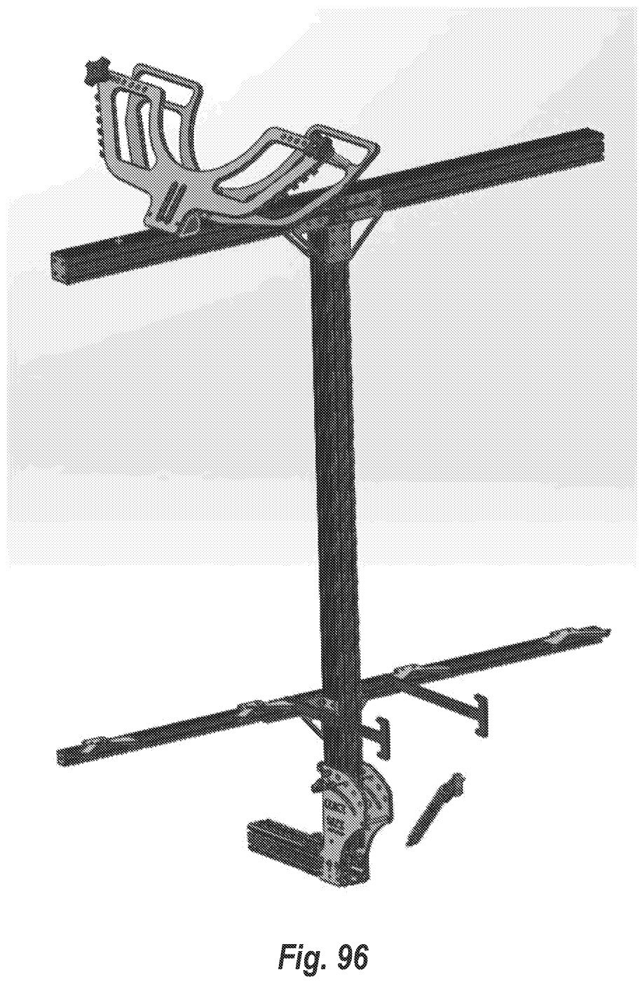

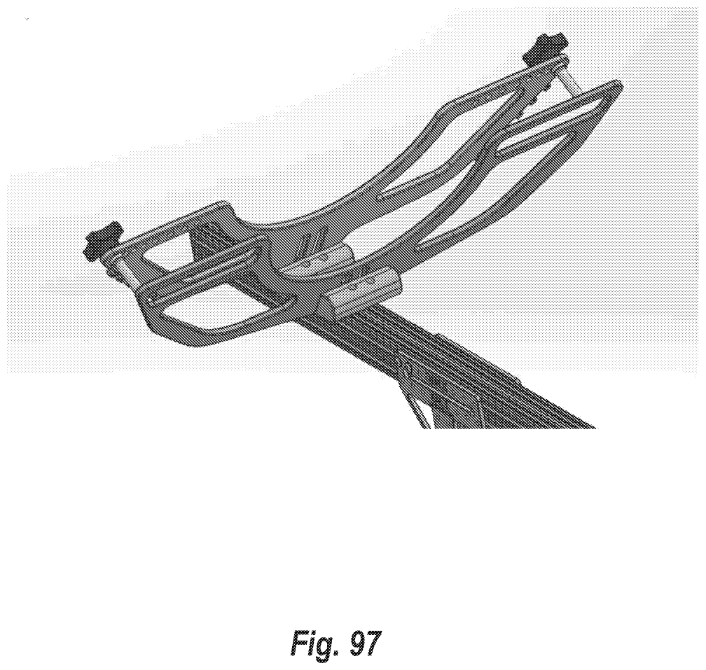

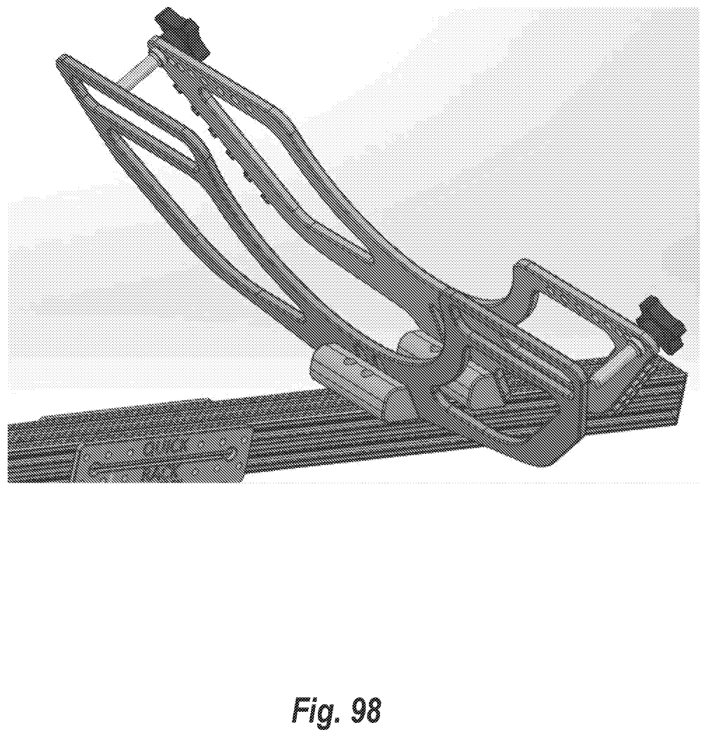

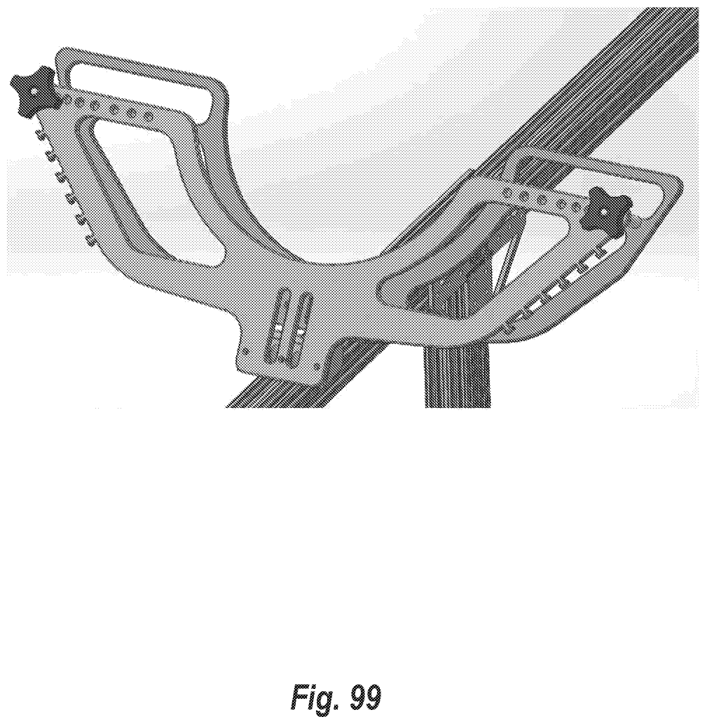

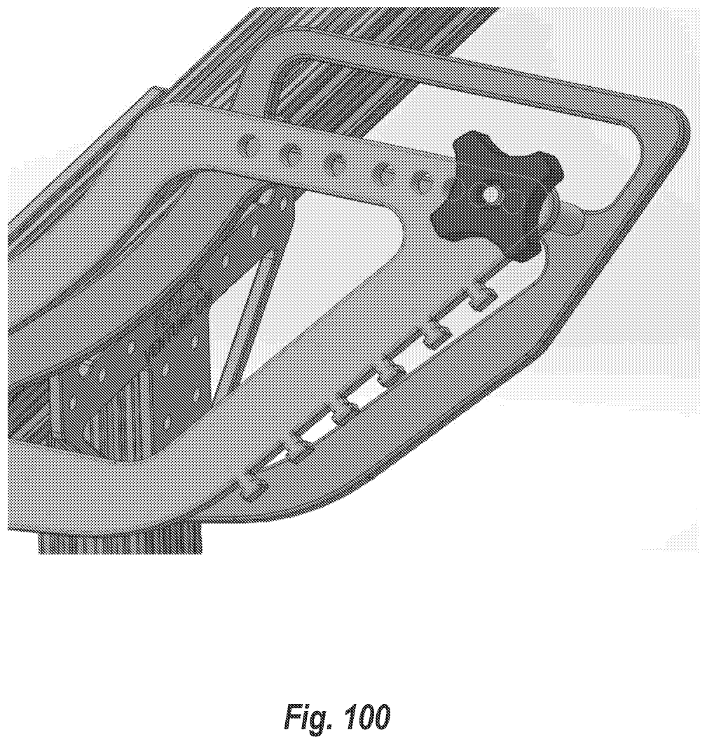

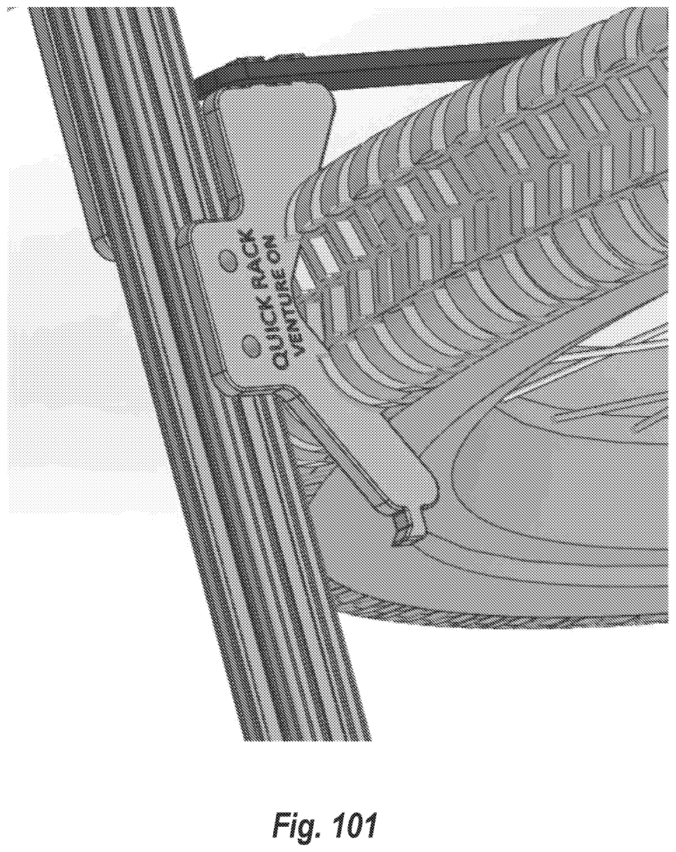

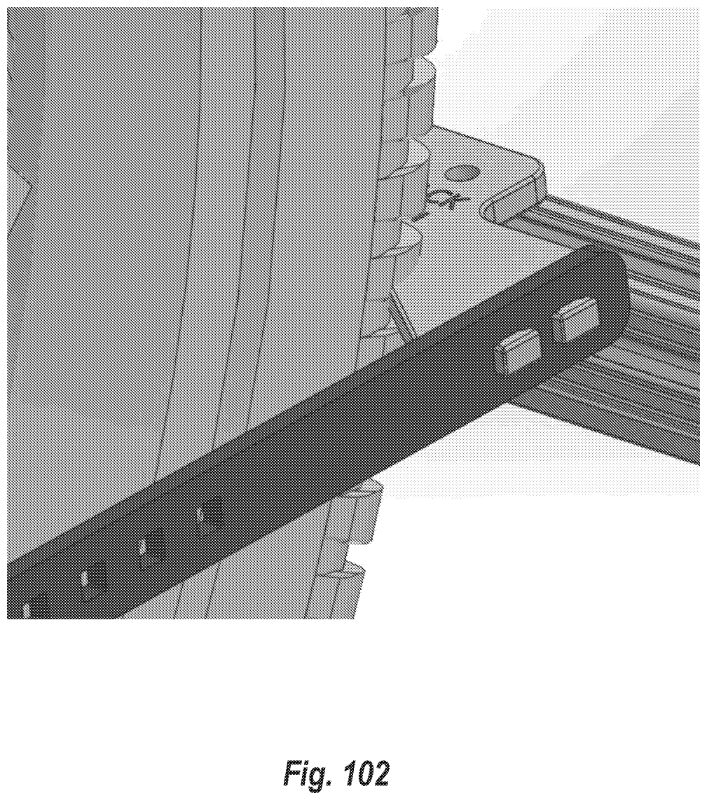

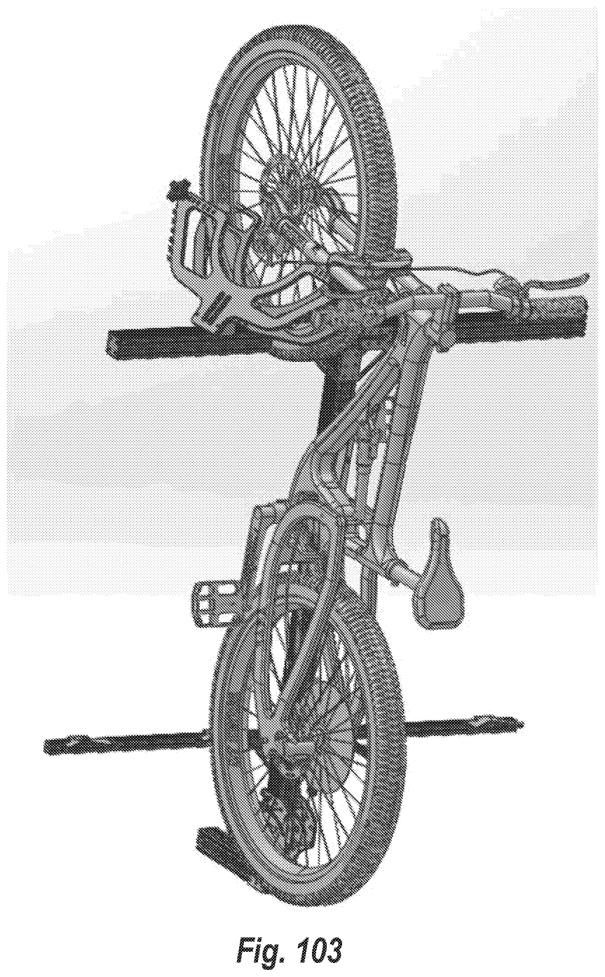

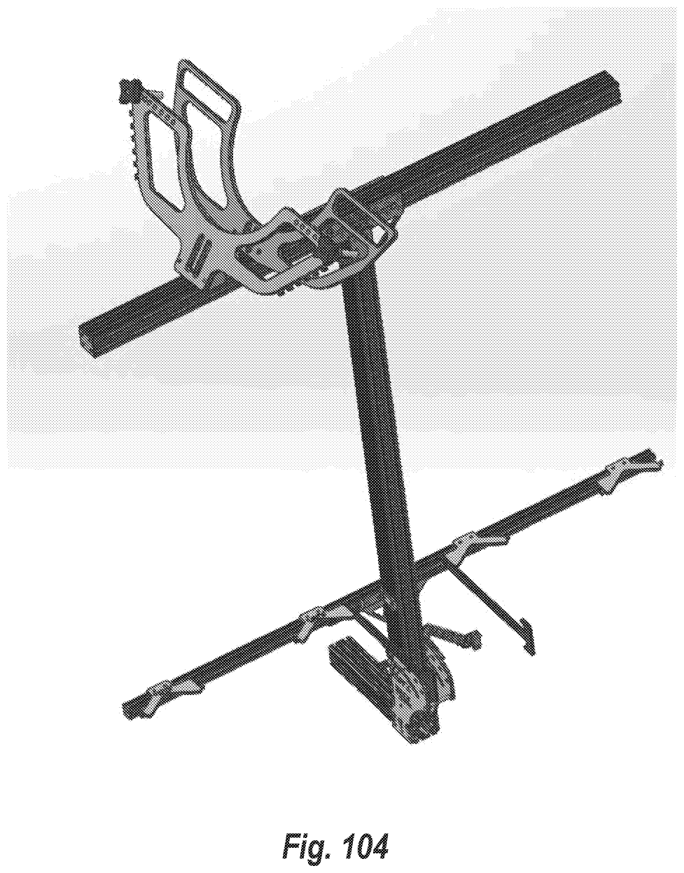

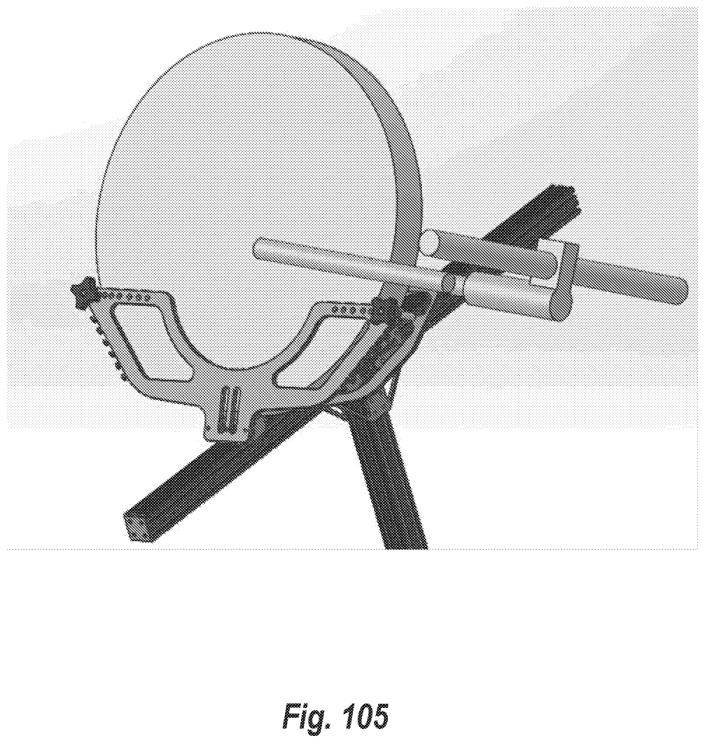

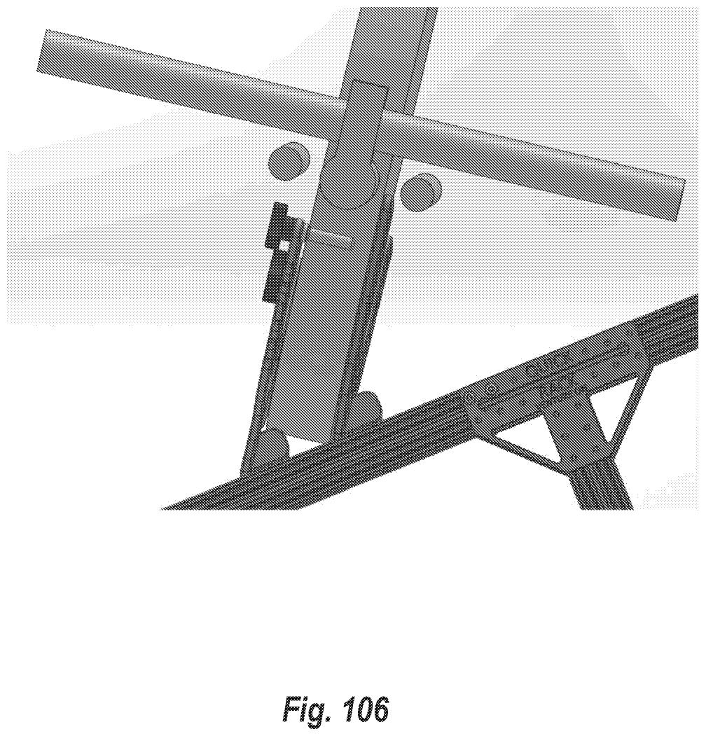

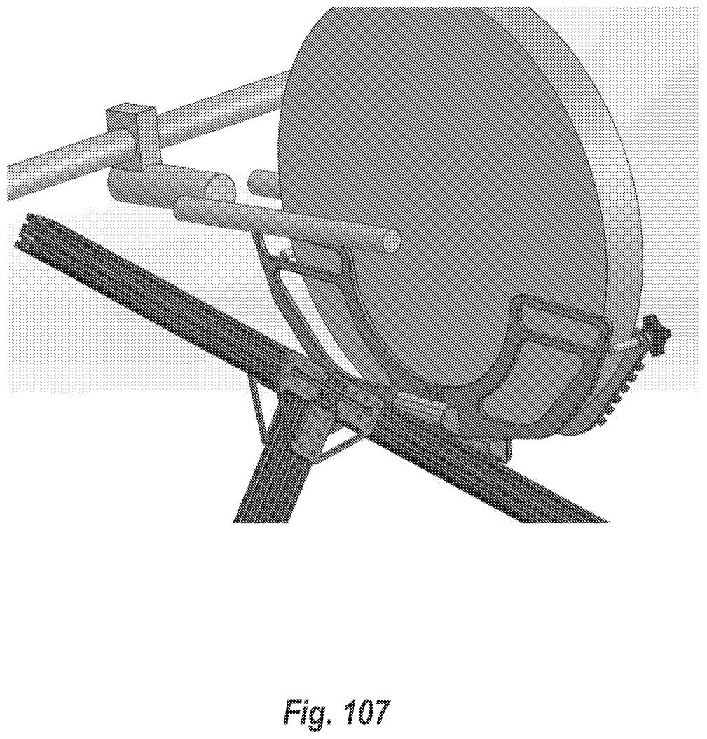

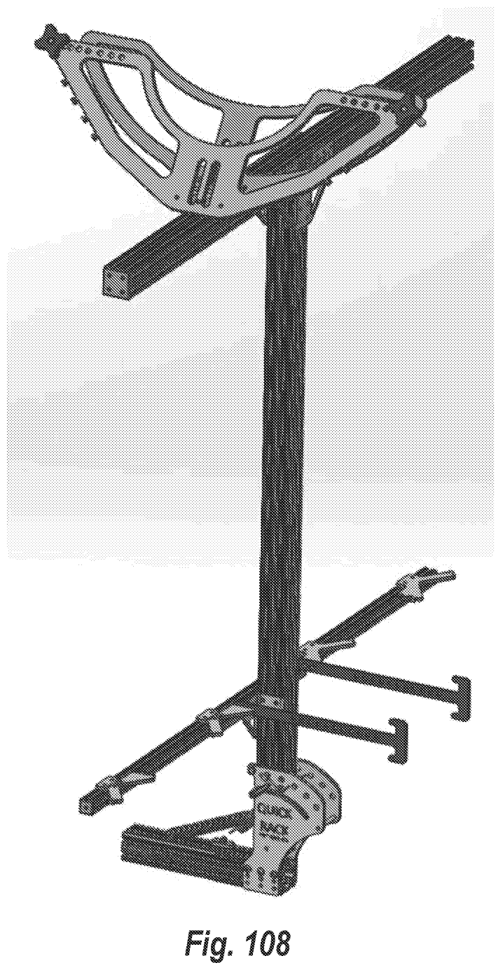

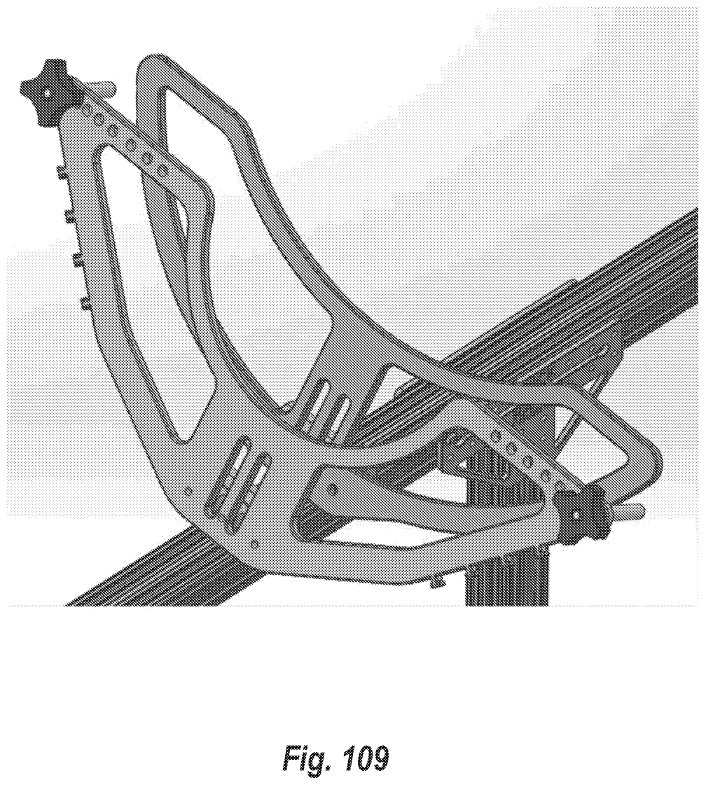

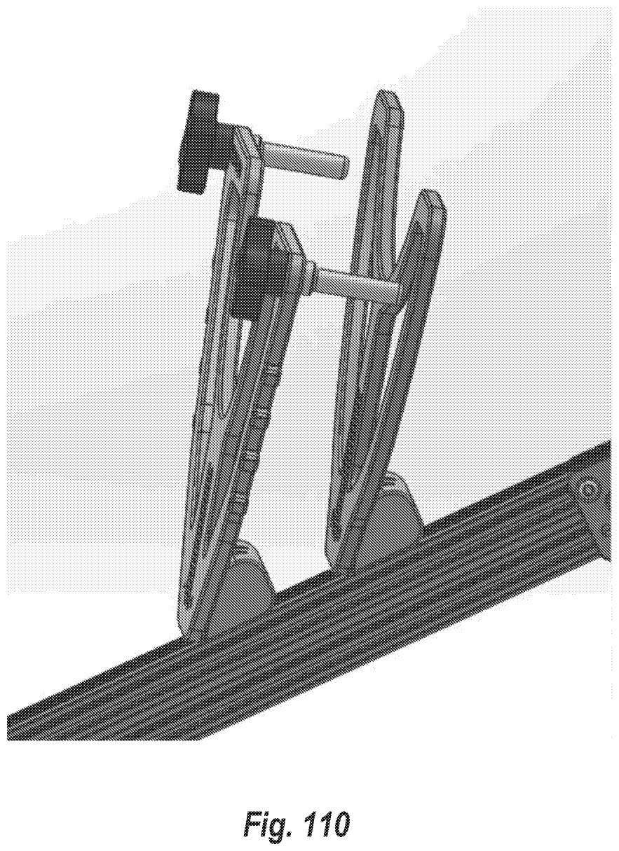

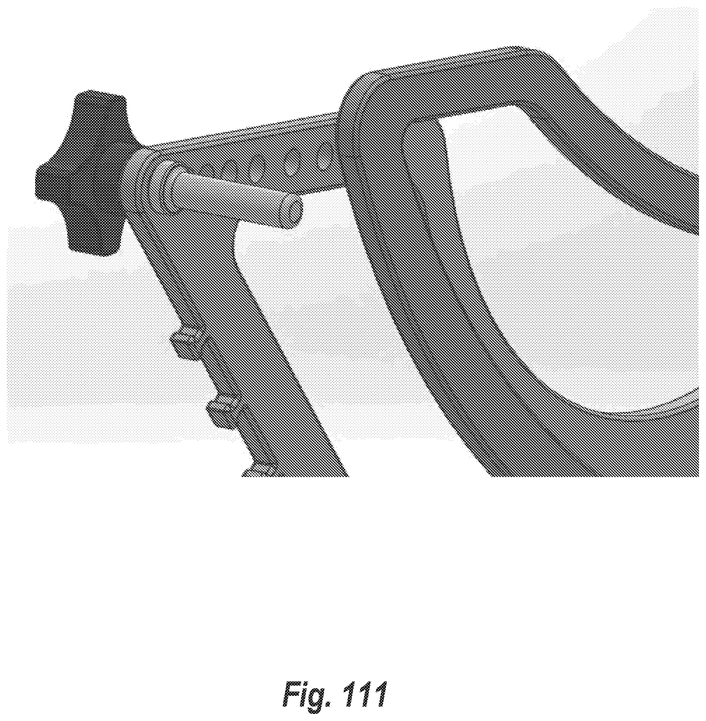

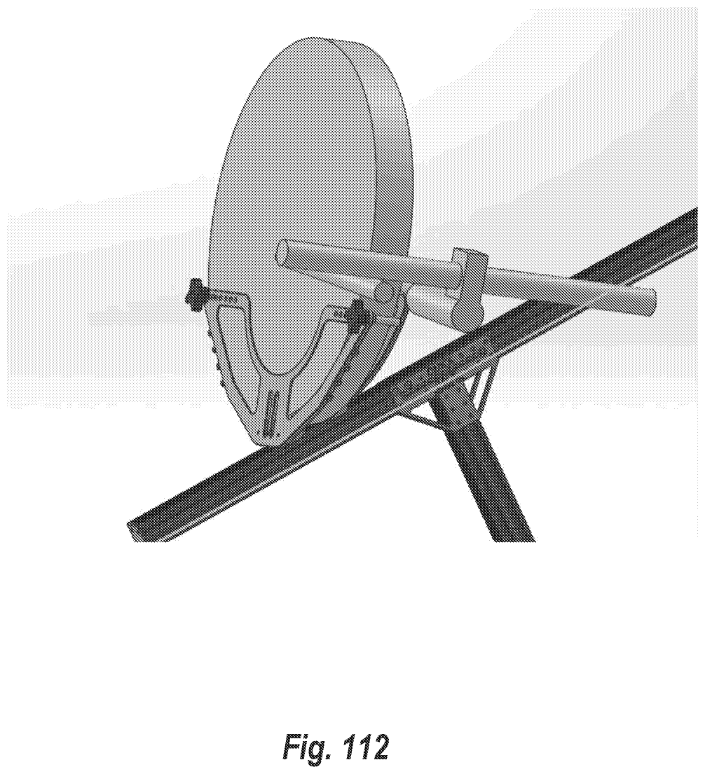

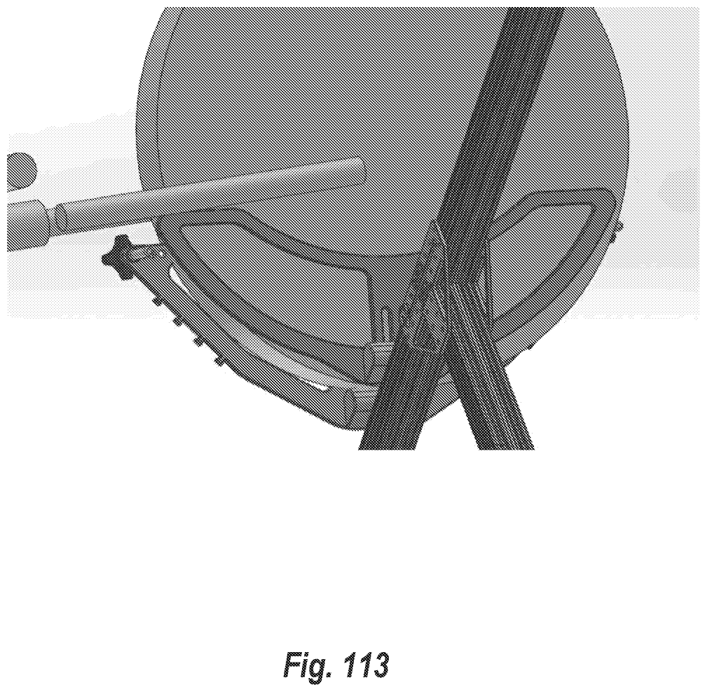

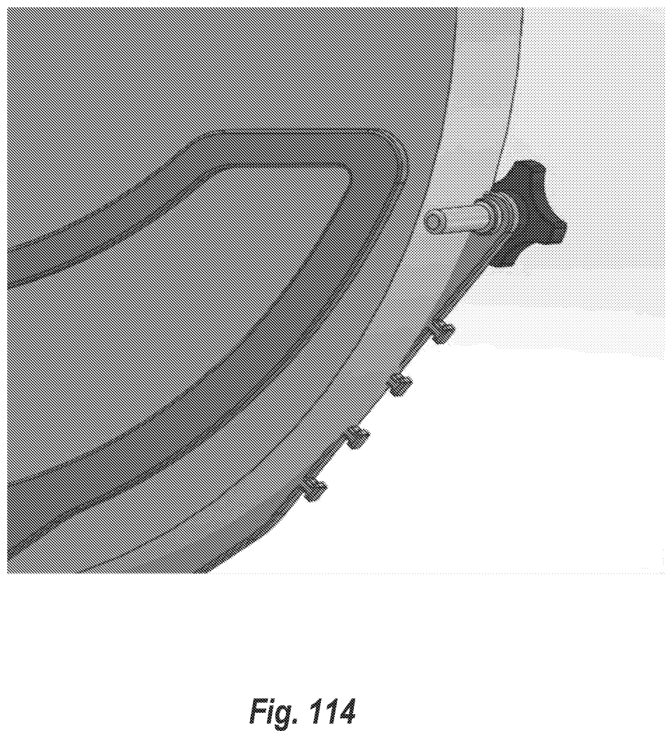

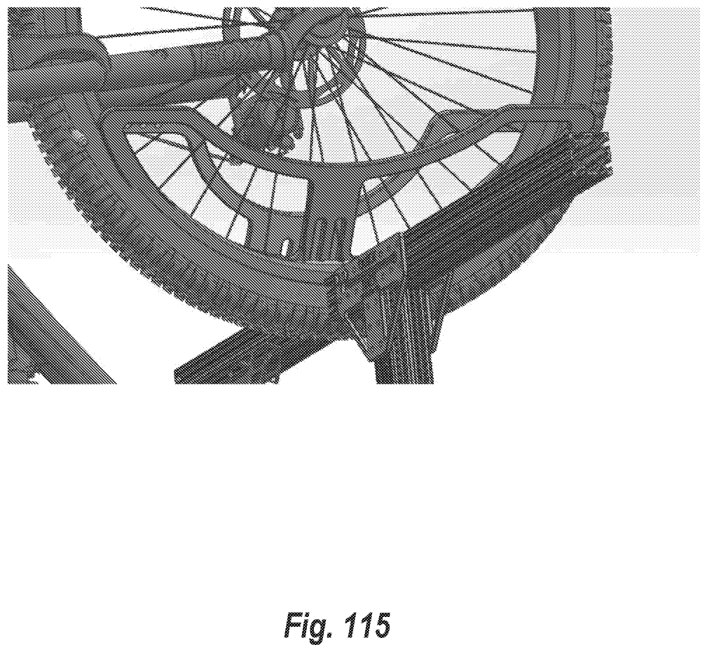

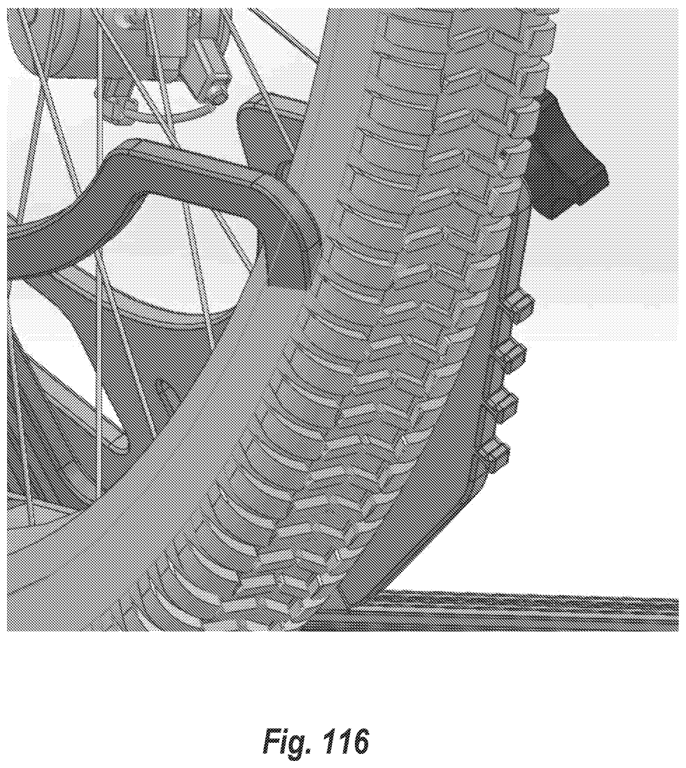

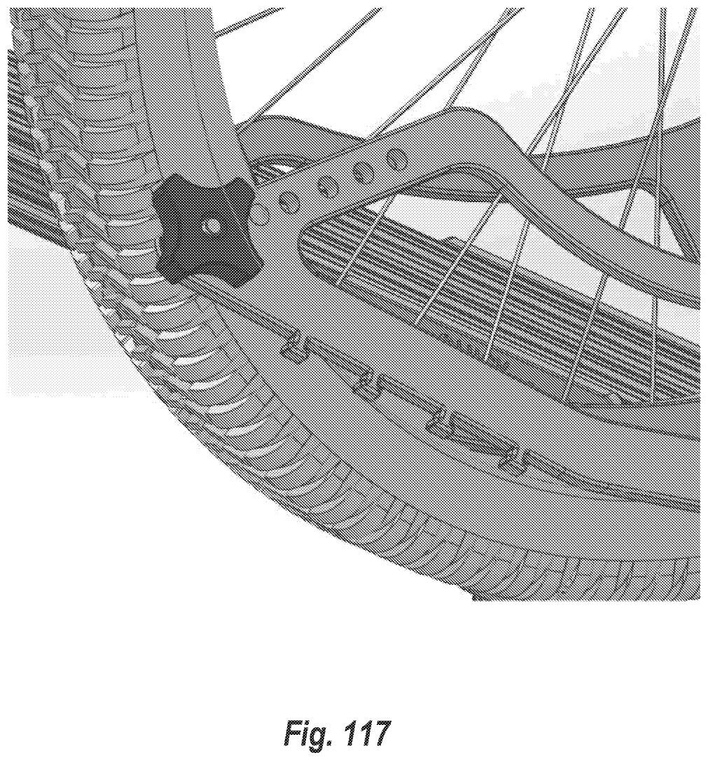

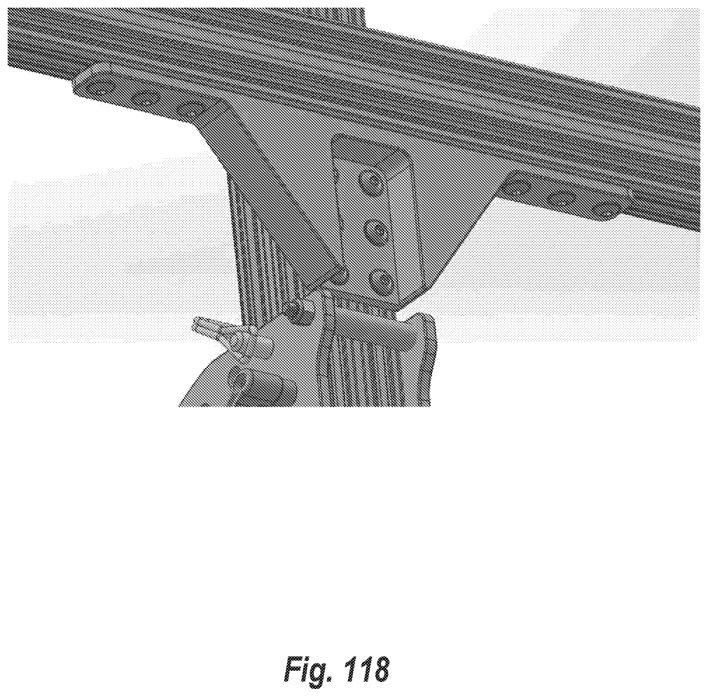

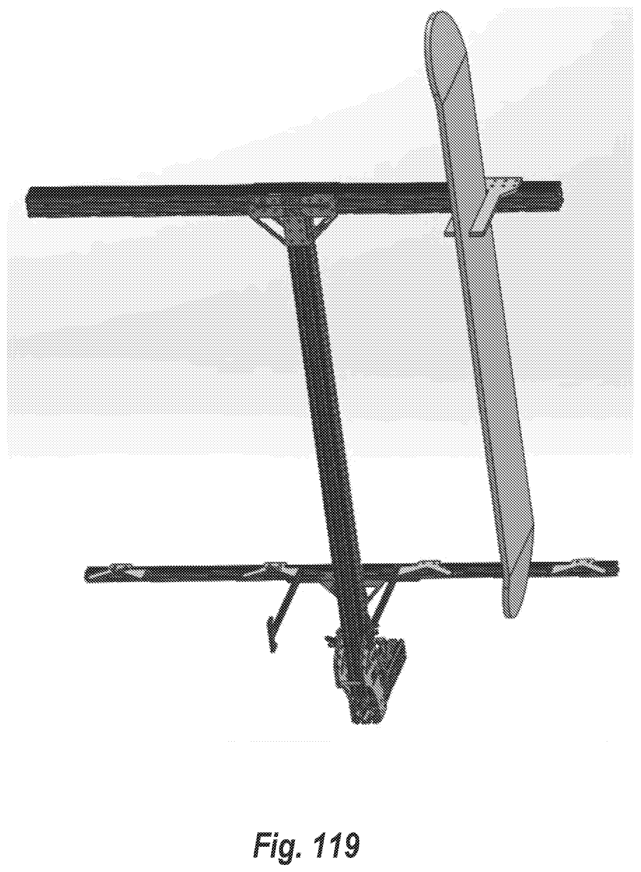

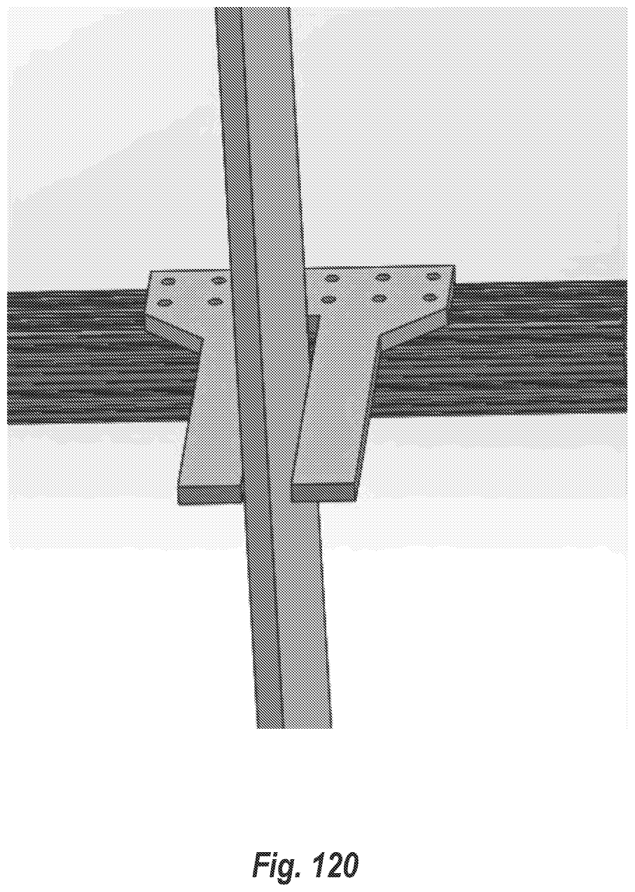

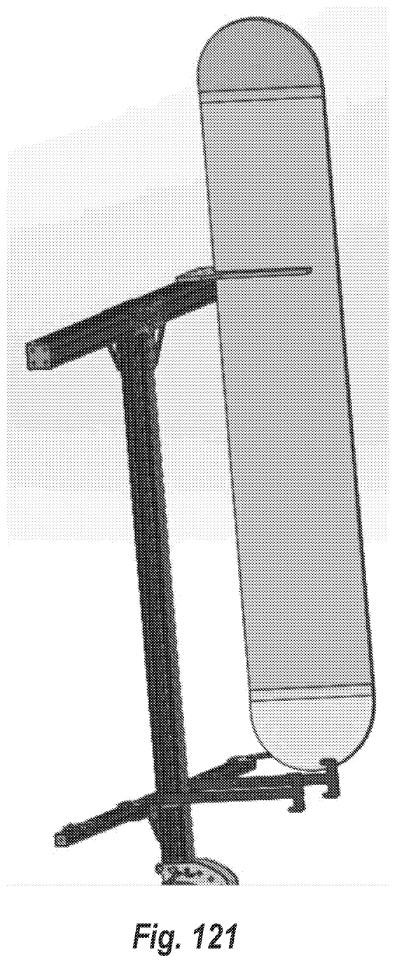

Further, in some embodiments, the side plate 202 and/or the side plate 204 comprise additional or alternative features or designs. For instance, in certain embodiments (e.g., FIGS. 89-95), one of the side plate 202 or the side plate 204 is sized and shaped as a holding plate to accommodate a portion of the diameter of a bike wheel such that at least part of the bike wheel sits inside the holding plate. If applicable, another companion plate can function as a locking plate that keeps the bike wheel from bouncing out of or falling through the holding plate.

As mentioned above, the hitch-mounted apparatus 100 includes a lower retention mechanism adjustably connected to the 104 for securing at least a portion of a payload. FIGS. 3A-3C illustrate a lower retention mechanism 300 of the hitch-mounted apparatus 100 in accordance with one or more embodiments. As shown, the lower retention mechanism 300 comprises a wheel rest 302 (and in certain embodiments, an adjustable restraint not shown). The wheel rest 302 may be sized and shaped to fit a variety of bike wheels (including a bike wheel 308 as shown in FIG. 3A). In addition, the wheel rest 302 may be formed to create a “V”-shape or “U”-shape (or other shapes or retaining features and configurations) such that the bike wheel does not slide along the second support arm 104. In these or other embodiments, the depth, size, and/or angle of the “V”-shape or “U”-shape (or other shapes or retaining features and configurations) of the wheel rest 302 may comprise any suitable depth, size, and/or angle dependent on the payload (e.g., the bike wheel size).

Additionally, to maintain the bike wheel 308 within the wheel rest 302, an adjustable restraint can be threaded through wheel spokes to secure the bike wheel 308 in a same or similar manner as described above in relation to the adjustable restraint 210 of FIG. 2A. For example, the adjustable restraint attaches to a protrusion on one side of the wheel rest 302, advances between wheel spokes of the bike wheel 308, and attaches to another protrusion on the other side of the wheel rest 302.

Similarly, and as described above with respect to the upper retention mechanism 110, the wheel rest 302 can also slidably adjust to a desired position along the second support arm 104. For example, by loosening fasteners disposed within the slots 114 of the second support arm 104, the wheel rest 302 can slide along the slots of the second support arm 104 to positionally align or offset relative to the upper retention mechanism 110.

Further shown, and as mentioned above, the hitch-mounted apparatus 100 includes the pivot joint 112 to allow the connecting member 106 to rotate relative to the hitch tube 108. To do so, the pivot joint 112 includes lever locks 306. In these or other embodiments, the lever locks 306 may include compression locks, cam locks, screw locks, serrated locking plates, etc. By engaging or tightening the lever locks 306, the lever locks 306 can compress side plates 316a-316b against the connecting member 106 via one or more corresponding portions of the 306 disposed within the slots 114 of the connecting member 106. Advantageously, this compression helps to reduce and/or eliminate play between the connecting member 106 and the hitch tube 108. Then, when disengaging or loosening the lever locks 306, the lever locks 306 can translate, with the connecting member 106, along slots 310 of the pivot joint 112 as the connecting member 106 rotates or pivots. Additionally, the one or more corresponding portions of the 306 disposed within the slots 114 of the connecting member 106 can translate up or down the slots 114 as the connecting member 106 is rotated to a desired position.

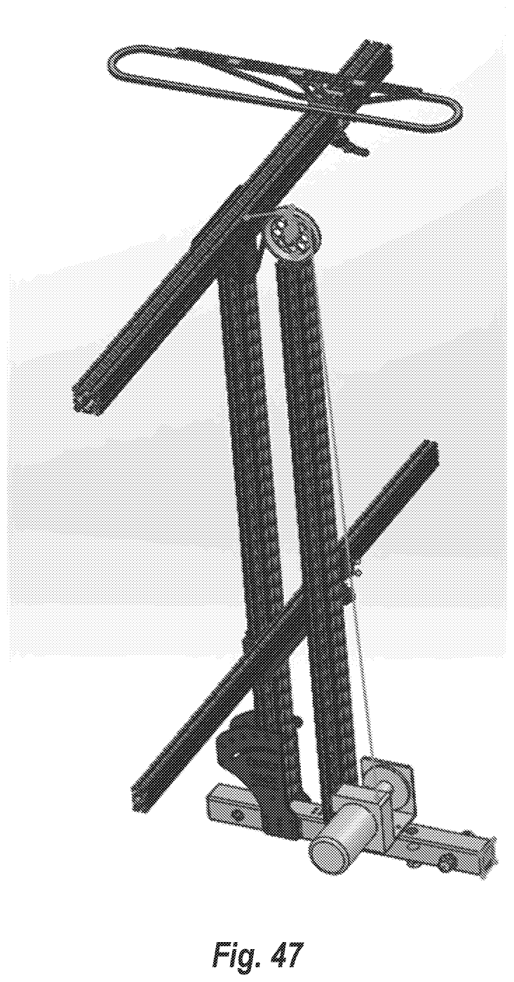

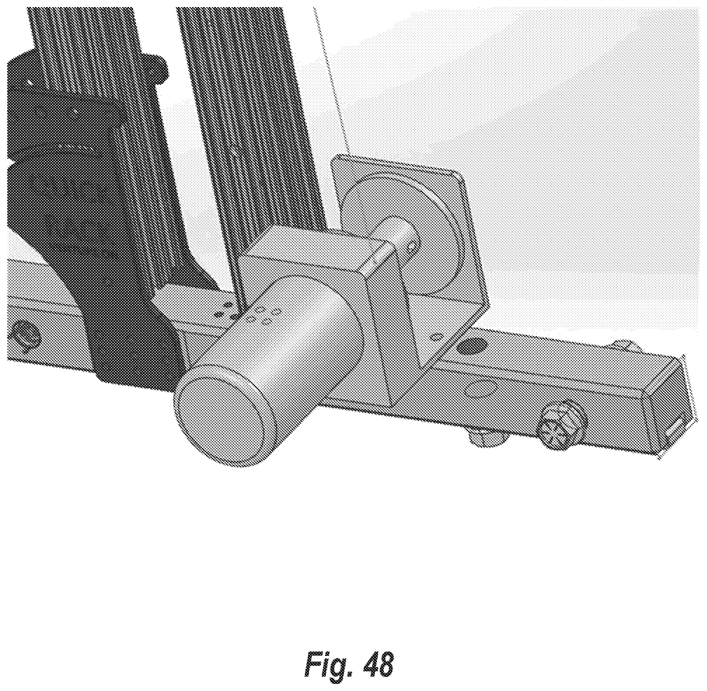

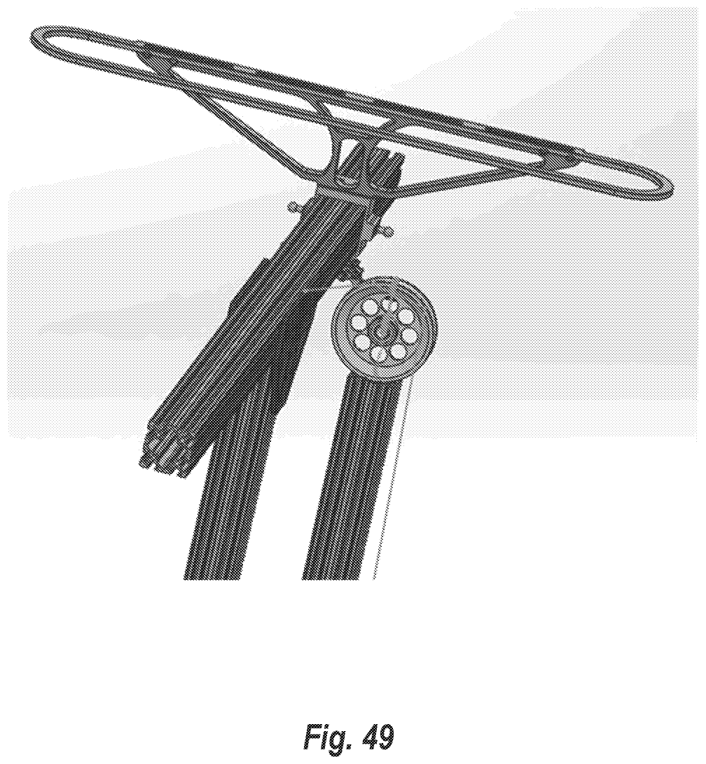

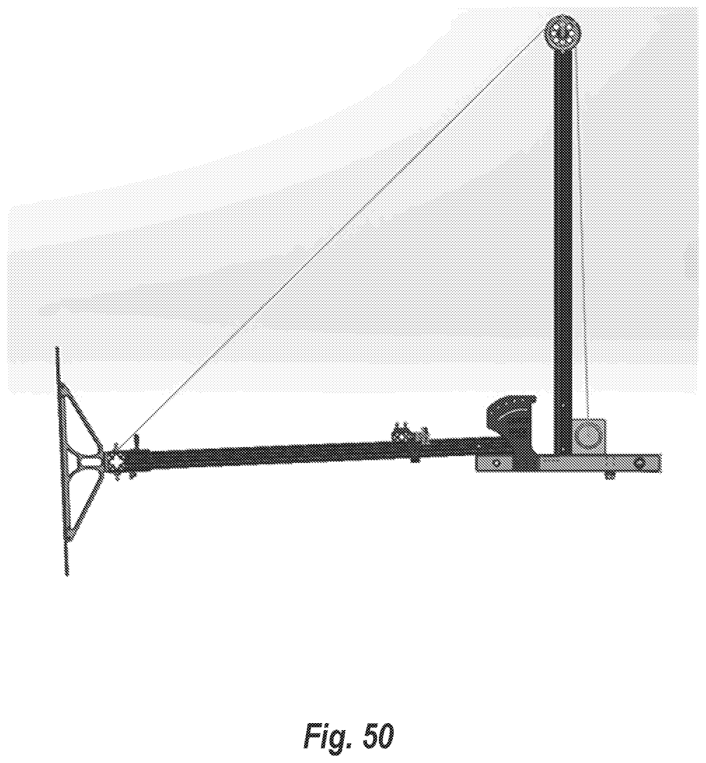

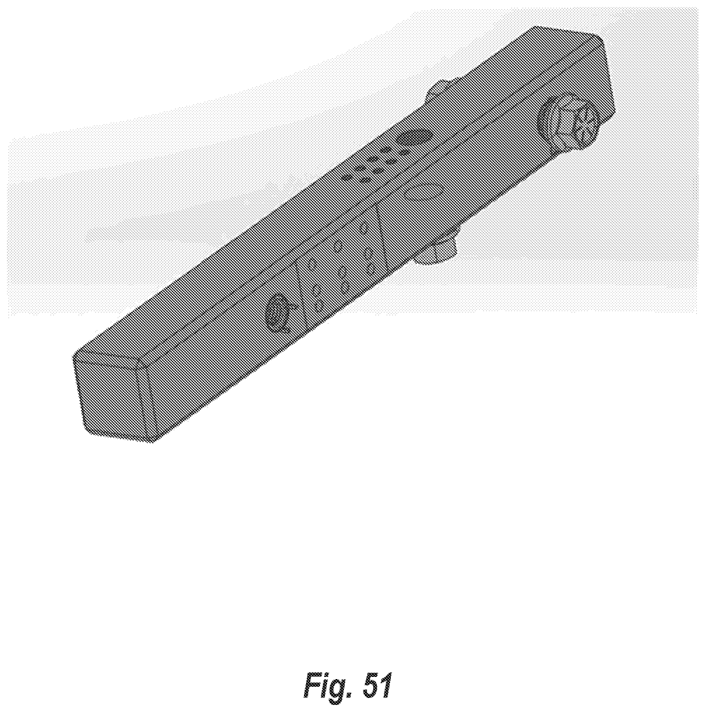

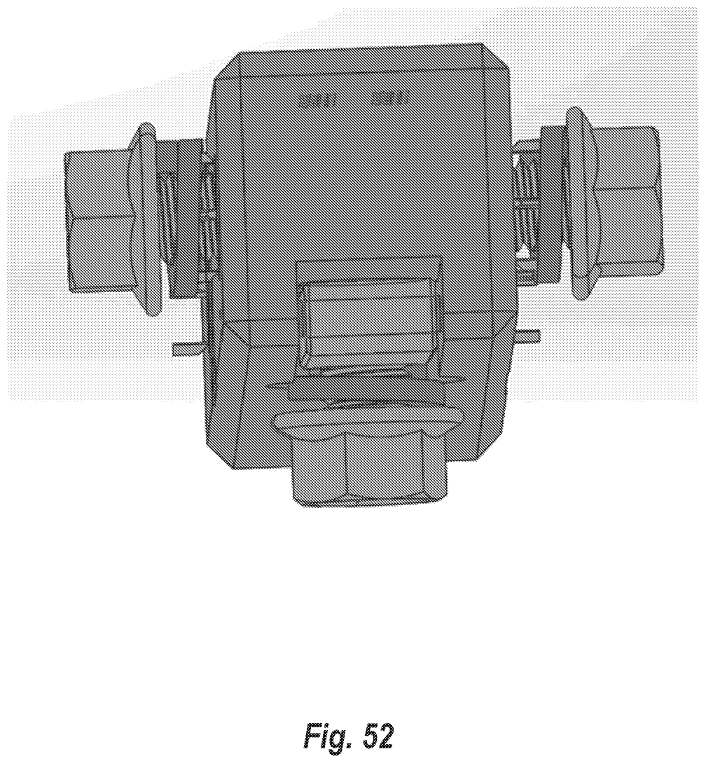

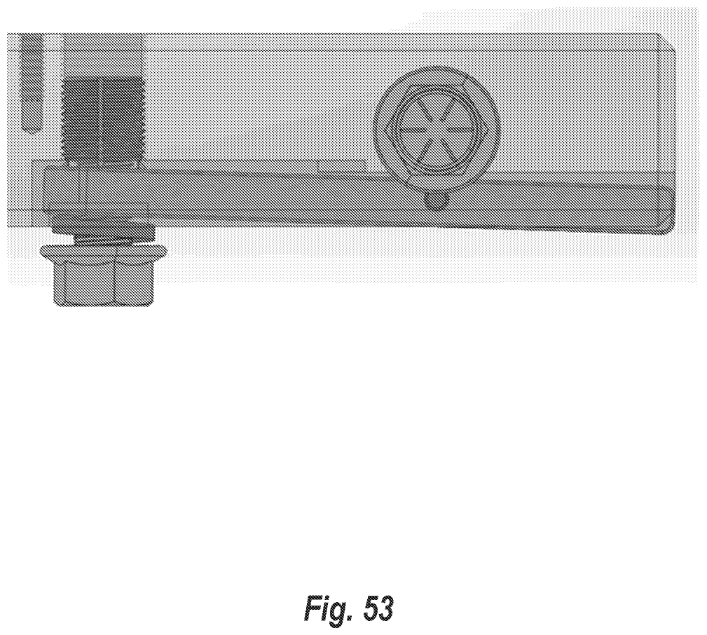

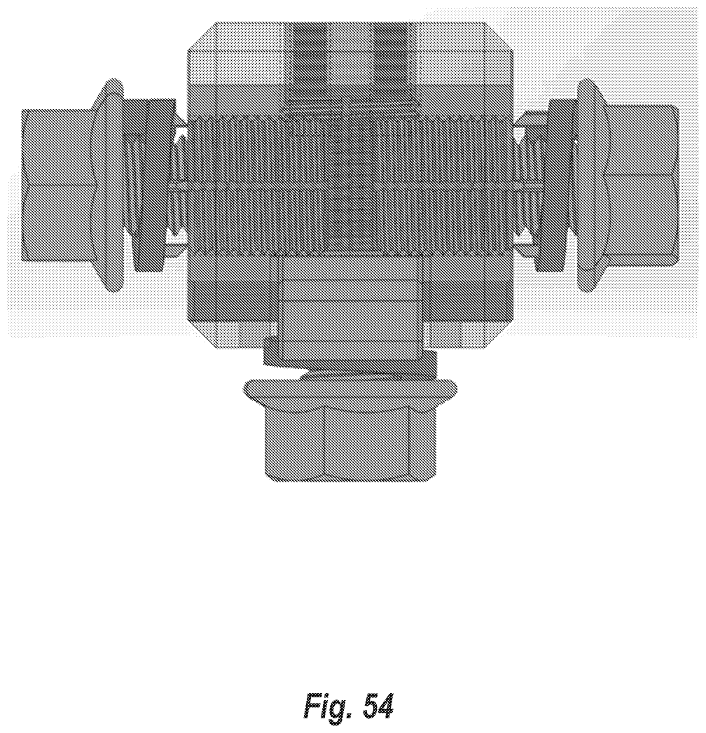

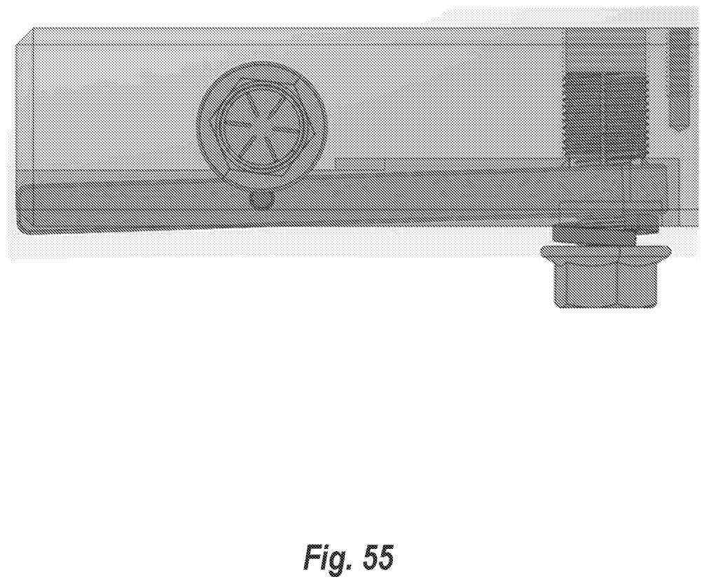

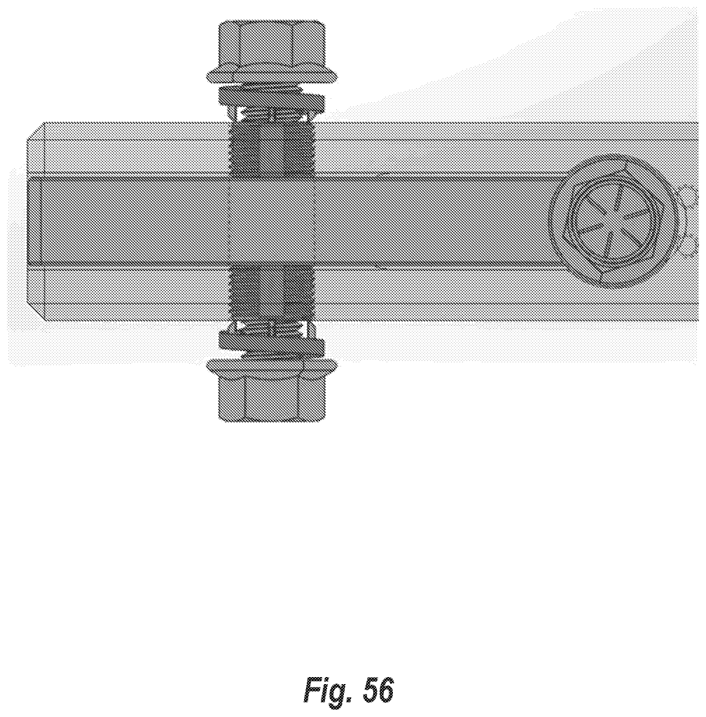

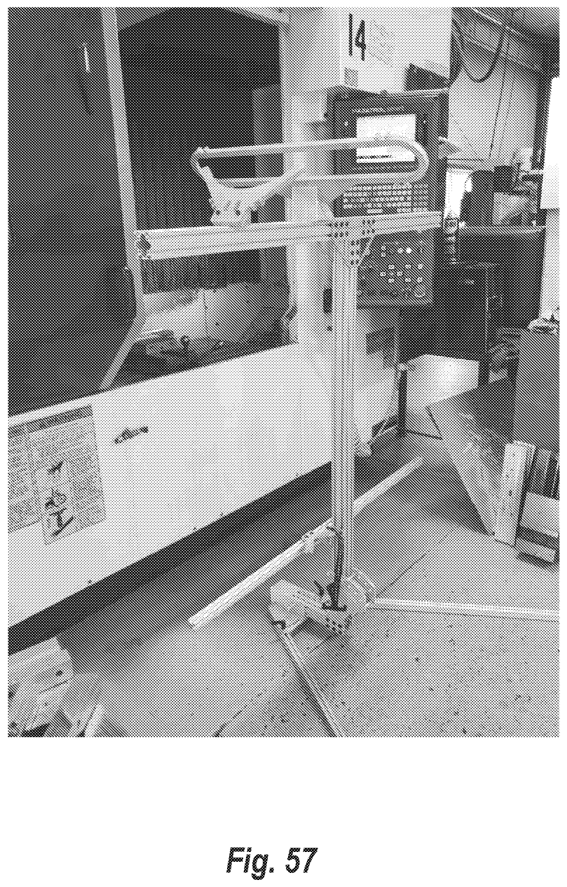

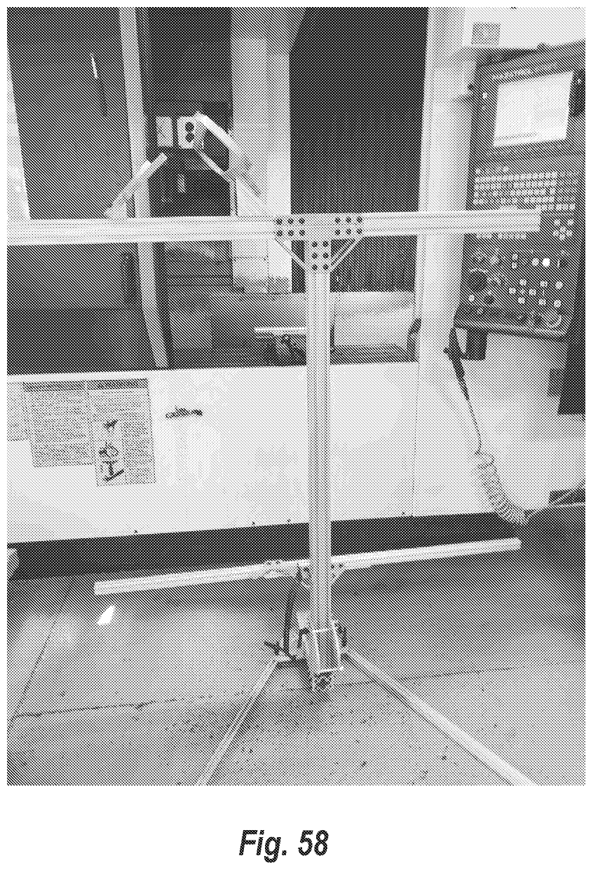

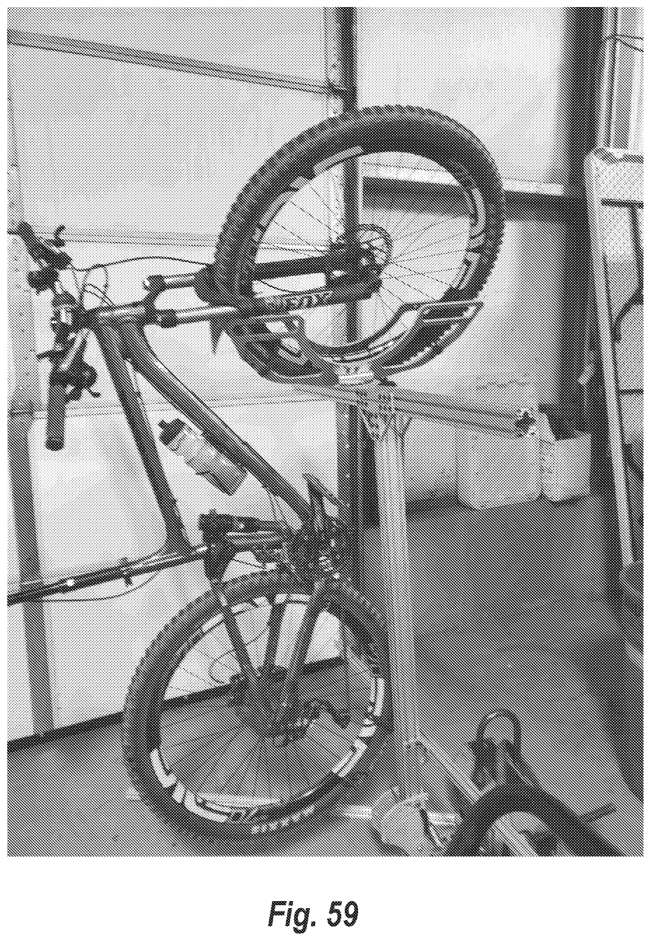

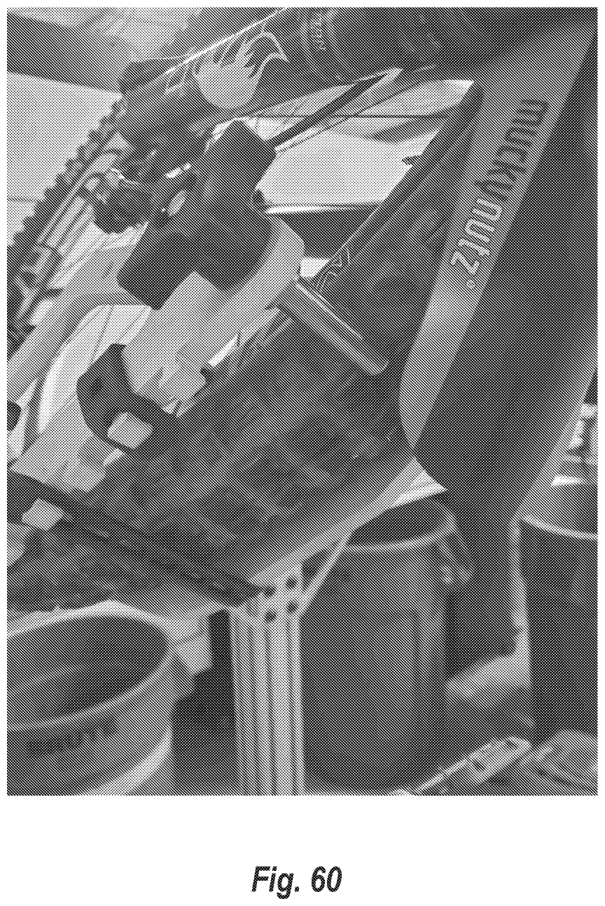

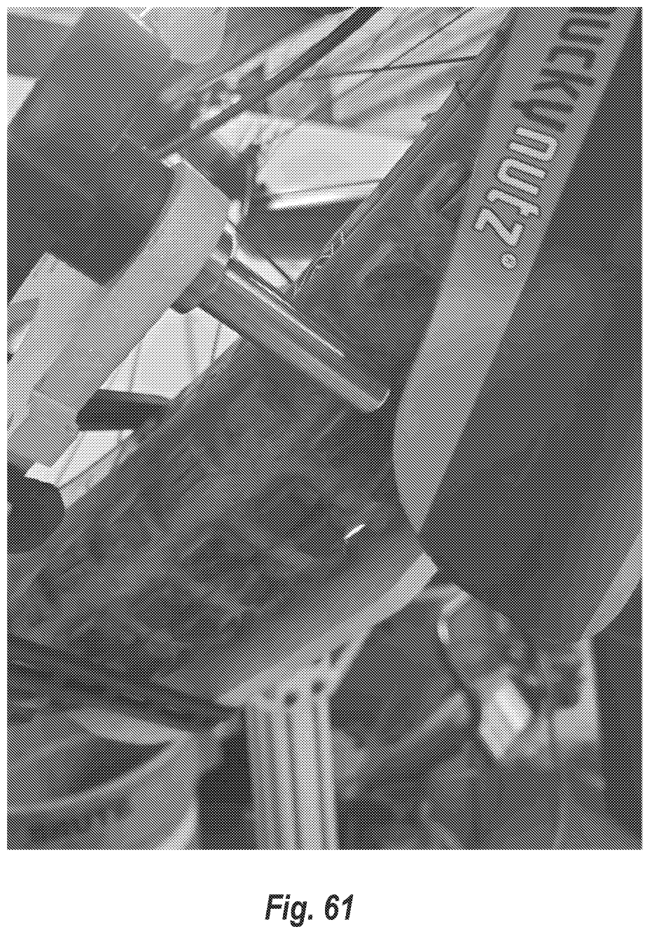

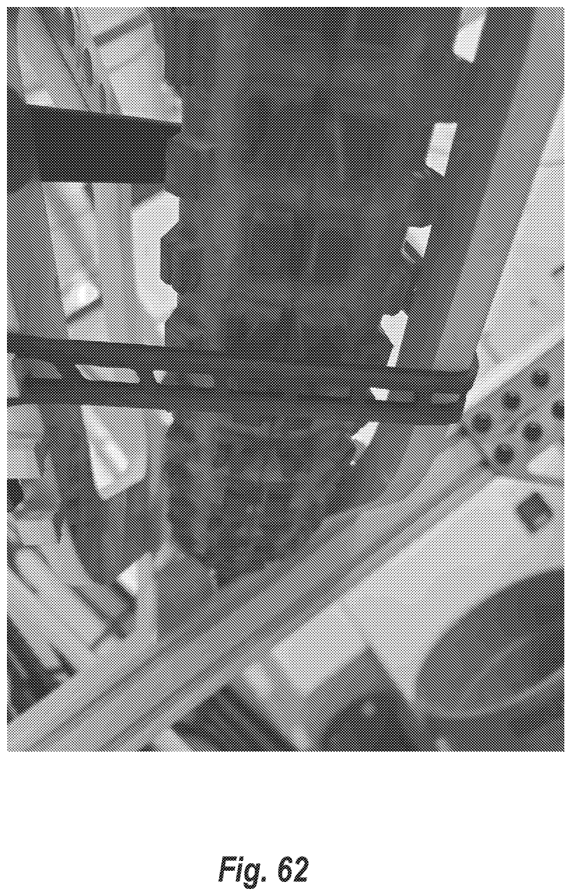

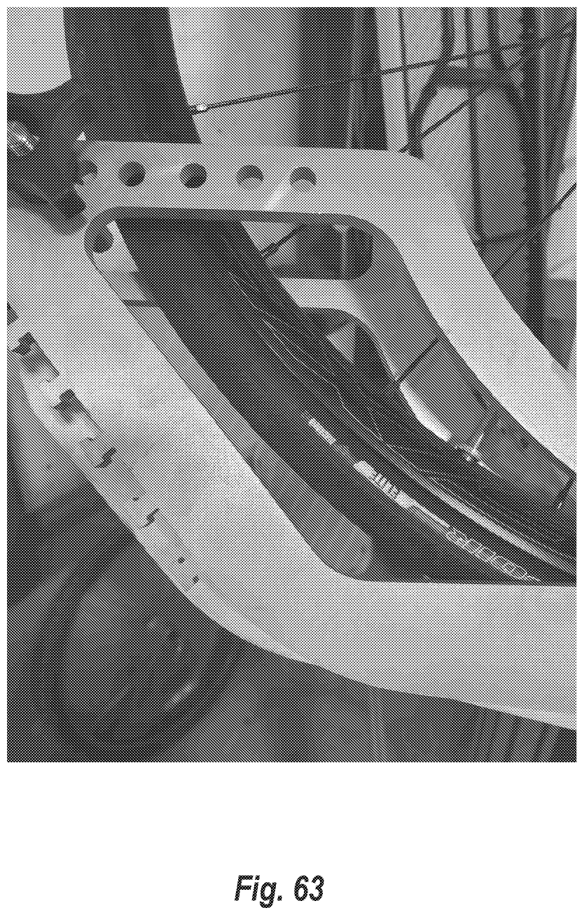

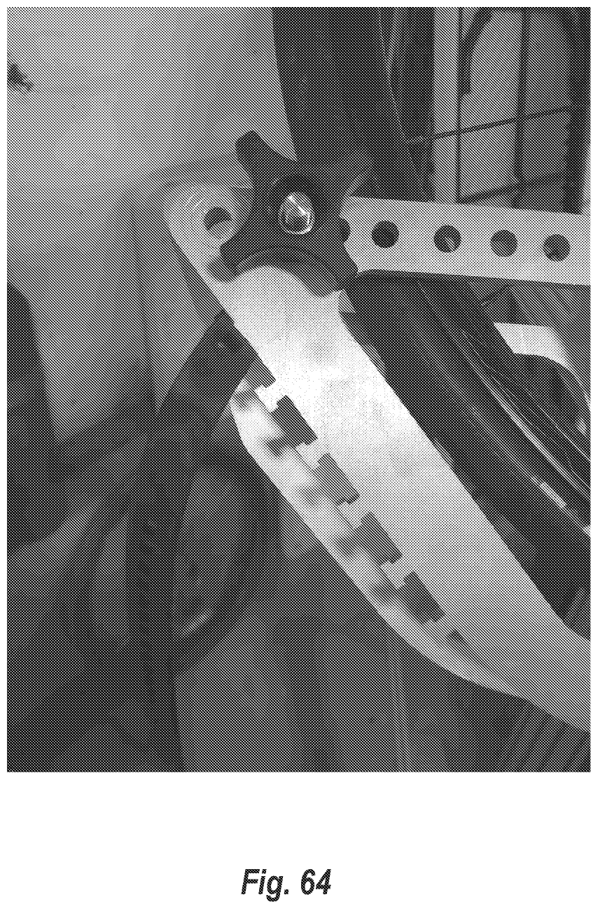

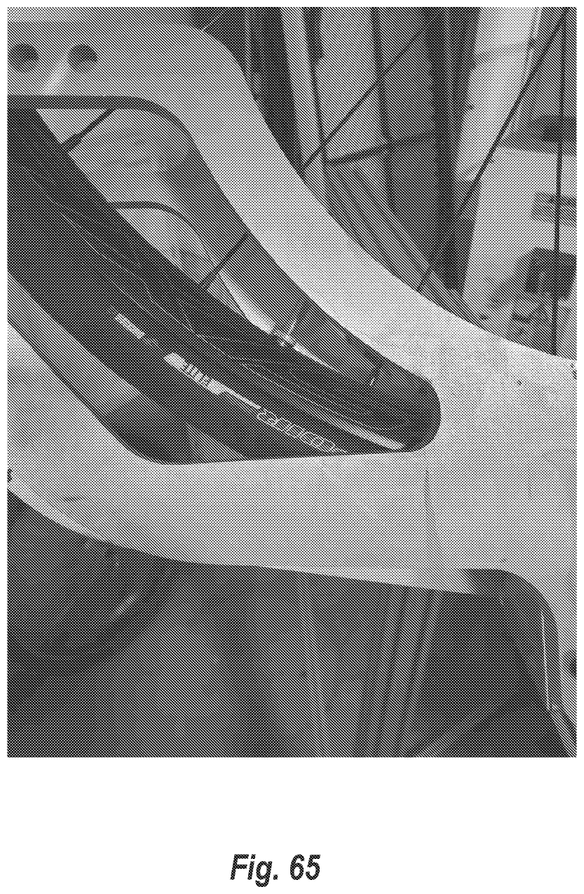

As an optional safety feature, the hitch-mounted apparatus 100 also includes a safety pin 314 that engages a pair of the respective pin holes 312 disposed within the side plates 316a-316b. Specifically, the safety pin 314 includes a rod portion inserted into a pair of the pin holes 312 aligning with a thru-hole of the connecting member 106 such that the rod portion passes through the connecting member 316. Alternatively, the rod portion of the safety pin 314 passes across a front-side of the connecting member 106 instead of through the connecting member 106. In addition, the safety pin 314 includes a wrap-around portion that secures a backside of the connecting member 106. Together, the rod portion and the wrap-around portion of the safety pin 314 keep the connecting member 106 from falling backwards or forwards in the event the lever locks 306 are incidentally disengaged or otherwise fail. The rod portion and the wrap-around portion of the safety pin 314 are shown in more detail in FIG. 47. Additionally or alternatively, the safety pin 314 can include a variety of other suitable fasteners and/or a combination of fasteners.

Modifications, additions, or omissions may be made to the embodiments illustrated and described in relation to FIGS. 3A-3C without departing from the scope of the present disclosure. For example, in some embodiments, the wheel rest 302 may be sized and shaped and/or oriented in different ways. To illustrate, the wheel rest 302 may include a curvature and orientation to fit the curvature of the bike wheel 308. Additionally or alternatively, the wheel rest 302 may secure the bike wheel 308 from one or both sides of the bike wheel 308. For instance, the bike wheel 308 may not physically “rest” on the wheel rest 302 in certain implementations. Rather, in some embodiments, the wheel rest 302 secures the bike wheel 308 from an offset position adjacent to the bike wheel 308 (e.g., by using the adjustable restraint, a clamping element, or other suitable retention feature). As another example, the wheel rest 302 comprises opposing resting plates or boundary plates that extend outward from the second support arm 104. In this case, the bike wheel 308 can rest on the second support arm 104 between the opposing resting plates or boundary plates of the wheel rest 302.

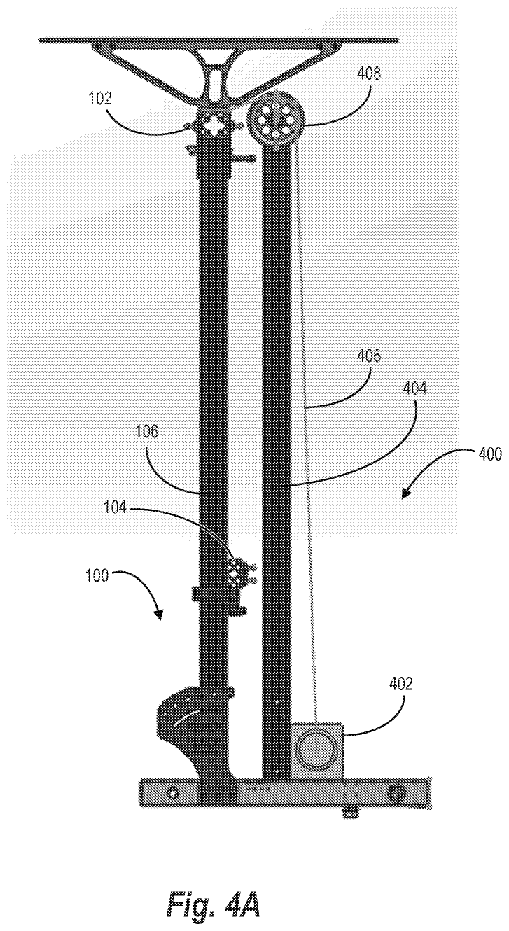

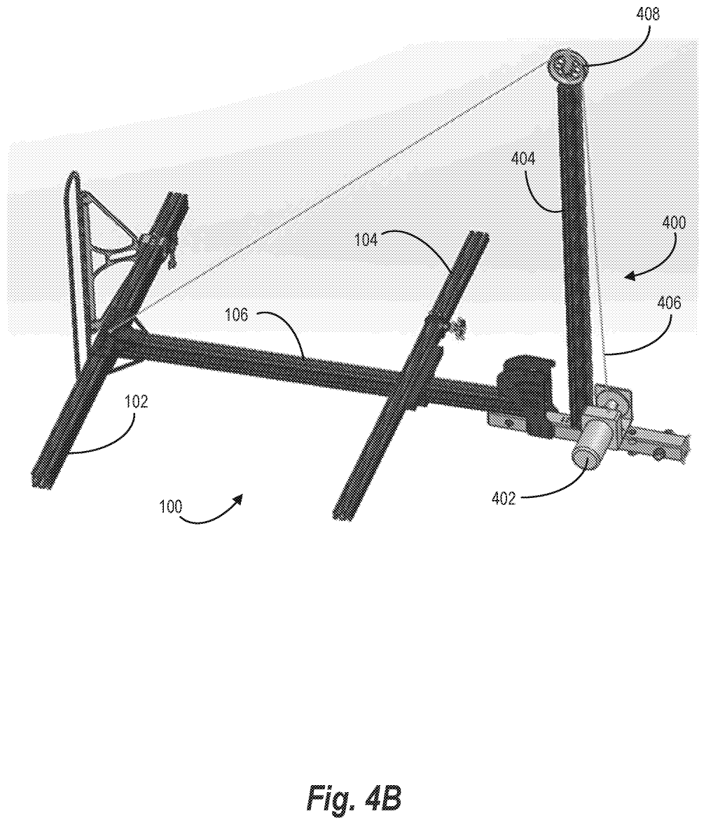

As mentioned above, one or more embodiments of the hitch-mounted apparatus 100 include accessibility features. FIGS. 4A-4B illustrate the hitch-mounted apparatus 100 comprising a motor-assist system 400 in accordance with one or more embodiments. As shown, the motor-assist system 400 comprises a winch 402, a member 404, a cable 406, and a pulley 408.

As illustrated in FIGS. 4A-4B, the winch 402 comprises an electric motor (e.g., an alternating current and/or direct current motor) for rotationally winding or unwinding the cable 406. In these or other embodiments, a variety of power sources (not shown) may power the electric motor of the winch 402. For example, one or more rechargeable batteries, solar-powered batteries, and/or a vehicle battery may power the winch 402. As another example, the winch 402 may include a wall socket connection for plugging into a power outlet (e.g., a 120-volt power outlet).

With respect to FIG. 4A, the motor-assist system 400 positions the connecting member 106 of the hitch-mounted apparatus 100 in an upright, stowed configuration ready for transit. To achieve this stowed configuration of the hitch-mounted apparatus 100, the winch 402 winds the cable 406, which extends a length of the member 404, engages the pulley 408, and connects to a top portion of the connecting member 106 and/or the first support arm 102.

With respect to FIG. 4B, the motor-assist system 400 positions the connecting member 106 of the hitch-mounted apparatus 100 in a lowered, unstowed configuration for loading one or more bikes. To achieve this unstowed configuration of the hitch-mounted apparatus 100, the winch 402 unwinds the cable 406. As the winch 402 unwinds the cable 406, the connecting member 106 progressively lowers from the vertical, raised position in FIG. 4A until achieving a horizontal position in FIG. 4B.

In these or other embodiments, the motor-assist system 400 is operated via one or more switches (e.g., a raise button and/or a lower button communicatively coupled to the winch 402. In this manner, the motor-assist system 400 provides significant advantages for easily and conveniently raising and lowering the hitch-mounted apparatus 100.

Modifications, additions, or omissions may be made to the embodiments illustrated and described in relation to FIGS. 4A-4B without departing from the scope of the present disclosure. For example, in some embodiments, the motor-assist system 400 may be powered via other means. To illustrate, the motor-assist system 400 may include gear-driven mechanisms (e.g., for hand-crank operations). As another example, the motor-assist system 400 may include hub-driven mechanisms (e.g., a hub motor that provides rotation to an outer part of the hub motor for raising and lowering the hitch-mounted apparatus 100). In yet another example, the motor-assist system 400 may include pneumatic and/or hydraulic mechanisms (e.g., pumps, pistons/cylinders, valves, hoses, reservoirs, etc.).

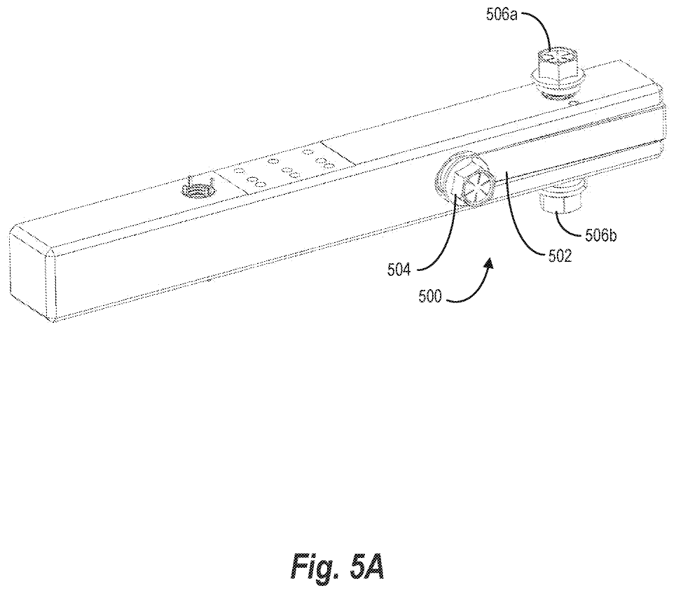

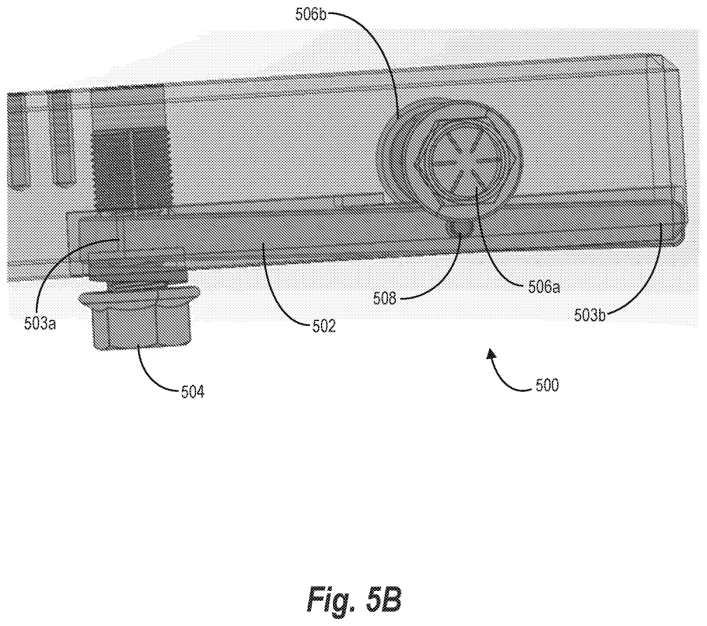

As mentioned above, the hitch-mounted apparatus 100 can include a hitch tube that comprises one or more features for further securing and/or providing a customized fit inside a vehicular hitch receiver associated with a vehicle (e.g., for a vehicular mounting system). FIGS. 5A-5B illustrate a hitch tube 500 of a hitch-mounted apparatus in accordance with one or more embodiments. As shown, the hitch tube 500 comprises a compression plate 502, a vertical bolt 504, and horizontal bolts 506a-506b.

In particular, the compression plate 502 is configured to pivot about a pivot point 508 (e.g., a dowel pin, screw, etc.) upon tightening the vertical bolt 504. To illustrate, upon tightening the vertical bolt 504, the vertical bolt 504 engages a proximal end 503a of the compression plate 502. By engaging the proximal end 503a of the compression plate 502, the vertical bolt 504 compresses or forces the proximal end 503a inwards (e.g., into an internal recess) toward a central axis of the hitch tube 500. In so doing, the compression plate 502 pivots about the pivot point 508 to cause a distal end 503b of the compression plate 502 to jut out or extend outwards beyond the outer surface of the hitch tube 500. In this manner, the vertical bolt 504 may be tightened until the distal end 503b juts out sufficiently to compress against an inner sidewall of the vehicular hitch receiver (thereby fixing the hitch tube 500 in the vertical direction perpendicular to the central axis or length of the hitch tube 500). Moreover, by utilizing this configuration, the vertical bolt 504 and the distal end 503b of the compression plate 502 work in concert to provide two separate points for vertically constraining the hitch tube 500. In addition, this configuration can help to better distribute the weight of the hitch-mounted apparatus 100 across the length of the vehicular hitch receiver.

In addition, the horizontal bolts 506a-506b engage threaded portions of the hitch tube 500 to provide a compression force between the hitch tube 500 and the vehicular hitch receiver. Inserted from opposing sides of the hitch tube 500, the horizontal bolts 506a-506b can engage the hitch tube 500 to horizontally fix a position of the hitch tube 500 within the vehicular hitch receiver. Specifically, the horizontal bolts 506a-506b are configured as a horizontal vice (being axially aligned with one another) such that the hitch tube 500 is horizontally locked in place upon tightening of the horizontal bolts 506a-506b to the vehicular hitch receiver.

In this manner, the hitch tube 500 can be positionally constrained vertically and horizontally within a vehicular hitch receiver for safe, smooth operation and transit of the hitch-mounted apparatus 100. That is, the hitch tube 500 can significantly reduce (if not completely eliminate) bouncing, rattling, and other undesired play within the vehicular hitch receiver.

Modifications, additions, or omissions may be made to the embodiments illustrated and described in relation to FIGS. 5A-5B without departing from the scope of the present disclosure. For example, in some embodiments, the hitch tube 500 may include additional or alternative fasteners (e.g., instead of using the compression plate 502).

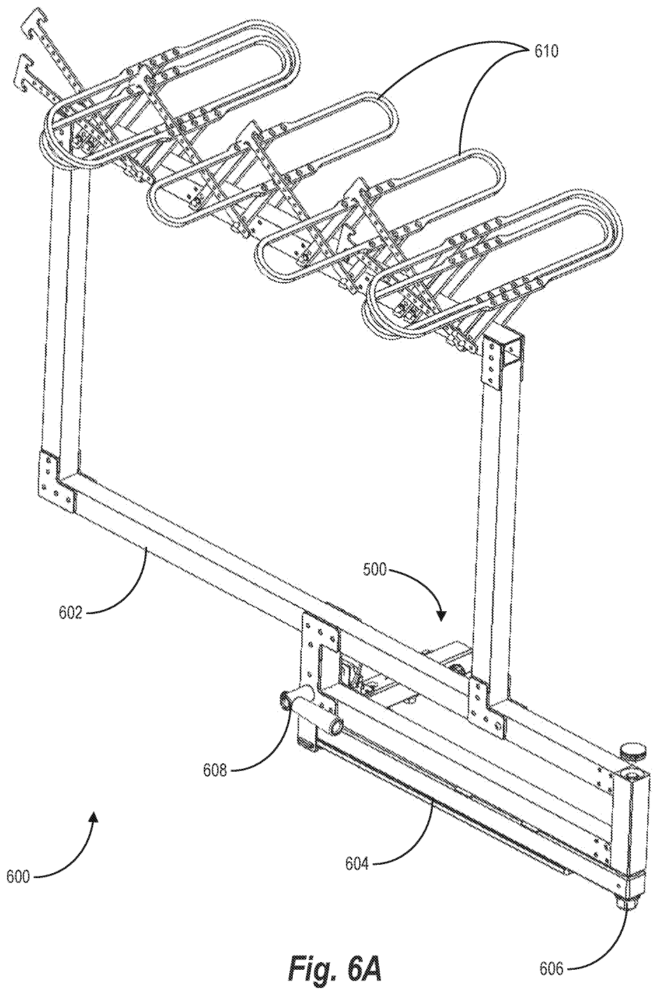

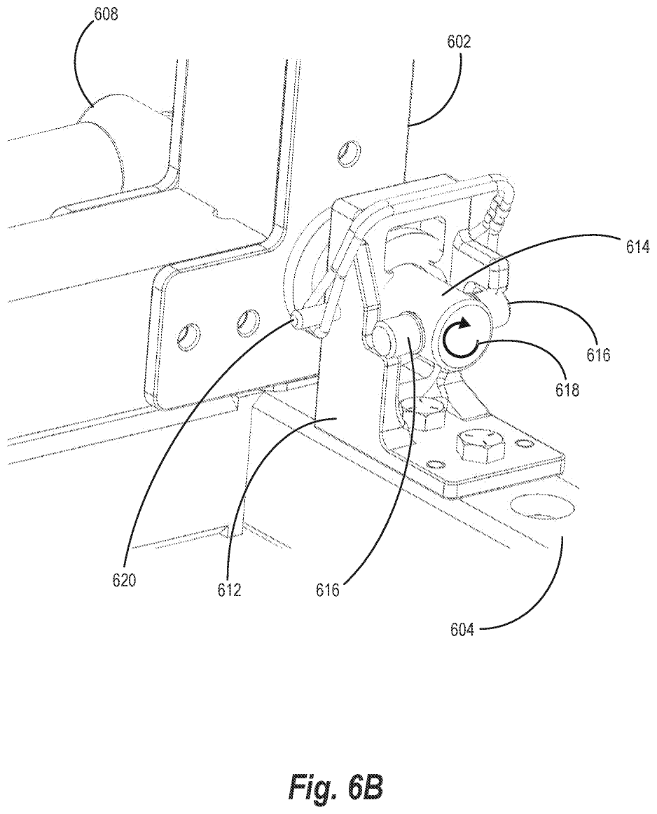

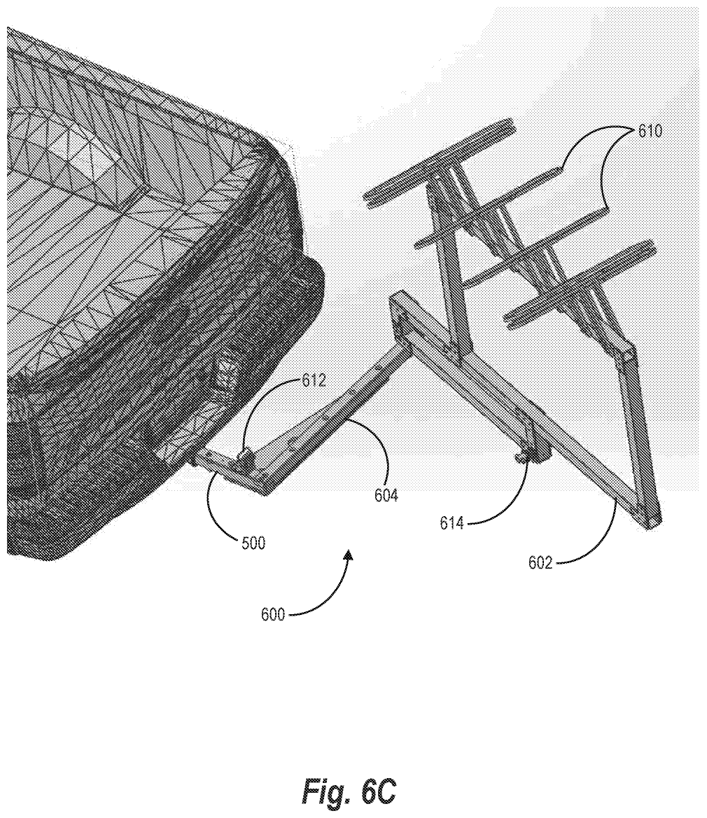

As described above, various embodiments of the hitch-mounted apparatus 100 can include static mounting apparatuses that remain fixed relative to the hitch tube or else mounting apparatuses that raise and lower (e.g., as shown in FIGS. 4A-4B). However, the present invention is not so limited. For example, FIGS. 6A-6C illustrate a hitch-mounted apparatus comprising a swing rack 600 that swings between a stowed and unstowed configuration in accordance with one or more embodiments. By allowing the swing rack 600 to rotate between stowed and unstowed configurations as will be described below, the swing rack 600 can impart significant ergonomic and/or convenience-type advantages over conventional systems, particularly for accessing a vehicle while the swing rack 600 remains mounted to the vehicle. It will be appreciated that the swing rack 600, and embodiments disclosed herein, can be configured to hold a single bike or multiple bikes (e.g., up to 6 bikes or more).

As shown in FIG. 6A, the swing rack 600 includes a swing top 602 comprising a plurality of frame members. Although shown connected via a plurality of brackets and fasteners, in other embodiments, the plurality of frame members can be connected by additional and/or alternative means (e.g., via welding, permanent fasteners, adhesives, interlocking or press-fit members, and/or other suitable means). In addition, the frame members of the swing top 602 are configured so as to support the weight of bikes or other payloads secured in upper retention mechanisms 610 (e.g., in a same or similar manner as described above in relation to the upper retention mechanisms 110). Further, the frame members of the swing top 602 are arranged so as to physically connect to a base 604 in a manner that provides a balanced, stable load transfer from the swing top 602 to the base 604 and the hitch tube 500. Moreover, the frame members of the swing top 602 are spatially arranged relative to the base 604 such that vehicle access is not impeded when the swing rack 600 is in the unstowed configuration depicted in FIG. 6C.

In particular, the swing top 602 is pivotally connected to the base 604 at a swing point 606. At the swing point 606, the swing rack 600 can rotationally move from the stowed or closed configuration as depicted in FIG. 6A to the unstowed or open configuration depicted in FIG. 6C. In these or other embodiments, the swing point 606 comprises one or more bolts, nut fasteners, bushings, washers, spacers, bearings, etc. for forming a pivot joint of any suitable variety (e.g., a hinge joint, an adjustable pivot joint, a locking mechanical pivot joint, a pivot hinge, a pin joint, etc.). In this manner, the swing point 606 can both support the load of the swing top 602 and allow desired rotational mobility of the swing top 602.

Additionally shown in FIG. 6A, the swing rack 600 comprises a handle 608 for locking and unlocking the swing rack 600 to allow a transition between the stowed and unstowed configurations. For example, as will be discussed below in relation to FIG. 6B, the handle 608 is integrally attached to a key rod 614 for securing the swing top 602 to the base 604 in order to maintain the stowed configuration of FIG. 6A.

In FIG. 6B, the swing top 602 is secured to the base 604 via the key rod 614 just mentioned. Specifically, a locking mechanism 612 is affixed to the base 604 for receiving and securing the key rod 614 to ensure the swing top 602 remains in the stowed configuration during travel. Indeed, as shown in FIG. 6B, the locking mechanism 612 engages turn stops 616 of the key rod 614 such that the swing top 602 is prevented from incidental withdrawal from the locking mechanism 612. Thus, to disengage the locking mechanism 612 and open the swing top 602 to the unstowed configuration of FIG. 6C, a user grabs the handle 608 and turns the handle 608 in an unlocking direction 618. When the handle 608 turns in the unlocking direction 618, the key rod 614 correspondingly turns in the unlocking direction 618 such that the locking mechanism 612 no longer engages the turn stops 616.

As a safety mechanism, a lock pin 620 passing through the locking mechanism 612 and the key rod 614 also prevents withdrawal of the key rod 614 from the locking mechanism 612. Alternatively, the lock pin 620 passes through the locking mechanism 612 and immediately adjacent (e.g., underneath) the key rod 614 such that the turn stops 616 cannot pass by the lock pin 620. Thus, after both removing the lock pin 620 and disengaging the locking mechanism 612, the swing top 602 can be intentionally opened to the unstowed configuration.

In these or other embodiments, albeit not required, the key rod 614 can at least partially share with the swing point 606 a distributed load from the swing top 602. For example, in the stowed configuration when the key rod 614 is inserted into and secured within the locking mechanism 612, the key rod 614 can transfer a partial load from the swing top 602 to the base 604 via the locking mechanism 612 and/or lock pin 620. In this manner, certain implementations of the swing rack 600 can more evenly distribute a load from the swing top 602 rather than entirely using the swing point 606 to transfer the load of the swing top 602 to the base 604 (thereby improving longevity of the swing rack 600).

As shown in FIG. 6C, the swing rack 600 is depicted in the unstowed configuration. In at least some cases, the swing rack 600 in the unstowed configuration of FIG. 6C affords improved access (e.g., to a vehicle and/or the swing rack 600 itself). For example, unlike many conventional systems, the swing rack 600 can remain attached to the vehicle and be rotatably swung to allow clearance for opening and full access to a vehicle tailgate, hatch, trunk, window, or door. Additionally or alternatively for example, a user may stand on either side of the swing top 602 in the unstowed configuration to load or unload a payload secured via the upper retention mechanisms 610.

Modifications, additions, or omissions may be made to the embodiments illustrated and described in relation to FIGS. 6A-6C without departing from the scope of the present disclosure. For example, in some embodiments, the swing rack 600 can swing in additional or alternative directions. As another example, the swing rack 600 can additionally or alternatively include any of the different upper retention mechanisms disclosed herein (e.g., to accommodate a wide variety of payloads).

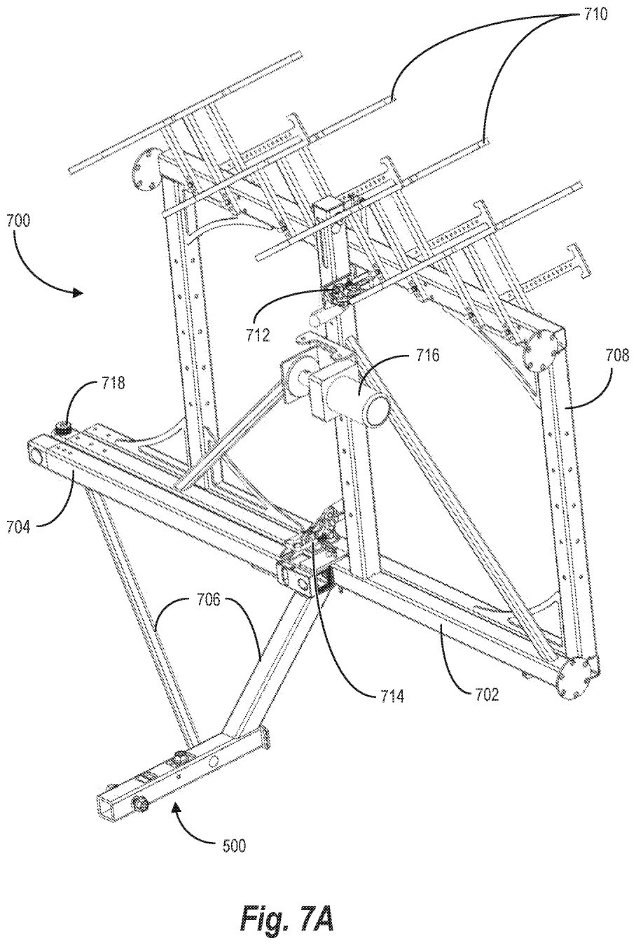

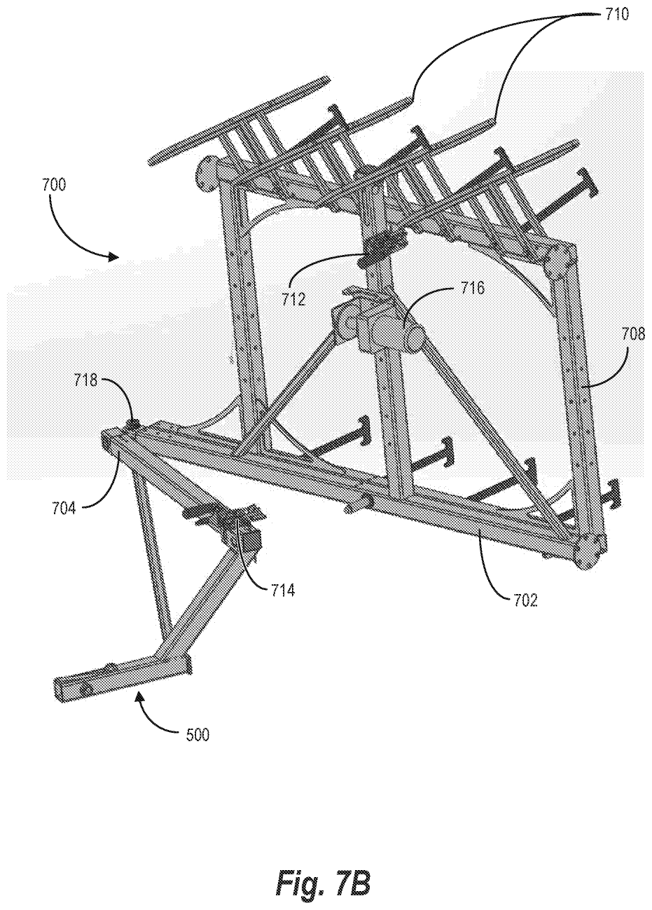

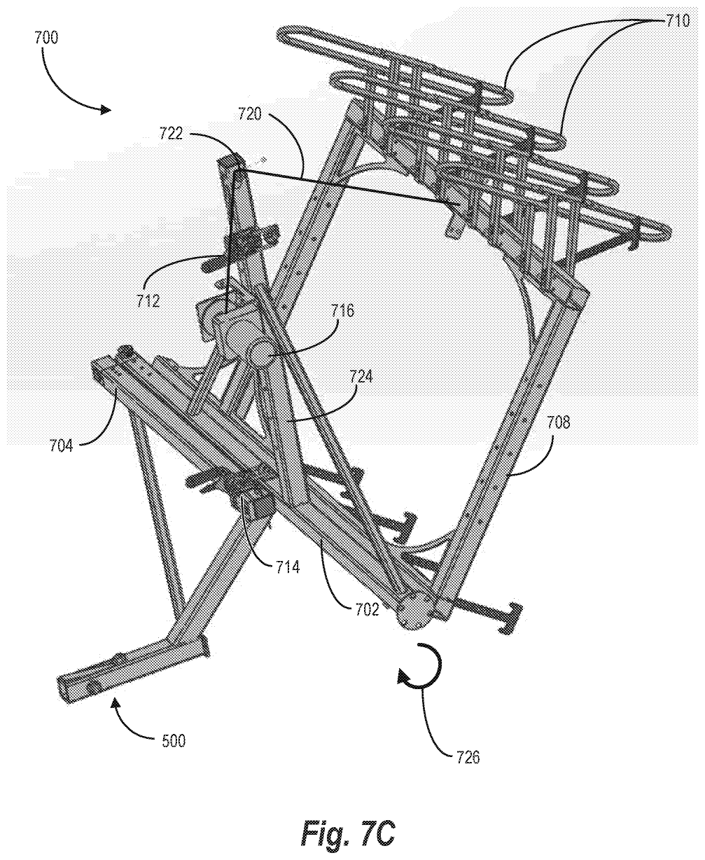

As discussed above, a hitch-mounted apparatus can include a variety of different accessibility advantages. In certain embodiments, a hitch-mounted apparatus comprises features for providing a combination of horizontal and vertical accessibility. In accordance with one or more such embodiments, FIGS. 7A-7C illustrate a hitch-mounted apparatus 700.

As shown in FIGS. 7A-7C, the hitch-mounted apparatus 700 comprises the hitch tube 500 (discussed above in relation to FIGS. 5A-5B), a swing top 702, and a base 704. The base 704 connects the swing top 702 to the hitch tube 500 via support members 706. In particular, the support members 706 are load bearing and transfer a load of the swing top 702 from the base 704 to the hitch tube 500. More or fewer support members 706 (and in differing configurations) can provide a same or similar functionality.

In addition, the base 704 connects to the swing top 702 via a locking mechanism 714 and a pivot joint 718. It will be appreciated that the locking mechanism 714 can include a variety of different locking mechanisms (e.g., clasps, interlocking features, magnets, etc.). When activated or engaged, the locking mechanism 714 holds the swing top 702 in place adjacent to the base 704. By contrast, when deactivated or disengaged from the locking mechanism 714, the swing top 702 is free to swing horizontally about the pivot joint 718.

Indeed, as shown in FIG. 7B, the swing top 702 is released from the locking mechanism 714 such that the swing top 702 rotates laterally about the pivot joint 718. In so doing, and as similarly discussed above in relation to FIGS. 6A-6C, the hitch-mounted apparatus 700 can swing between a stowed and unstowed configuration. By allowing the hitch-mounted apparatus 700 to horizontally rotate between stowed and unstowed configurations, the hitch-mounted apparatus 700 can impart significant ergonomic and/or convenience-type advantages over conventional systems, particularly for accessing a vehicle while the hitch-mounted apparatus 700 remains mounted to the vehicle.

Additionally shown, the swing top 702 comprises a liftable rack 708 with retention mechanisms 710 (as similarly discussed above). In one or more embodiments, the swing top 702 separates from the liftable rack 708. For example, the liftable rack 708 is lowered from a stowed configuration towards an unstowed configuration (e.g., as shown in FIG. 7C). The unstowed configuration can include a variety of different angles of the liftable rack 708 relative to an upright member 724 of the base 704. In certain implementations, the unstowed configuration corresponds to about a 90-degree angle of the liftable rack 708 relative to the upright member 724 (e.g., such that the liftable rack 708 lies flat or parallel to the hitch tube 500). In this manner, users can easily load a payload without having to lift much (or any) of the payload. For instance, a front bike wheel can be parked into one of the retention mechanisms 710 when the liftable rack 708 is in the unstowed or loading configuration.

To move the liftable rack 708 to the unstowed configuration, a locking mechanism 712 (which is the same or similar to the locking mechanism 714) disengages or deactivates to allow separation of the liftable rack 708 from the upright member 724 of the base 704. In addition, a winch 716 releases or unwinds a cable 720 that connects the upright member 724 (via a pulley 722) to the liftable rack 708—thereby allowing a motor-assisted lowering from the stowed configuration. It will be appreciated that the winch 716 comprises a same or similar component(s) as the winch 402 discussed above in relation to FIGS. 4A-4B. Moreover, the winch 716 can be mechanically, electrically, and/or pneumatically coupled to a variety of components to power the winch 716 (e.g., as described above for the motor-assist system 400).

In particular, when lowering the liftable rack 708 to the unstowed configuration, the liftable rack 708 vertically rotates in a direction 726 about a hinge or other joint connection to the base 704. In a similar manner, the winch 716 winds the cable 720 to correspondingly raise (e.g., vertically rotate or pivot opposite the direction 726) the liftable rack 708 from the unstowed configuration to the stowed configuration. In at least some embodiments of the hitch-mounted apparatus 700, the liftable rack 708 and the upright member 724 are parallel to each other for the stowed configuration.

Although not illustrated, it will be appreciated that the liftable rack 708 can be vertically lowered to the unstowed configuration while the swing top 702 is also in the unstowed configuration (i.e., released from the base 704 and horizontally swung open). Accordingly, the hitch-mounted apparatus 700 can provide myriad different configurations for ergonomic and convenient unloading and/or loading of payloads.

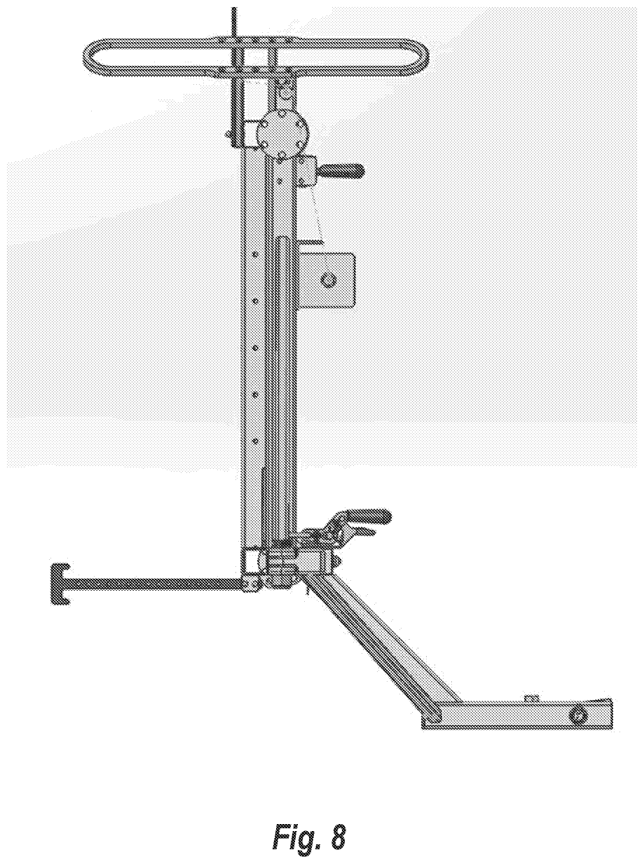

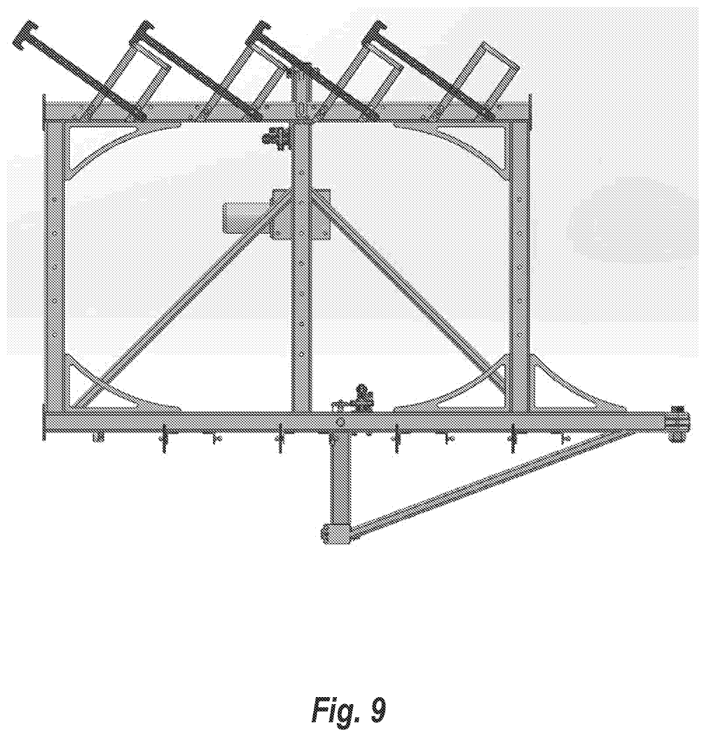

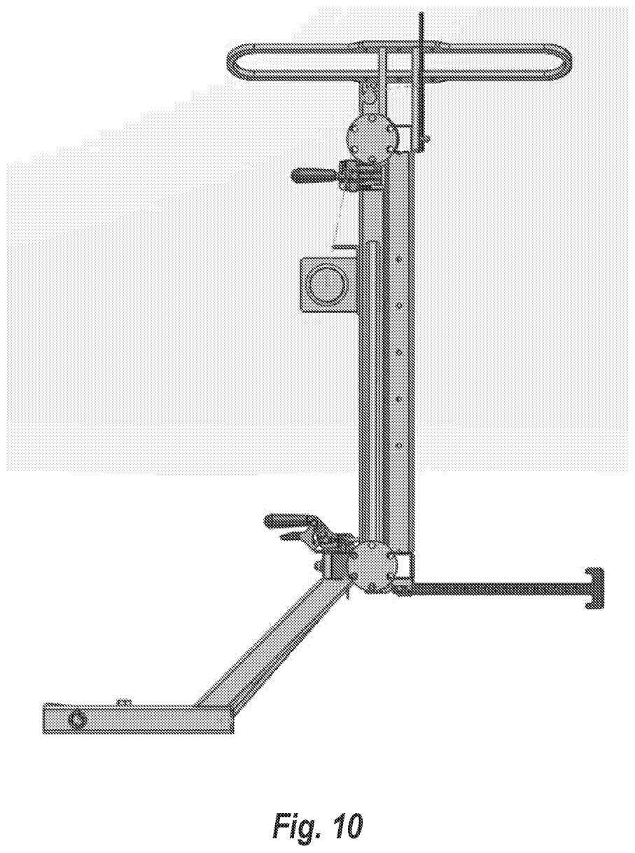

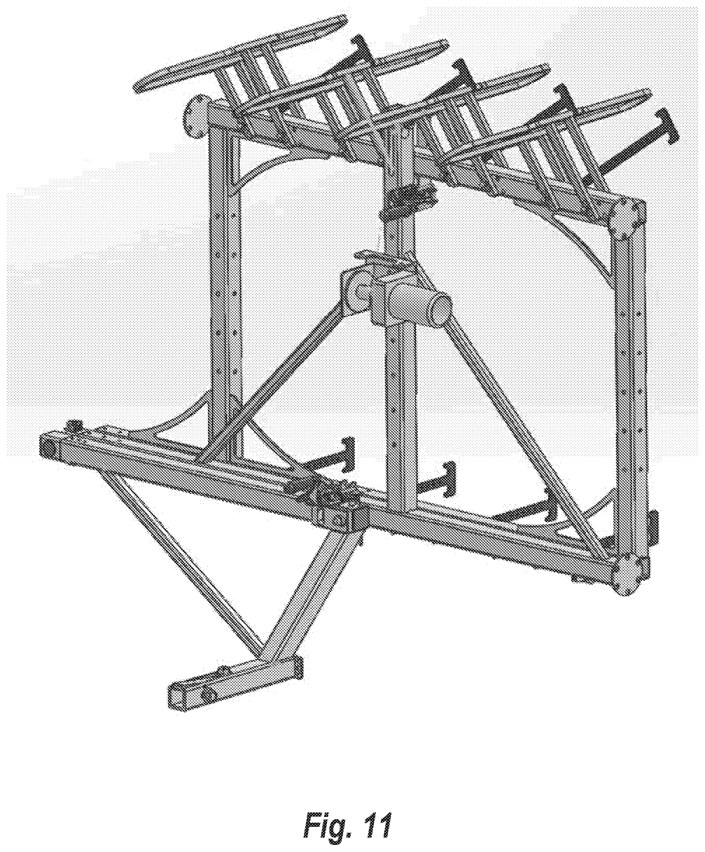

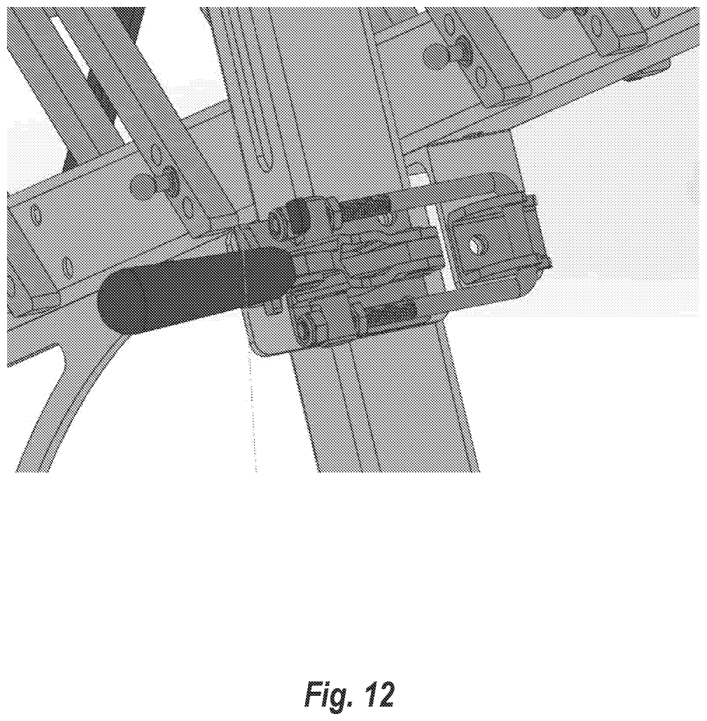

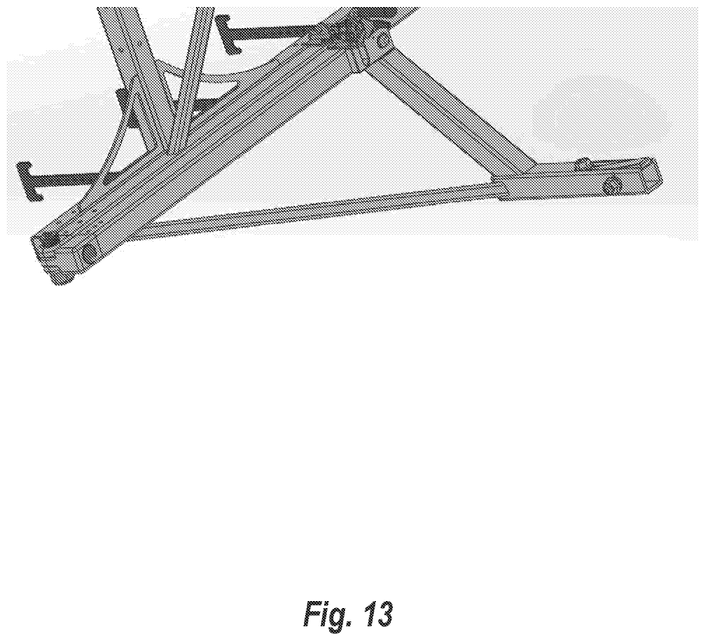

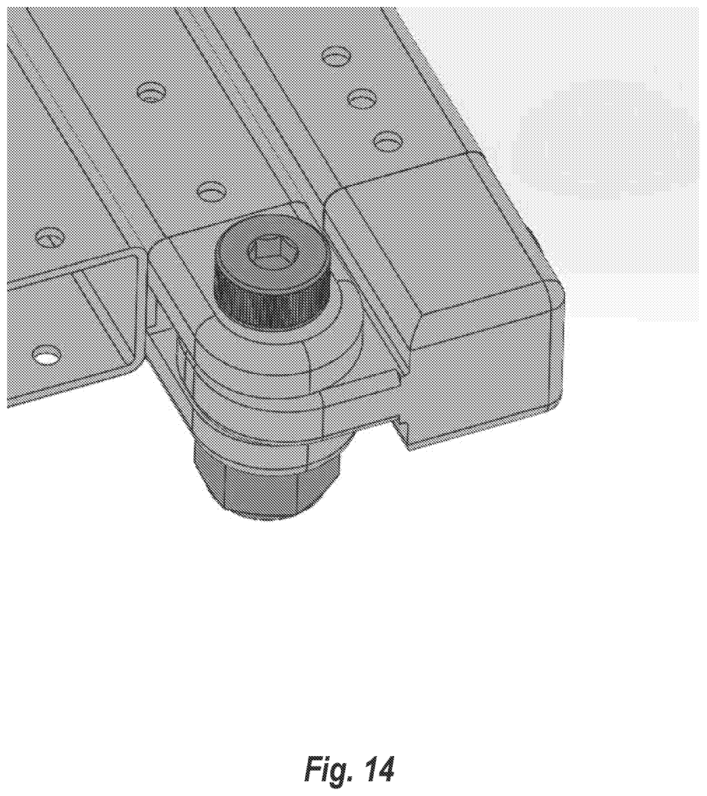

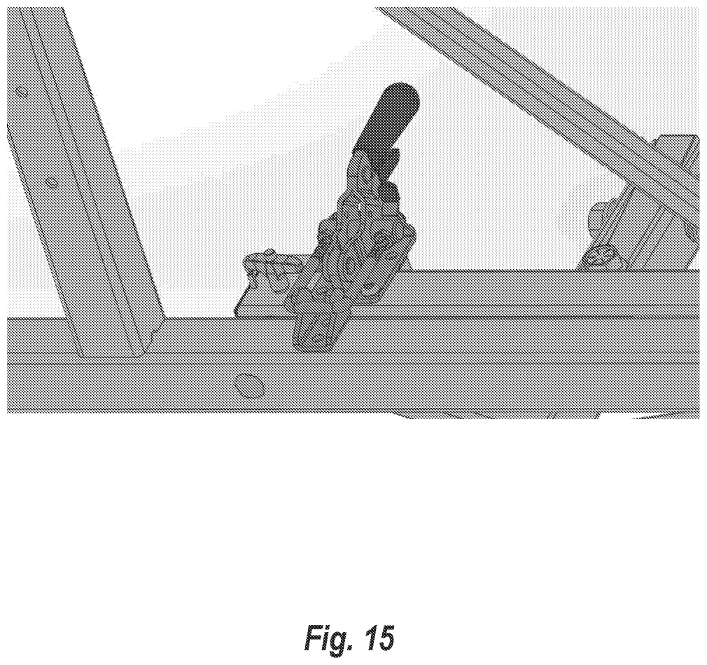

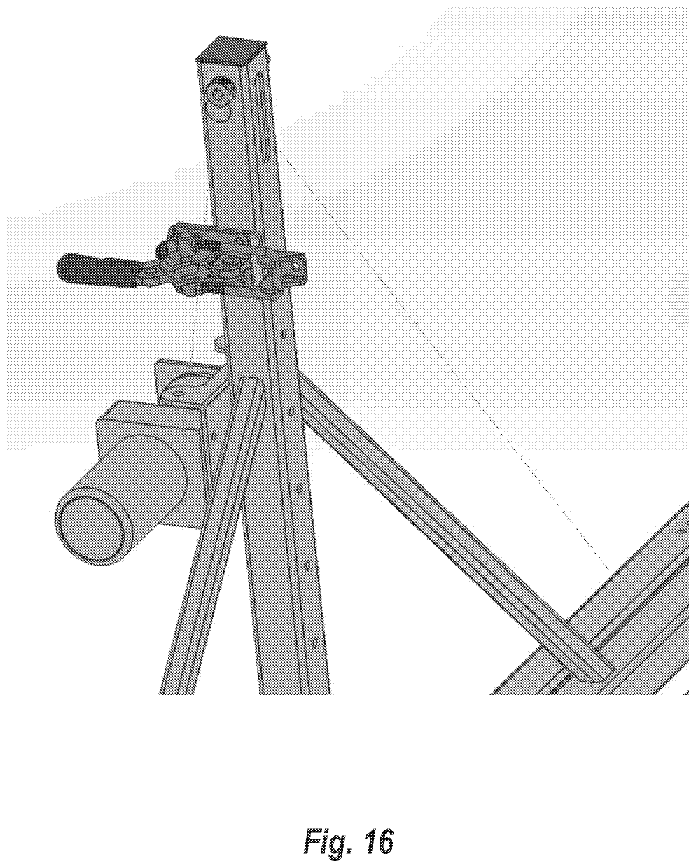

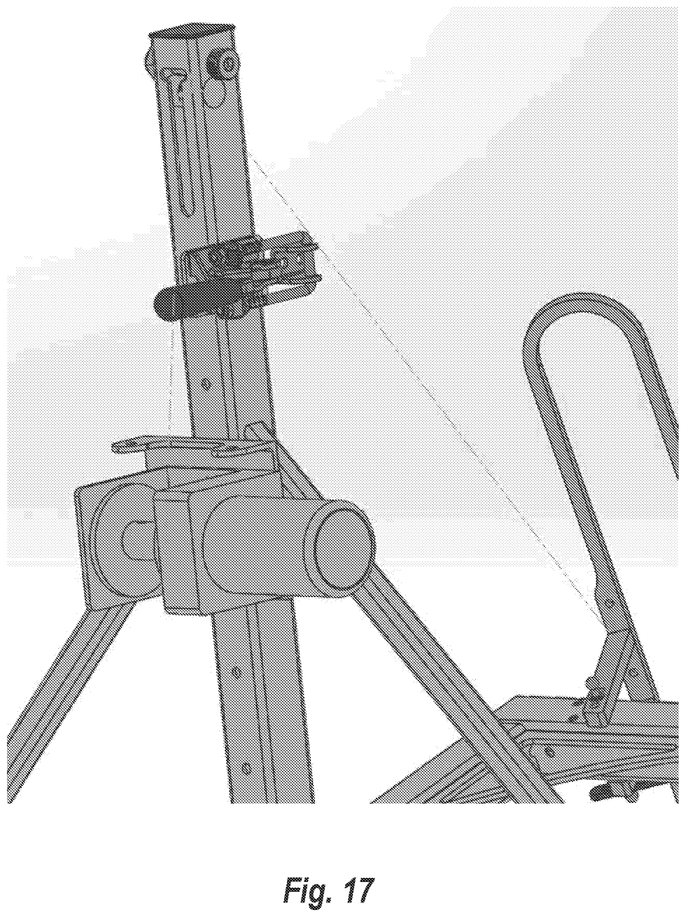

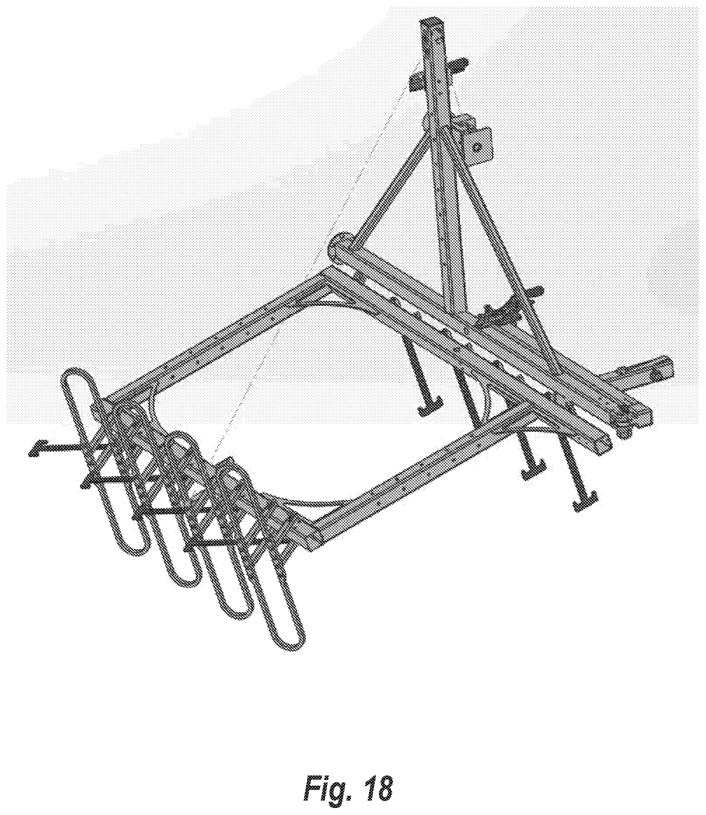

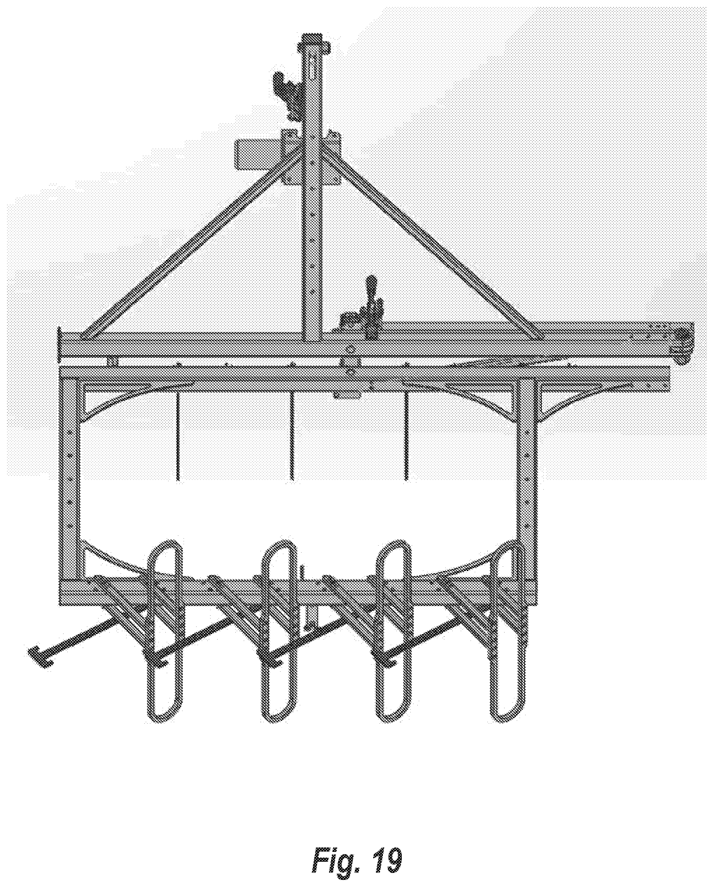

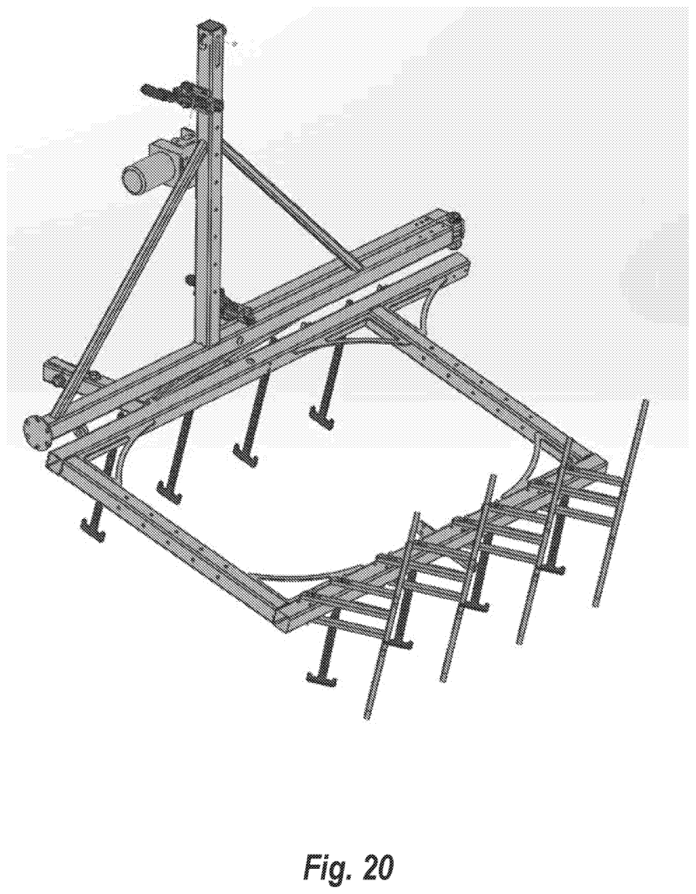

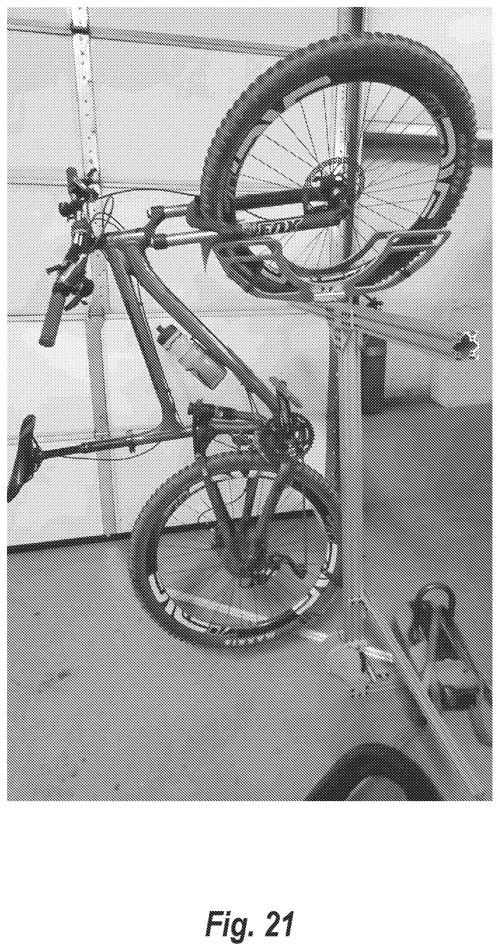

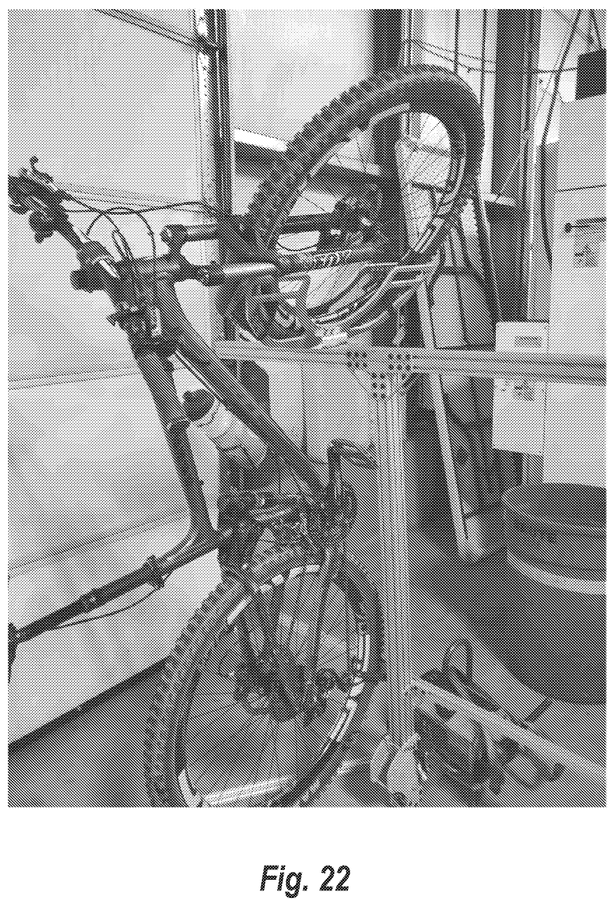

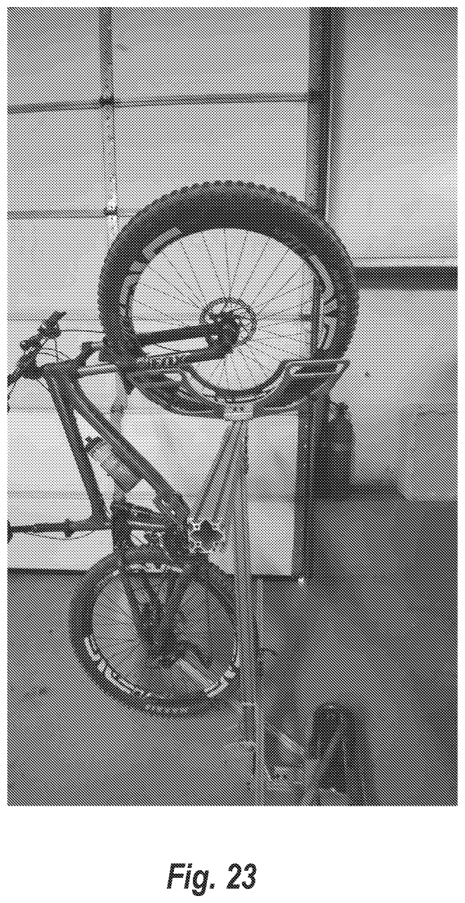

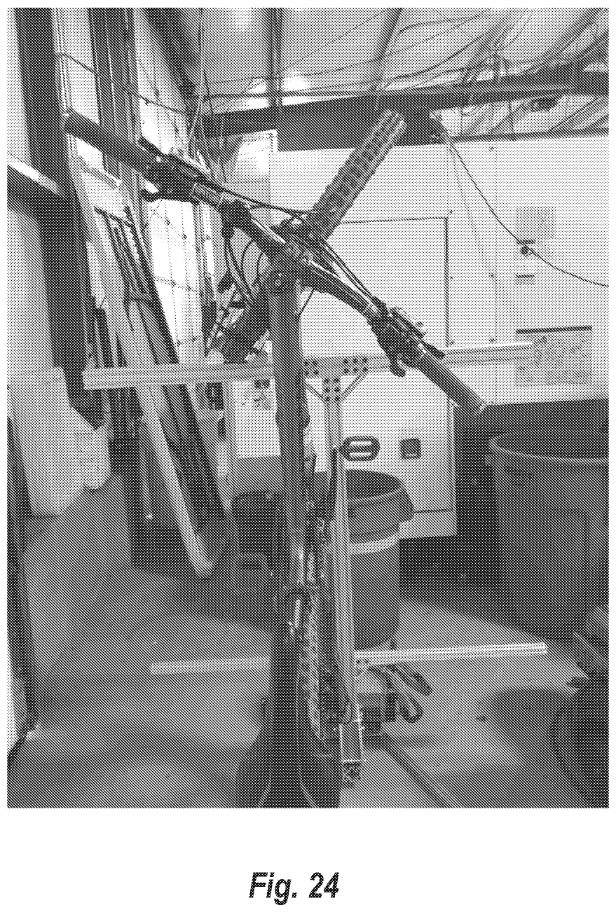

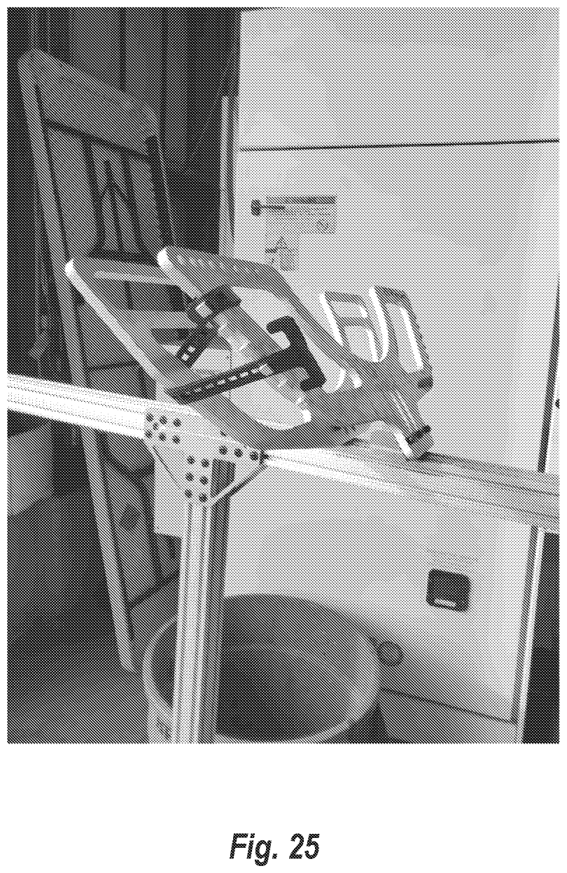

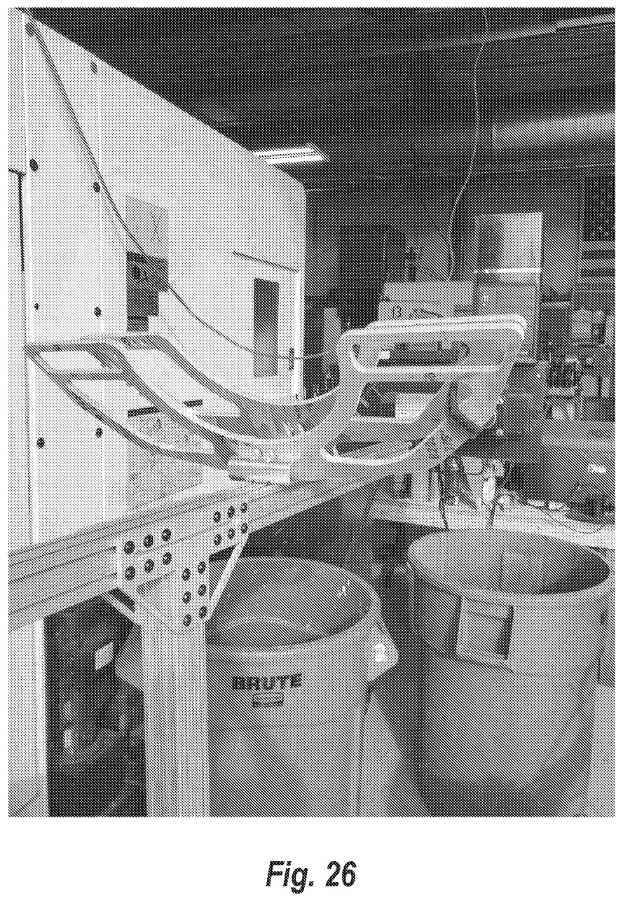

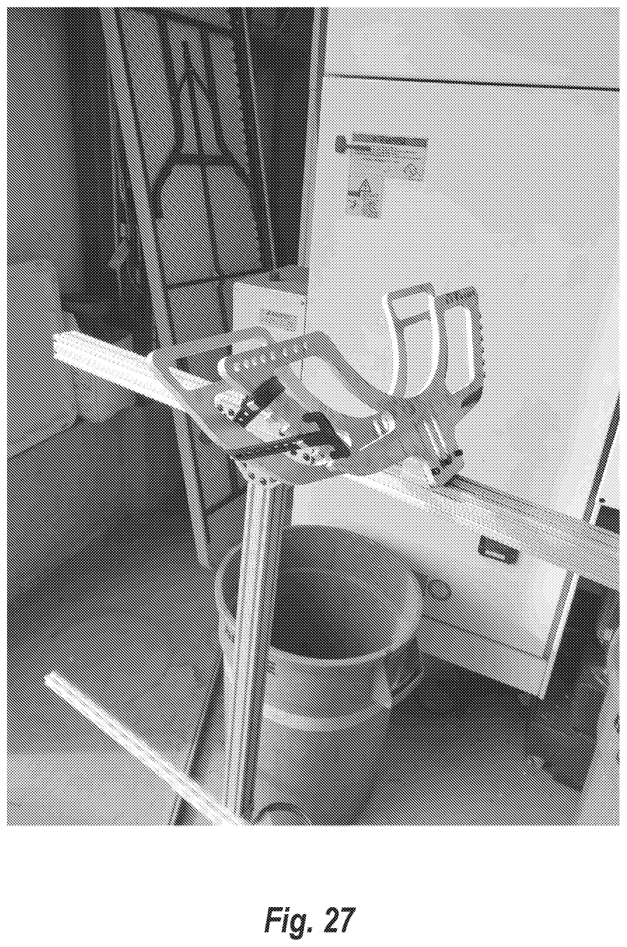

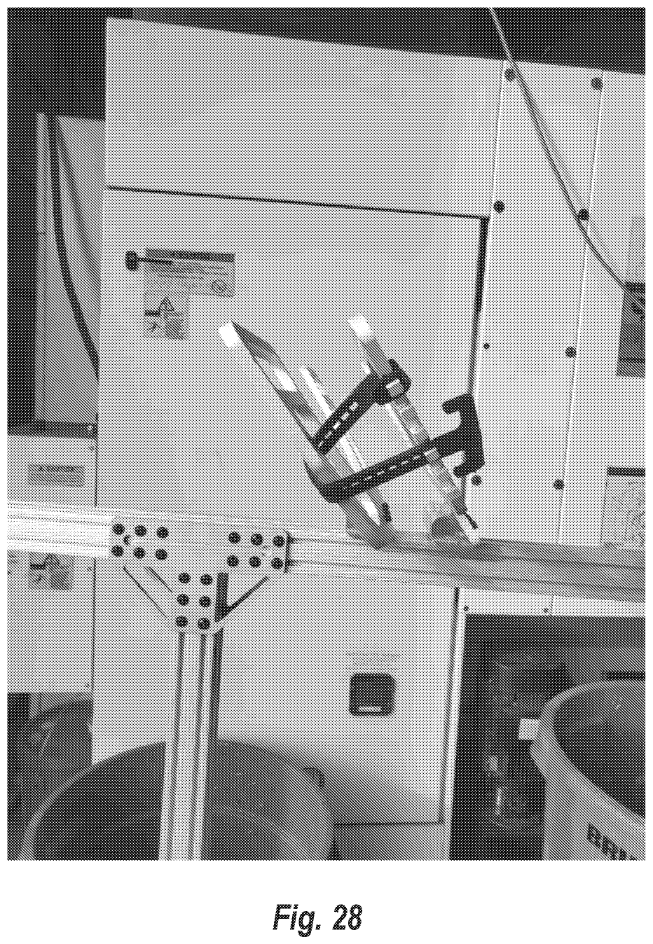

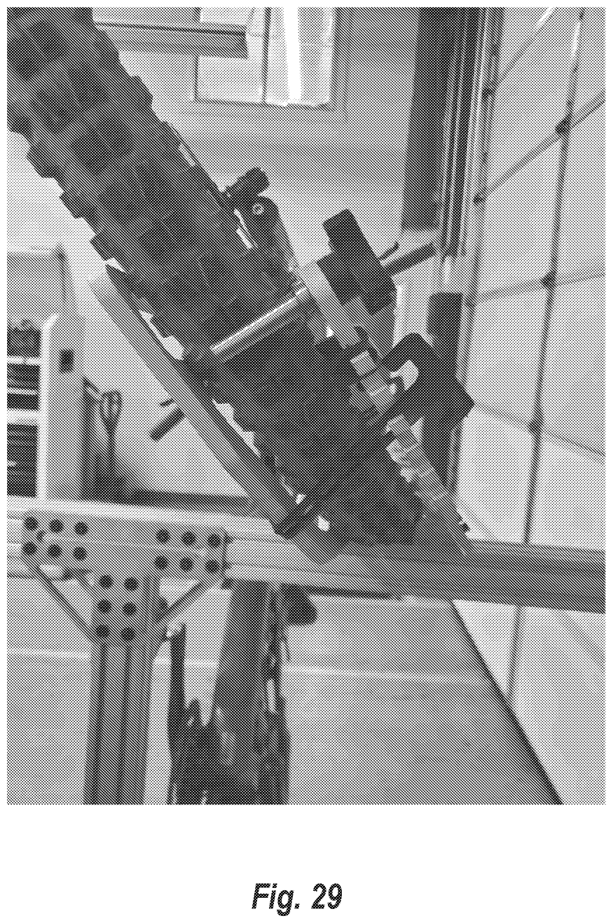

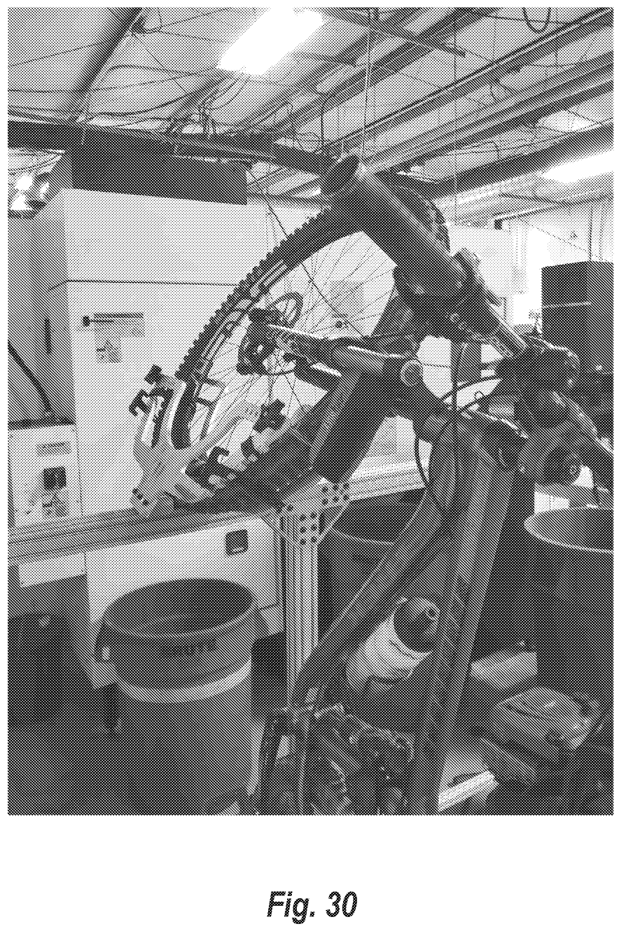

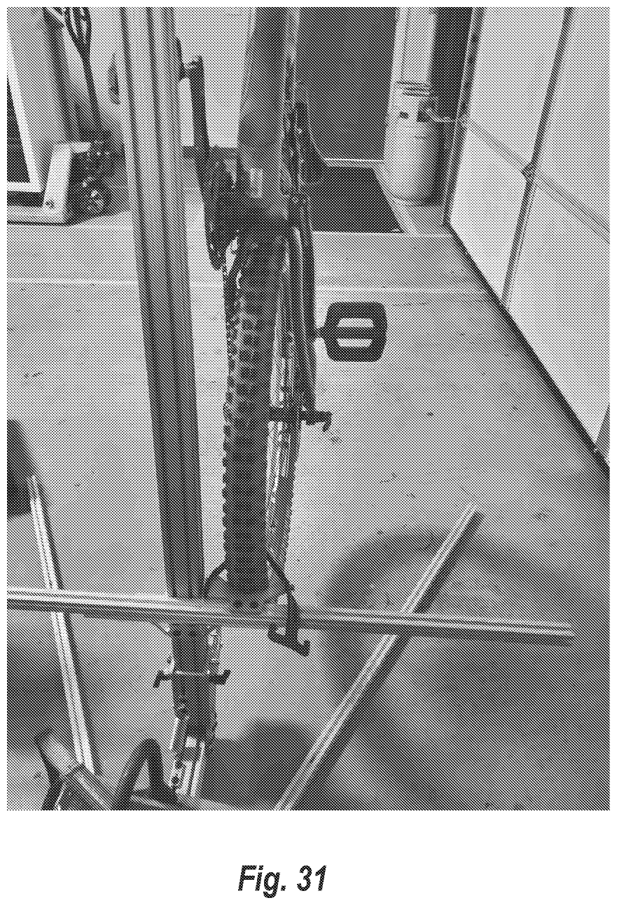

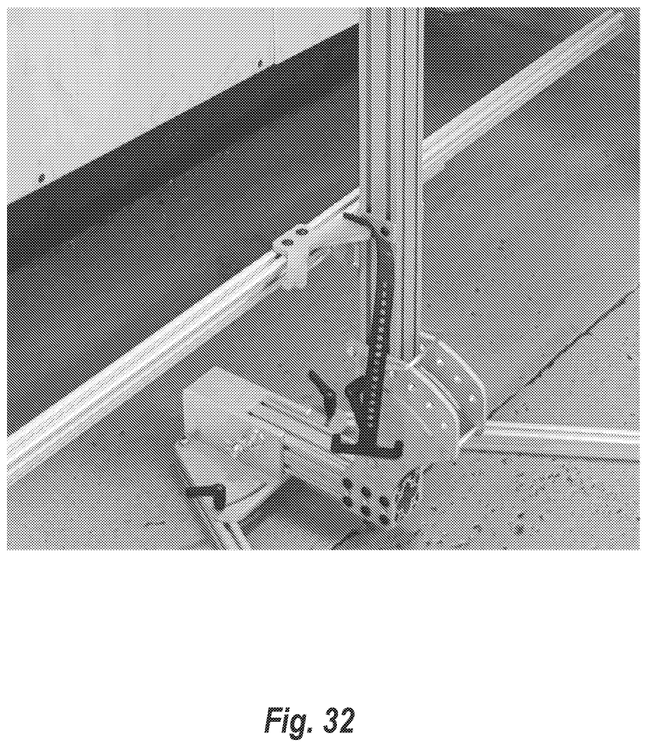

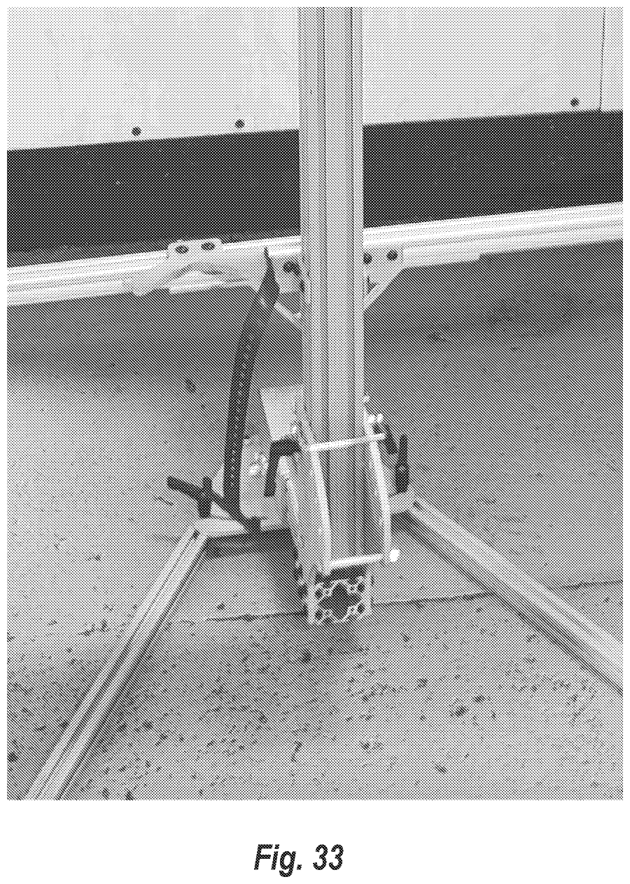

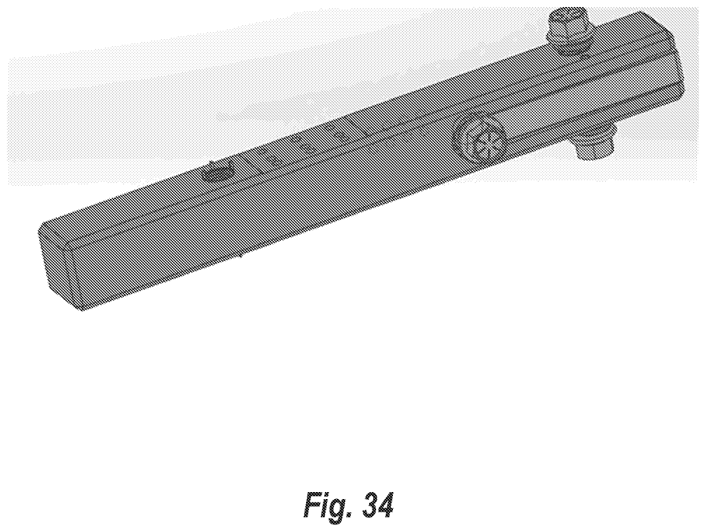

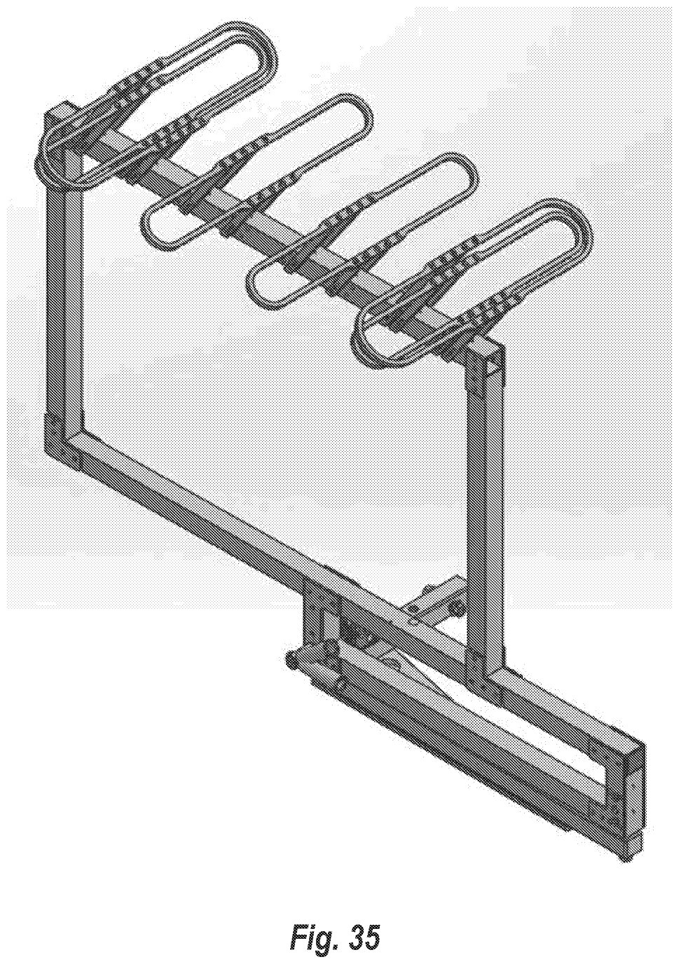

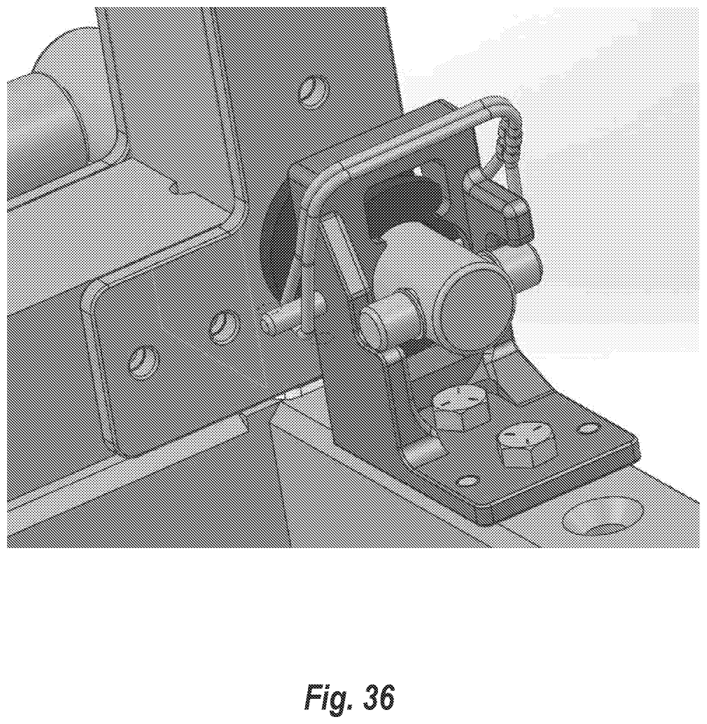

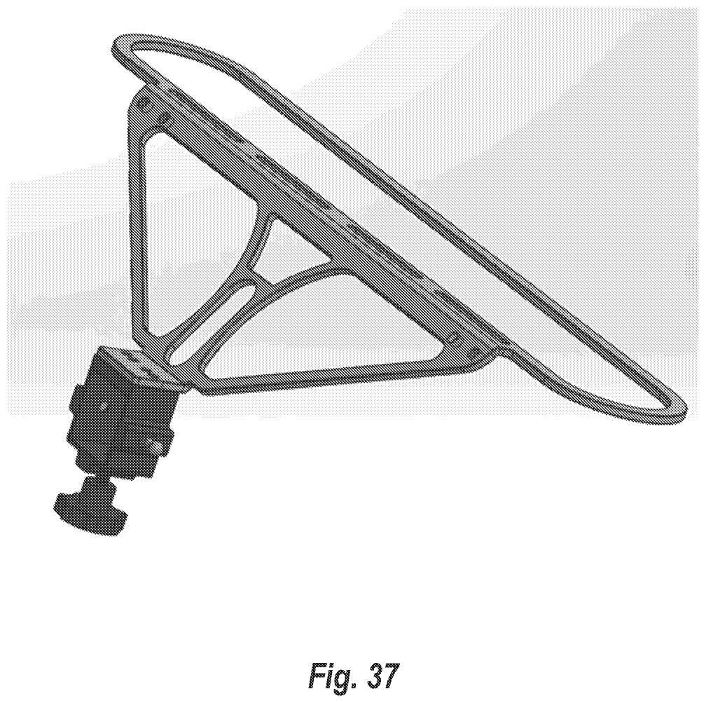

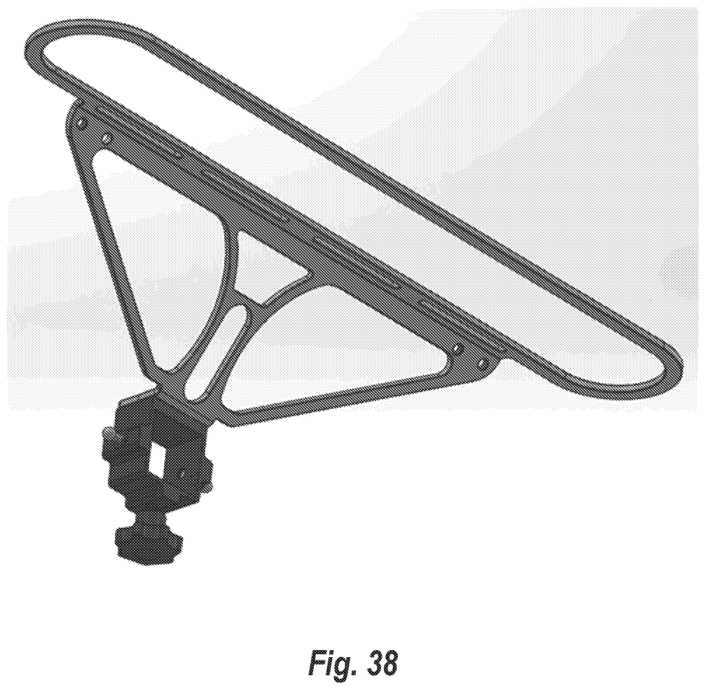

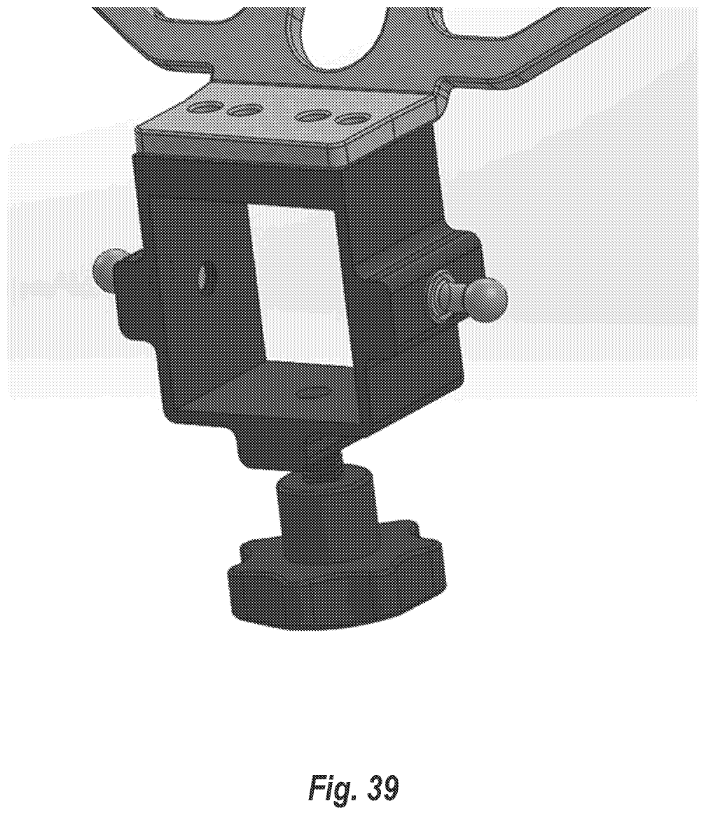

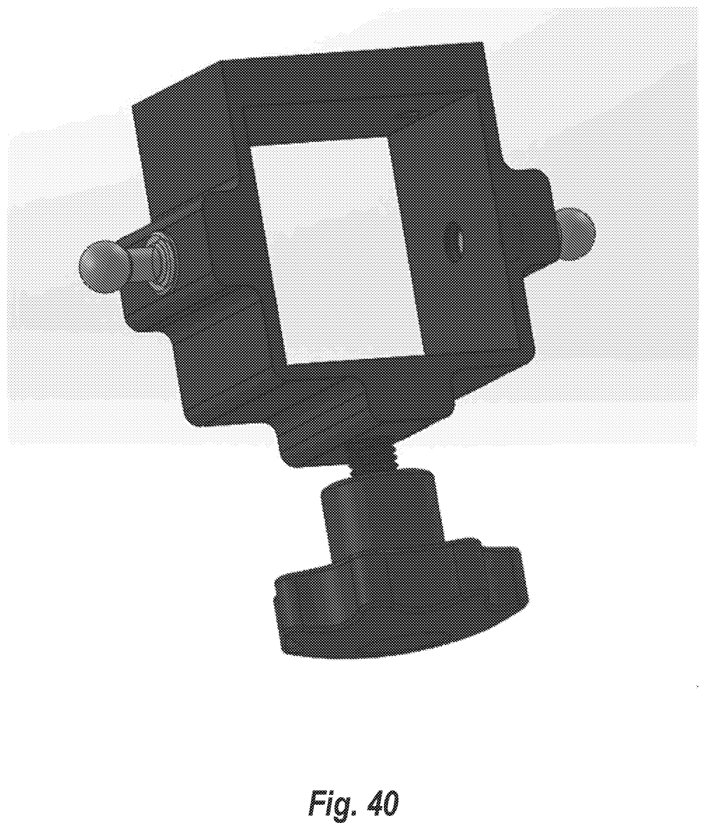

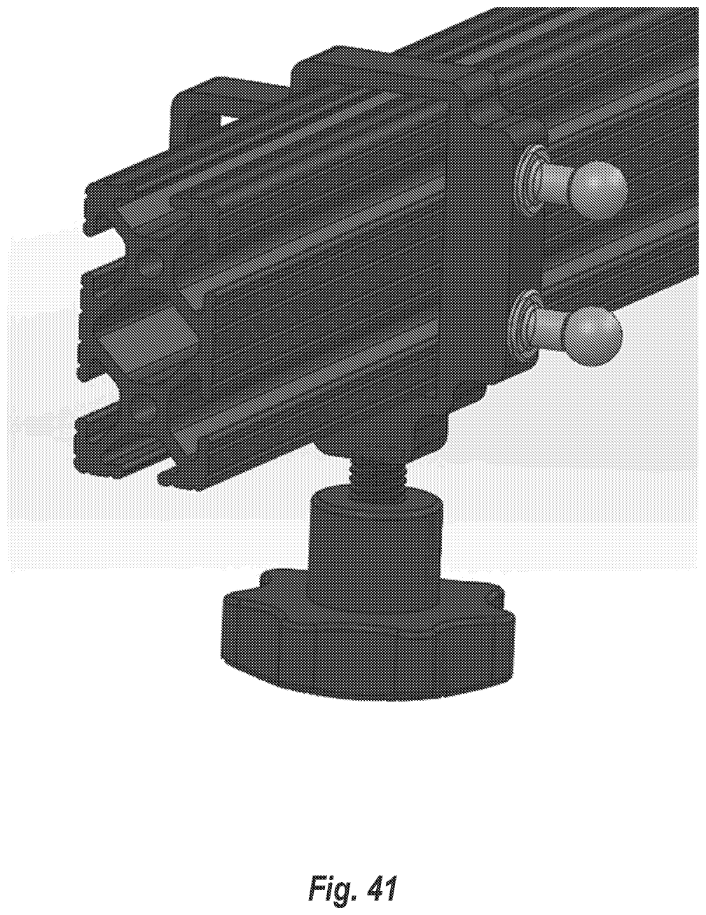

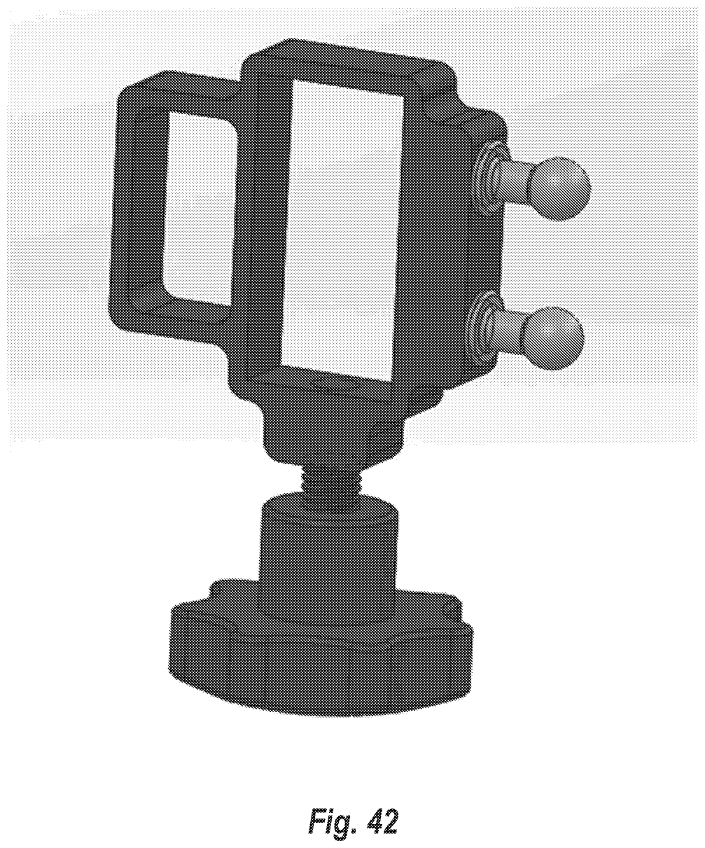

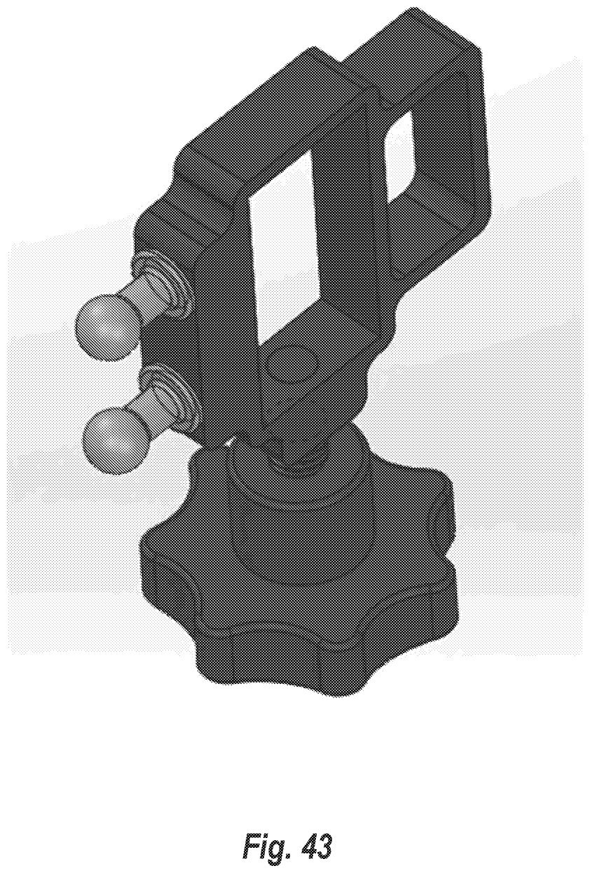

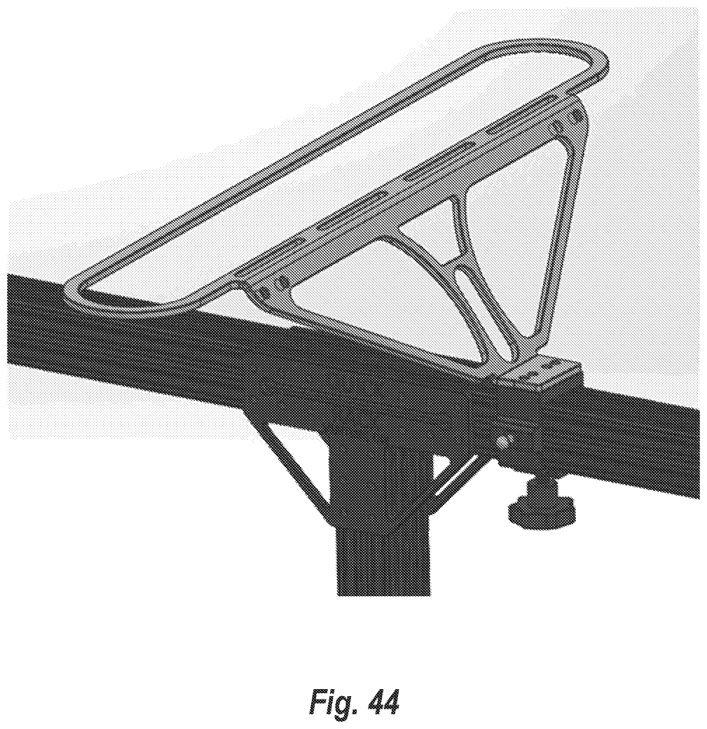

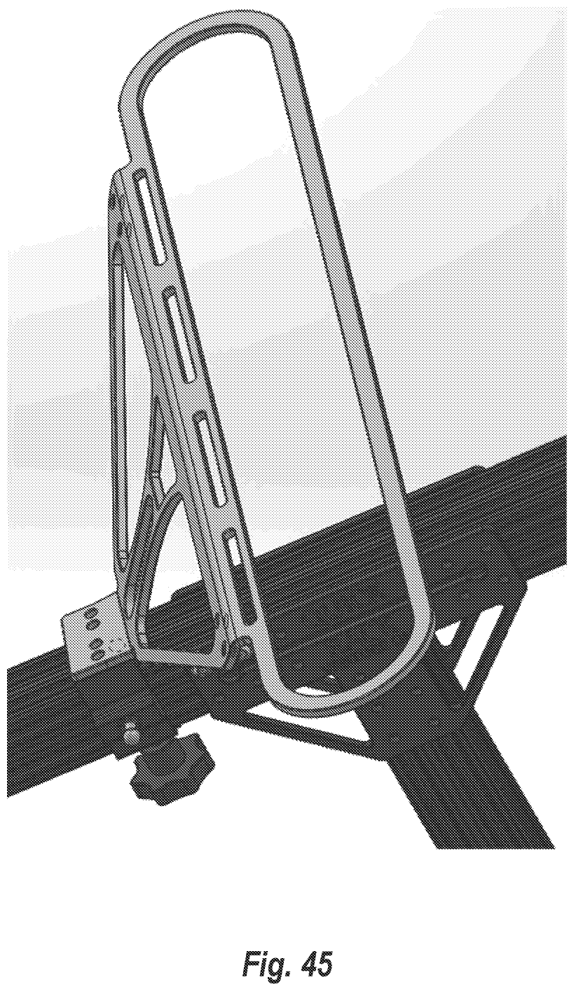

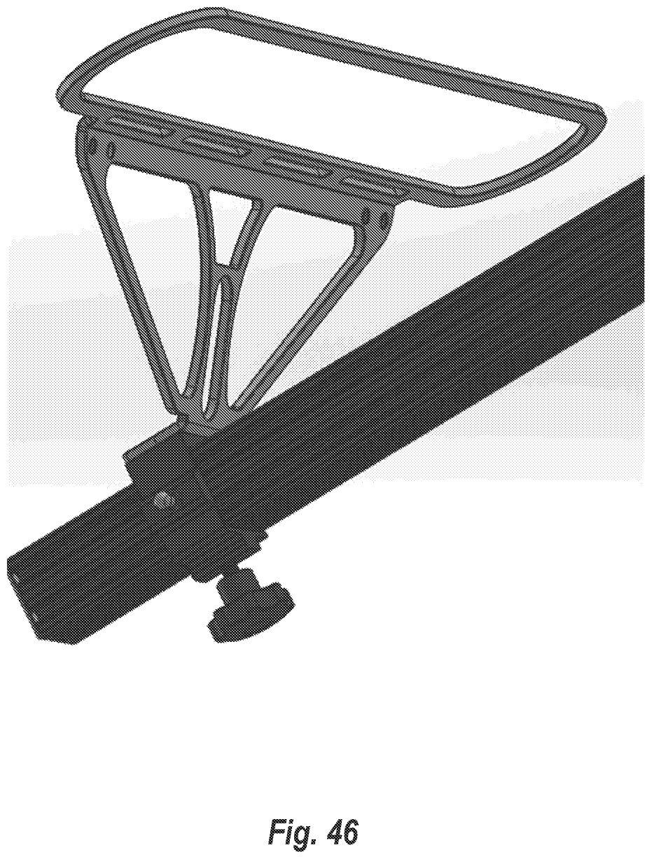

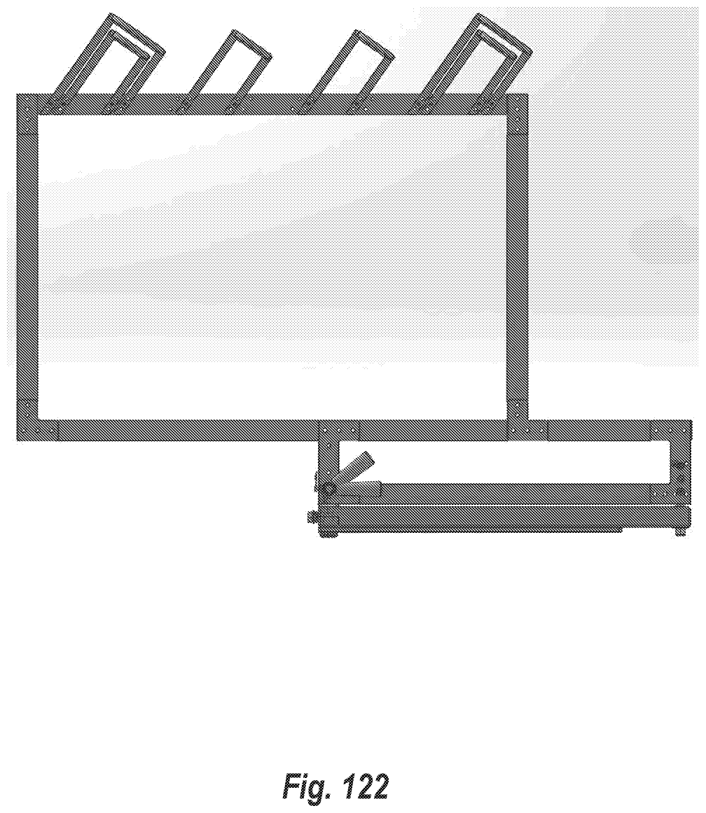

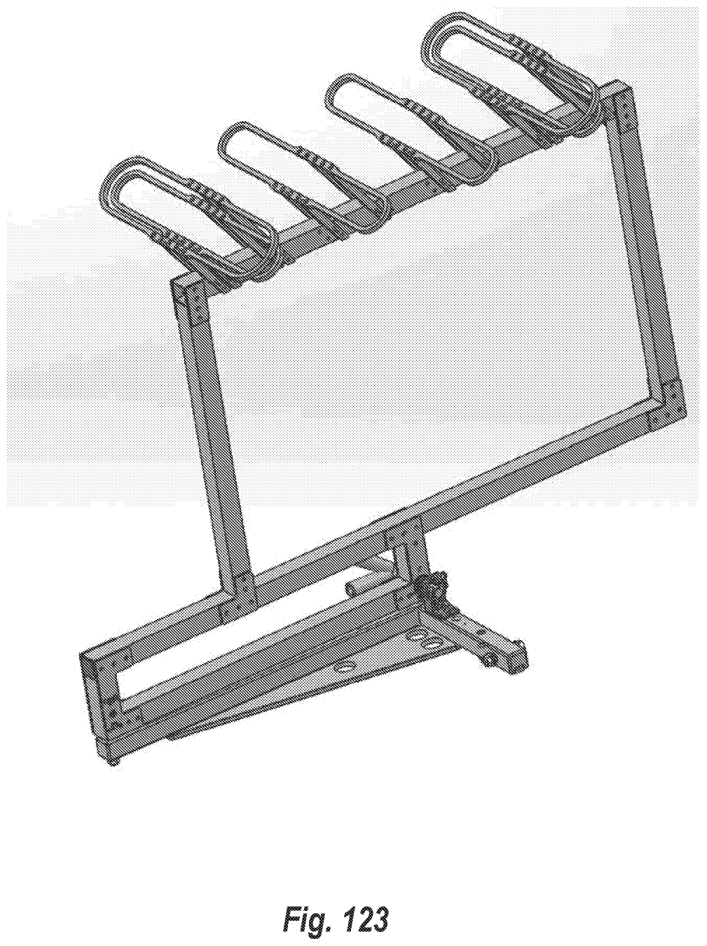

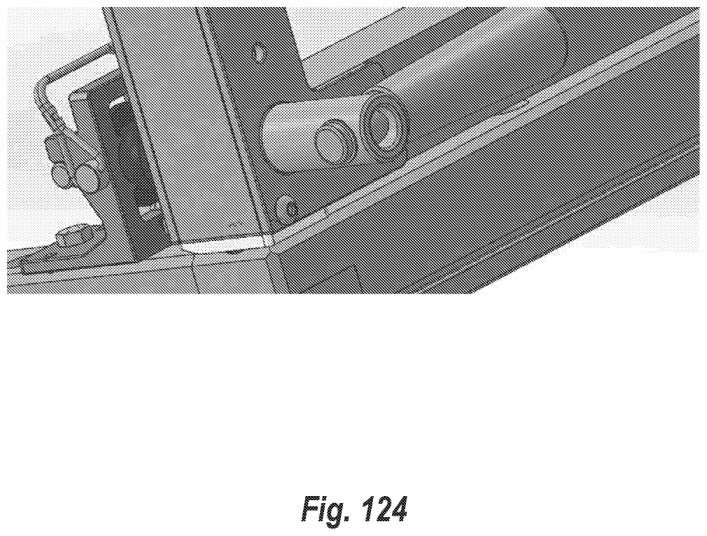

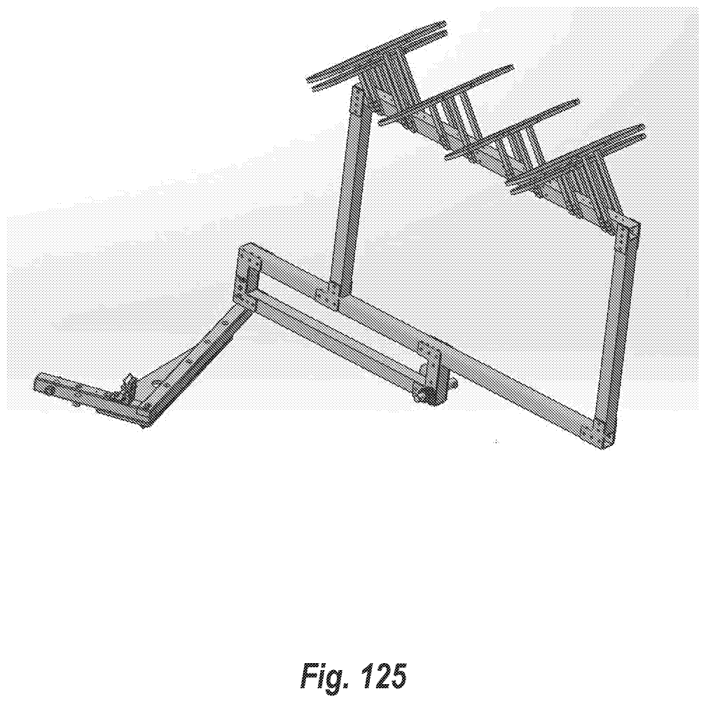

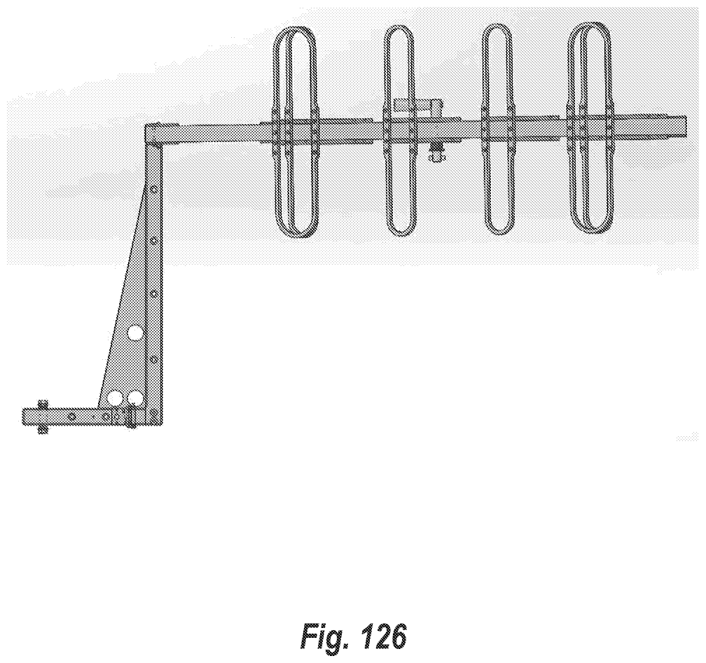

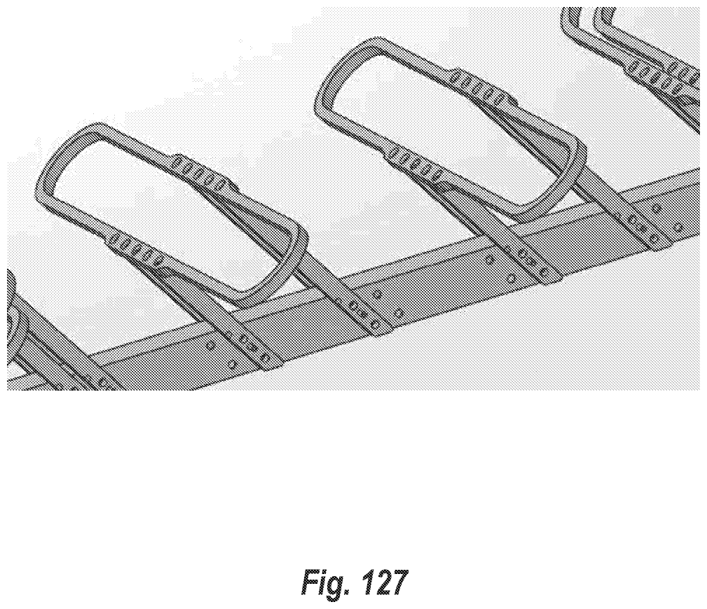

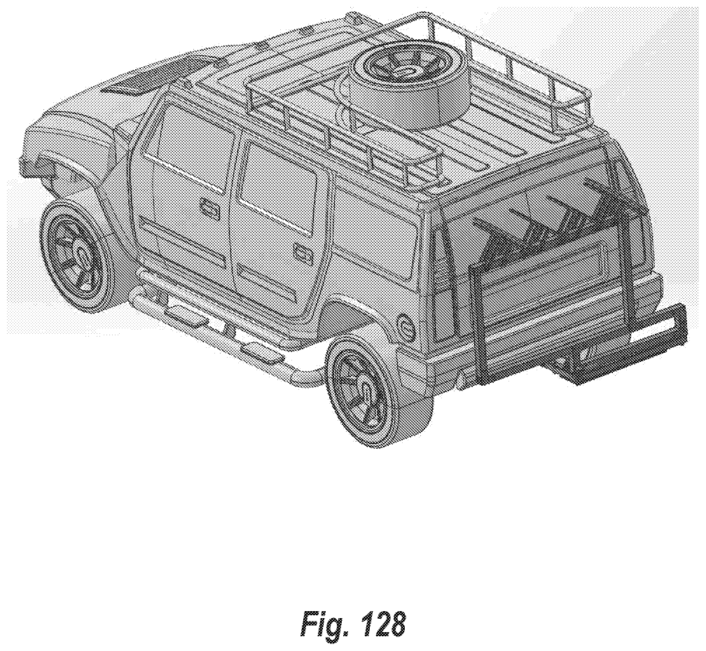

The hitch-mounted apparatus 100 can include a variety of additional or alternative embodiments than expressly described or illustrated in relation to the foregoing figures. In accordance with one or more embodiments, FIGS. 8-128 illustrate additional views of the hitch-mounted apparatus 100 as well as additional or alternative embodiments of a hitch-mounted apparatus within the scope of the present disclosure, such as the swing rack 600 further portrayed in FIGS. 122-128 or the hitch-mounted apparatus 700 further portrayed in FIGS. 8-20.

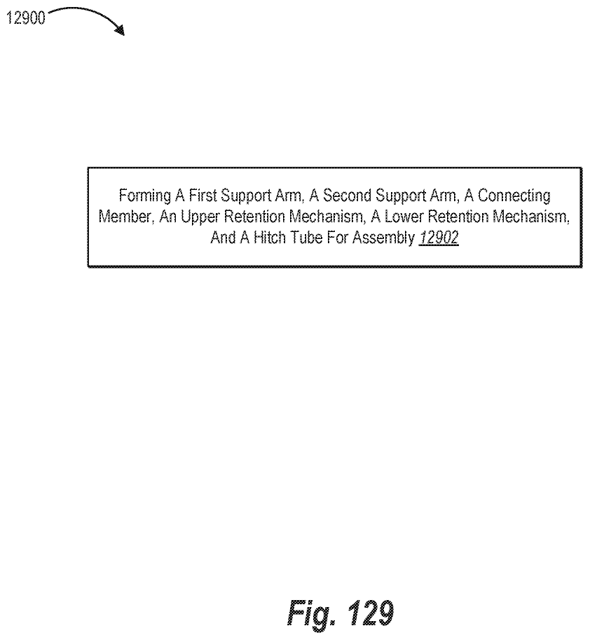

One or more implementations of the present invention can also include methods of manufacturing a hitch-mounted apparatus. In accordance with one or more embodiments, a process 12900 in FIG. 129 and the accompanying description describe one or more embodiments of such methods. One of ordinary skill in the art will recognize that the methods described below can be modified. For example, various acts of the method described can be omitted or expanded, additional acts can be included, and the order of the various acts of the method described can be altered as desired to achieve variations or alternative embodiments within the scope of this disclosure. Indeed, the process 12900 can be modified in myriad different ways for manufacturing one or more embodiments of the hitch-mounted apparatus of the present disclosure.

As shown in FIG. 129, the process 12900 includes an act 12902 of forming a first support arm, a second support arm, a connecting member, an upper retention mechanism, a lower retention mechanism, and a hitch tube for assembly. In certain embodiments, forming one or more of the first support arm, the second support arm, the connecting member, the upper retention mechanism, the lower retention mechanism, or the hitch tube for assembly comprises performing various processes on a metal bar stock (e.g., a blank, slug, or billet) such as forging, extruding, temperature treating, turning, milling, boring, tapping, sawing, coating, etc. Additionally or alternatively, forming one or more of the first support arm, the second support arm, the connecting member, the upper retention mechanism, the lower retention mechanism, or the hitch tube for assembly comprises performing metal casting, die casting, metal injection molding, metal 3D printing, stamping, laser cutting, plasma cutting, etc.

In these or other embodiments, the process 12900 may be performed (or modified to be performed) utilizing a variety of materials. One example material includes aluminum (e.g., 1100 grade aluminum, 3003 grade aluminum, or 6061 grade aluminum). Another example material includes steel (e.g., 304 stainless steel, 201 stainless steel), carbon fiber, titanium, etc. Yet another example material includes copper and copper alloys. Further, another example material includes various types of plastic (e.g., polyethylene terephthalate, high-density polyethylene, polyvinyl chloride, low-density polyethylene, polypropylene, polystyrene, polycarbonate, recycled plastic, etc.). In certain embodiments, a material can include one or more types of resin. Yet another example material includes fibrous materials, such as bamboo fiber. In certain implementations, materials can also be combined. For instance, metal and plastic components may be combined for forming a lightweight, durable combination.

As mentioned, the act 12902 comprises forming the components of the hitch-mounted apparatus for assembly, regardless of what entity actually performs the assembly. Indeed, it will be appreciated that the act 12902 need not expressly include actual assembly of the components of the hitch-mounted apparatus. Rather, assembly (in whole or in part) of the hitch-mounted apparatus may be performed subsequently by a manufacturer, a distributor, and/or an end-user.

In one or more embodiments, assembly of a hitch-mounted apparatus comprises: attaching the first support arm to a top portion of the connecting member; providing an adjustable connection between the second support arm and the connecting member at a position between the top portion and a bottom portion of the connecting member; providing an adjustable connection between the upper retention mechanism and the first support arm; providing an adjustable connection between the lower retention mechanism and the second support arm; and providing a rotatable connection between the hitch tube and the bottom portion of the connecting member via a pivot joint, wherein the hitch tube is configured for insertion into a vehicular hitch receiver. For example, assembling a hitch-mounted apparatus comprises attaching components and providing corresponding connections in a manner consistent with the attachments and connections discussed above in relation to the foregoing figures.

As mentioned previously, it is understood that the outlined acts in the process 12900 are only provided as examples, and some of the acts may be optional, combined into fewer acts, or expanded into additional acts without detracting from the essence of the disclosed embodiments. Additionally, the acts described herein may be repeated or performed in parallel with one another or in parallel with different instances of the same or similar acts. Indeed, an additional or alternative act not shown in FIG. 129, act(s) in the process 12900 may include an act of forming, constructing, or assembling one or more of the following embodiments. For example, the process 12900 includes attaching the first support arm and the second support arm perpendicularly to the connecting member.

In another example, the process 12900 includes forming the upper retention mechanism to comprise dual retention plates for securing a bike wheel. In certain implementations, forming the dual retention plates comprises forming the dual retention plates to move independently relative to each other along the first support arm to provide an adjustable retention span for fitting different bike wheel sizes. In other embodiments, forming the dual retention plates comprises joined the dual retention plates together via a common base configured to slide along the first support arm. In yet another example, the process 12900 includes forming the upper retention mechanism by constructing or assembling at least one of a mechanical stop or an adjustable restraint for securing a bike wheel within the upper retention mechanism. Stiff further, in another example, the process 12900 includes forming the upper retention mechanism to be angularly adjustable relative to the first support arm.

Further, in additional or alternative embodiments, the process 12900 may include forming or constructing one or more of the following embodiments. In a particular example, the process 12900 includes forming the second support arm to slide up or down the connecting member for positional adjustment along the connecting member (e.g., to modify a distance between the first support arm and the second support arm).

Still further, in additional or alternative embodiments, the process 12900 may include forming or constructing one or more of the following embodiments. For example, the process 12900 may include forming the lower retention mechanism (e.g., a wheel rest) to slide laterally across the second support arm for positional adjustment along the second support arm. As another example, the process 12900 may include forming the pivot joint to comprise one or more lever locks that: lock the connecting member in place when the one or more lever locks are engaged; and allow the connecting member to recline forwards or backwards between a stowed configuration and an unstowed configuration when the one or more lever locks are released.

In certain embodiments, the process 12900 includes forming or constructing one or more of the following embodiments. For example, the process 12900 includes assembling a motor to assist in raising or lowering the connecting member between a stowed configuration and an unstowed configuration. As another example, the process 12900 includes forming a hitch tube comprising a compression plate and an adjustable bolt that, when tightened, causes the compression plate to compress against the vehicular hitch receiver.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A hitch-mounted apparatus comprising:
a first support arm attached to a top portion of a connecting member;
a second support arm adjustably connected to the connecting member at a position between the top portion and a bottom portion of the connecting member;
an upper retention mechanism adjustably connected to the first support arm;
a lower retention mechanism adjustably connected to the second support arm; and
a hitch tube rotatably attached to the bottom portion of the connecting member via a pivot joint, wherein the hitch tube is configured for insertion into a vehicular hitch receiver.

2. The hitch-mounted apparatus of claim 1, wherein the first support arm and the second support arm are attached perpendicularly to the connecting member.

3. The hitch-mounted apparatus of claim 1, wherein the upper retention mechanism comprises dual retention plates for securing a bike wheel.

4. The hitch-mounted apparatus of claim 3, wherein the dual retention plates are configured to move independently relative to each other along the first support arm to provide an adjustable retention span for fitting different bike wheel sizes.

5. The hitch-mounted apparatus of claim 1, wherein the upper retention mechanism comprises at least one of a mechanical stop or an adjustable restraint for securing a bike wheel within the upper retention mechanism.

6. The hitch-mounted apparatus of claim 1, wherein the upper retention mechanism is angularly adjustable relative to the first support arm.

7. The hitch-mounted apparatus of claim 1, wherein the second support arm is configured to slide up or down the connecting member for positional adjustment along the connecting member.

8. The hitch-mounted apparatus of claim 1, wherein the lower retention mechanism is configured to slide laterally across the second support arm for positional adjustment along the second support arm.

9. The hitch-mounted apparatus of claim 1, wherein the pivot joint comprises one or more lever locks that:
lock the connecting member in place when the one or more lever locks are engaged; and
allow the connecting member to recline forwards or backwards between a stowed configuration and an unstowed configuration when the one or more lever locks are released.

10. The hitch-mounted apparatus of claim 1, further comprising a motor to assist raising or lowering the connecting member between a stowed configuration and an unstowed configuration.

11. The hitch-mounted apparatus of claim 1, wherein the hitch tube comprises a compression plate and an adjustable bolt that, when tightened, causes the compression plate to compress against the vehicular hitch receiver.

12. A vehicular mounting system comprising:
a vehicular hitch receiver associated with a vehicle; and
a hitch-mounted apparatus comprising:
a first support arm attached to a top portion of a connecting member;
a second support arm adjustably connected to the connecting member at a position between the top portion and a bottom portion of the connecting member;
an upper retention mechanism adjustably connected to the first support arm;
a lower retention mechanism adjustably connected to the second support arm; and
a hitch tube rotatably attached to the bottom portion of the connecting member via a pivot joint, wherein the hitch tube is configured for insertion into the vehicular hitch receiver.

13. The vehicular mounting system of claim 12, wherein the first support arm and the second support arm are attached perpendicularly to the connecting member.

14. The vehicular mounting system of claim 12, wherein the upper retention mechanism comprises dual retention plates.

15. The vehicular mounting system of claim 14, wherein the dual retention plates are joined together via a common base configured to slide along the first support arm.

16. The vehicular mounting system of claim 12, wherein the upper retention mechanism is angularly adjustable relative to the first support arm.

17. The vehicular mounting system of claim 12, wherein the second support arm is configured to slide up or down the connecting member to modify a distance between the first support arm and the second support arm.

18. The vehicular mounting system of claim 12, wherein the lower retention mechanism comprises a wheel rest configured to slide laterally across the second support arm for positional adjustment along the second support arm.

19. The vehicular mounting system of claim 12, wherein the pivot joint comprises one or more lever locks that:
lock the connecting member in place when the one or more lever locks are engaged; and
allow the connecting member to recline forwards or backwards between a stowed configuration and an unstowed configuration when the one or more lever locks are released.

20. A method of manufacturing a hitch-mounted apparatus, the method comprising forming a first support arm, a second support arm, a connecting member, an upper retention mechanism, a lower retention mechanism, and a hitch tube for assembly, wherein the assembly comprises:
attaching the first support arm to a top portion of the connecting member;
providing an adjustable connection between the second support arm and the connecting member at a position between the top portion and a bottom portion of the connecting member;
providing an adjustable connection between the upper retention mechanism and the first support arm;
providing an adjustable connection between the lower retention mechanism and the second support arm; and
providing a rotatable connection between the hitch tube and the bottom portion of the connecting member via a pivot joint, wherein the hitch tube is configured for insertion into a vehicular hitch receiver.
